(19) United States
(12) Patent Application Publication
(10) Pub. No.: US 2008/0072182 A1
(43) Pub. Date: Mar. 20, 2008

(54) STRUCTURED AND PARAMETERIZED MODEL ORDER REDUCTION

(75) Inventors: Lei He, Pasadena, CA (US); Hao Yu, Glendale, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/858,099

(22) Filed: Sep. 19, 2007

Related U.S. Application Data
(60) Provisional application No. 60/826,157, filed on Sep. 19, 2006.

(51) Int. Cl. G06F 17/50; G06F 7/60

(52) U.S. Cl. 716/2; 703/2

(57) ABSTRACT

Model-order reduction techniques are described for RLC circuits modeling the VLSI layouts. A structured model order reduction is developed to preserve the block-level sparsity, hierarchy and latency. In addition, a structured and parameterized model order reduction is developed to generate macromodels for design optimizations of VLSI layouts. The applications are thermal via allocation under the dynamic thermal integrity and via stapling to simultaneously optimize thermal and power integrity.

### CROSS-REFERENCE TO RELATED APPLICATIONS

This application claims priority from U.S. provisional application Ser. No. 60/826,157, filed on Sep. 19, 2006, incorporated herein by reference in its entirety.

### STATEMENT REGARDING FEDERALLY SPONSORED RESEARCH OR DEVELOPMENT

This invention was made with Government support under Grant No. ccr-0093273/0401682 awarded by the National Science Foundation (NSF). The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

A portion of the material in this patent document is also subject to protection under the maskwork registration laws of the United States and of other countries. The owner of the maskwork rights has no objection to the facsimile reproduction by anyone of the patent document or the patent disclosure, as it appears in the United States Patent and Trademark Office publicly available file or records, but otherwise reserves all maskwork rights whatsoever. The maskwork owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to integrated circuit layout modeling, and more particularly to macromodels for IC design.

2. Description of Related Art

VLSI circuits contain a number of highly structured components such as bus, power ground grid and substrate. These components can be modeled by passive networks with a tremendous number of circuit elements and ports. To analyze such networks efficiently, model order reduction has been studied extensively. Based on the Krylov subspace projection and congruence transformation, PRIMA is widely used to generate the reduced macro-model with preserved passivity. However, the macro-model produced by PRIMA destroys the block-level matrix structure such as sparsity, hierarchy and latency, which may still consume expensive computational cost. Moreover, it contains no sensitivity information for design optimization.

Power integrity verification is an essential phase of designing on-chip Power/Ground (P/G) grids. Typical P/G grid circuits typically have millions of nodes and large numbers of ports. Moreover, due to heterogeneous integration of various modules, the current density becomes highly non-uniform across the chip.

Compared to conventional two dimensional (2D) integration with one active device layer, the three dimensional (3D) integration with multiple active layers, is effective toward increasing integration level and further improving performance. However, due to increased power density, heat dissipation is extremely important in 3D-ICs. It is well known that excessively high temperature can significantly degrade interconnect/device reliability and performance in 2D-ICs. One effective heat-removal approach is to use vertical through vias to improve thermal conductivity, called thermal vias. However, current techniques assume a steady-state thermal analysis with the maximum thermal power as inputs, ignoring temporal and spatial variant thermal power, and may hence lead to significant over-design.

The existing 3D integration solutions also assume a separated design flow to allocate or staple vias to satisfy the constraints of power integrity and thermal integrity and hence may also lead to the over-design.

Accordingly, it will be appreciated that numerous shortcomings currently exist in the current high-performance IC design. The present invention overcomes these shortcomings while garnering additional IC design benefits.

### BRIEF SUMMARY OF THE INVENTION

The present invention describes methods for analyzing and reducing IC design models. The specification includes twenty-five sections spanning four major headings (which significant overlap one another): (A) Block Structure Preserving Model Order Reduction; (B) Fast Analysis of Structured Power Grid by Triangularization Based Structure Preserving Model Order Reduction; (C) Thermal Via Allocation for 3D ICs Considering Temporally and Spatially Variant Thermal Power; and (D) Simultaneous Power and Thermal Integrity Driven Via Stapling in 3D ICs.

Prior to discussing the separate portions of the invention a few fundamental terminologies are addressed.

Macromodel—a dimension and complexity reduced model that could capture the essential input/output behavior of the original model in both frequency and time domain. Representing the original complicated model by the macromodel could reduce the computational cost during the simulation, verification, and design of the very large scale integrated circuit and system.

Block matrix structure—the circuit and system are described by the state variables in term of modified nodal analysis (MNA). The according MNA state matrix usually is sparse (only a small number of nonzero entries). Moreover, it has hierarchy when the circuit and system is constructed block by block in a hierarchical fashion. In addition, different blocks show a distribution of changing-rate called latency. Utilizing the block matrix structure could further reduce the computational cost.

Sensitivity—the incremental change at output of the circuit and system when changing/perturbing the circuit and system design parameters. Utilizing the sensitivity could guide the design optimization for the circuit and system.

Model order reduction—a mathematical procedure to generate macromodel by means of matrix projection. The projection matrix is constructed from the Krylov subspace.

(A) Block Structure Preserving Model Order Reduction:

Sections 1-6 generally describe, but are not limited to the following. (1) Applying a generalized block diagonal projection method to block structured state matrices to obtain a macromodel preserving blocked matrix structure. (2) Applying a bordered-block-diagonal (BBD) data structure to hierarchically represent the state matrix with basic blocks and their coupling blocks to preserve hierarchy. (3) The flow to calculate the substrate noise with use of macromodels.

A block structure preserving model reduction (BSMOR) is taught which generalizes the structure preserving model order reduction (SPRIM). The blocks can be derived based on specific applications such as block current characterization of the substrate. Increasing block numbers leads to more matched poles or moments using the same Krylov space and also increases the sparse ratio of the state matrices of the resulting macro-model. Results from testing illustrate that BSMOR has a 20× smaller reduction time than PRIMA does under a same error bound. To efficiently analyze the resulting macromodel with a large number of ports, a bordered block diagonal (BBD) partitioning method is put forth with a bottom-up hierarchical clustering (BBDC) where the macro-model is partitioned into a number of subset-port models, each with a manageable model size. With a similar accuracy, BBDC obtains 30× speedup compared to the original macro-model.

(B) Fast Analysis of Structured Power Grid by Triangularization Based Structure Preserving Model Order Reduction:

Sections 7-13 generally describe, but are not limited to the following. (1) Applying a block-duplication based triangularization to enable a localized block structure-preserving model order reduction with more exactly matched poles than those described under heading A. (2) Applying a dominant-pole based clustering to leverage non-uniform time constants and reduce redundancy in state matrices. (3) Extending block structure-preserved reduction to the single-input-multi-output (SIMO) system, so as to handle large number of ports. (4) Applying two-level relaxation to analyze the reduced block triangular system.

One aspect of the present invention is a Triangularization Based Structure preserving (TBS) model order reduction is proposed to verify power integrity of on-chip structured power grid. The power grid is represented by interconnected basic blocks according to current density, and basic blocks are further clustered into compact blocks, each with a unique pole distribution. Then, the system is transformed into a triangular system, where compact blocks are in its diagonal and the system poles are determined only by the diagonal blocks. Finally, projection matrices are constructed and applied for compact blocks separately. The resulting macromodel has more matched poles and is more accurate than the one using flat projection. It is also sparse and enables a two-level analysis for simulation time reduction. Results from testing confirms that compared with existing approaches TBS achieves up to 133× and 109× speedup in macromodel building and simulation respectively, and reduces waveform error by 33×.

(C) Thermal Via Allocation for 3D ICs Considering Temporally and Spatially Variant Thermal Power:

Sections 14-19 generally describe, but are not limited to the following. (1) Applying structure-preserved and parameterized model order reduction to generate macromodels, in which nominal values and sensitivities can be easily separated. (2) Automating physical IC design in response to parametrically describing the wire/via sizing problem in state matrices for physical design automation. (3) Applying structure-preserved and parameterized macromodels and the sequential linear/quadratic programming for layout optimization. (4) Minimizing thermal-violation integral for thermal optimization.

Existing methods for thermal-via allocation are based on a steady-state thermal analysis which can lead to an excessive number of thermal vias. Accordingly an accurate and efficient thermal-via allocation method is put forth which considers temporally and spatially variant thermal-power. The transient temperature is calculated using macromodel by a structured and parameterized model reduction, which generates temperature sensitivity with respect to thermal-via density. By defining a thermal-violation integral based on the transient temperature, a nonlinear optimization problem is formulated to allocate thermal-vias and minimize thermal-violation integral. This optimization problem is transformed into a sequence of subproblems by Lagrangian relaxation, and each subproblem is solved by quadratic programming using sensitivities from the macromodel. Testing of the approach illustrates that in comparison to existing steady-state thermal analysis methods, the present approach is much faster (e.g., approximately 126× faster) in obtaining a temperature profile, while reducing the number of thermal vias by at least 2× under the same temperature bound.

(D) Simultaneous Power and Thermal Integrity Driven Via Stapling:

Sections 20-25 generally describe, but are not limited to the following. (1) Optimizing the simultaneous use of vertical inter-layer vias for voltage bounce reduction and heat removal in 2D or 3D integrated circuits. (2) Minimizing via number for inter-layer via planning in 3D ICs. (3) Describing, parametrically, wire/via insertion considering topology modification. (4) Routing of power and signal simultaneously to optimize the power delivery network (including on-chip grids and off-chip packages) to reduce voltage bounce, thermal hotspot, and routing congestion.

The existing work on via-stapling in 3D integrated circuits optimizes power and thermal integrity separately and uses steady state thermal analysis. Methods are taught herein for performing simultaneous power and thermal integrity driven via stapling in 3D designs. The transient temperature and supply voltage violations are calculated by a structured and parameterized model reduction, which also generates parameterized temperature and voltage violation sensitivities with respect to the via pattern and density. Using parameterized sensitivities, an efficient yet effective greedy optimization is presented to optimize power and thermal integrity simultaneously. Testing with two active device layers shows that compared to sequential power and thermal optimization using steady-state thermal analysis, sequential optimization using transient thermal analysis reduces non-signal vias by on average 11.5%, and simultaneous optimization using transient thermal analysis reduces non-signal vias by on average 34%. The via reduction would be higher for the 3D design with more device layers.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a graph comparing maximum error using PRIMA and BSMOR (2 and 8) according to an aspect of the present invention.

FIGS. 2A-2B are graphs of unreduced non-zero patterns of a uniform RC-mesh.

FIGS. 3A-3B are graphs of non-zero patterns of a uniform RC-mesh after a BSMOR reduction with 8 iterations according to an aspect of the present invention.

FIGS. 4A-4B are schematics of a four-port admittance and with two reduced blocks according to an aspect of the present invention.

FIG. 5 is a hierarchical tree structure according to an aspect of the present invention, wherein each node represents an abstract block.

FIGS. 6A-6B is a schematic characterization of mesh networks depicting a non-uniform substrate mesh network and corresponding block structure of conductance/capacitance matrices according to an aspect of the present invention.

FIG. 7 is a flowchart of the BSMOR method according to an aspect of the present invention.

FIG. 8 is a graph of scalability trend for simulation time on the original model, flat macro-model, and partitioned models with different hierarchical levels according to an aspect of the present invention.

FIGS. 9A-9D are 3D graphs of noise envelope mapping for different conditions according to an aspect of the present invention.

FIGS. 10A-10B are 3D graphs of noise at high frequency with and without guard rings according to an aspect of the present invention.

FIG. 11 is a perspective view of an example P/G grid section.

FIG. 12 is a schematic of P/G block with nodes according to an aspect of the present invention.

FIG. 13 is a graph of off-diagonal matrices representing the nodes of FIG. 12, according to an aspect of the present invention.

FIG. 14 is a flow-data diagram for a triangular block structured moment matching process according to an aspect of the present invention.

FIG. 15 is a matrix process diagram of a triangularization step according to an aspect of the present invention.

FIG. 16 is a block diagram of a triangular block according to an aspect of the present invention.

FIG. 17 is a matrix process diagram of a first block diagonal projection process according to an aspect of the present invention.

FIG. 18 is a matrix process diagram of a second block diagonal projection process according to an aspect of the present invention.

FIG. 19 is a graph of pole matching comparing mq poles matched by TBS and BSMOR, and q poles matched by HiPRIME according to an aspect of the present invention.

FIGS. 20A-20C are plots of nonzero-entry patterns of conductance matrices according to an aspect of the present invention.

FIG. 21 is a graph of time-domain response at one port for HiPRIME, BSMOR, HAPD, TBS and the original under a unit-impulse input according to an aspect of the present invention.

FIG. 22 is a graph of frequency domain response under an impulse input according to an aspect of the present invention.

FIG. 23 is a perspective view of topology for typical 3D designs including the active device layers, thermal-vias, and substrates according to an aspect of the present invention.

FIG. 24 is a perspective view of heat buildup in a 3D IC design.

FIG. 25 is a schematic of discretizing active devices and inter-dielectric layers into interconnected tiles according to an aspect of the present invention.

FIG. 26 is a schematic of a transient model having tiles connected with a thermal resistance and capacitance and heat sources modeled as time-variant current sources according to an aspect of the present invention.

FIG. 27 is a graph representing different power measures of cycle-accurate power, transient thermal-power signature, and maximum thermal-power signature at the different scale of time constant according to an aspect of the present invention.

FIG. 28 is a graph of figure of merit using thermal-violation integral with defined ceiling temperature under an input of transient thermal-power signature according to an aspect of the present invention.

FIG. 29 is a graph of transient temperature responses of exact and structured and parameterized macromodels according to an aspect of the present invention.

FIG. 30 is a graph of convergence of subgradient optimization of primal and dual problems according to an aspect of the present invention.

FIG. 31 is a graph of iterative optimizations at transient temperature as one port is cooled according to an aspect of the present invention.

FIG. 32 is a graph of steady-state temperature of the top layer before thermal-via allocation using transient temperature profile according to an aspect of the present invention.

FIG. 33 is a graph of steady-state temperature of the top layer after thermal-via allocation using transient temperature profile according to an aspect of the present invention.

FIG. 34 is a cross-section view of typical 3D stacking of multiple active layers inside a single integrated circuit package.

FIGS. 35A-35B are image renderings of spatial distributions of normalized temperature and voltage violations for a typical 3D design before stapling vias.

FIGS. 36A-36C are schematics of a unit tile, an equivalent RLC cell, and an equivalent RC-cell according to aspects of the present invention.

FIGS. 37 is a schematic depicting a comparison between a conventional steady state thermal model with a transient thermal model according to an aspect of the present invention.

FIG. 38 is a schematic example of stapling between tiles 2 and 6 according to an aspect of the present invention.

FIG. 39 is a graph of matrix of X(2,6) for FIG. 38 according to an aspect of the present invention.

FIG. 40 is a graph of power definitions representing cycle-accurate power, transient thermal-power signature, and maximum thermal-power signature according to an aspect of the present invention.

FIGS. 41A-41C are schematics of levelization via-stapling between each pair of adjacent layers according to an aspect of the present invention.

FIG. 42 is a flowchart of general process flow in performing iterative optimization according to an aspect of the present invention.

FIG. 43 is a graph of transient voltage responses for exact models of macromodels according to an aspect of the present invention.

FIGS. 44A-44B are graphs of iterative optimization showing reductions in temperature and voltage violations by via-stapling according to an aspect of the present invention.

FIGS. 45A-45B are graphs of steady-state temperature of a bottom device layer before and after via-stapling according to an aspect of the present invention.

### DETAILED DESCRIPTION OF THE INVENTION

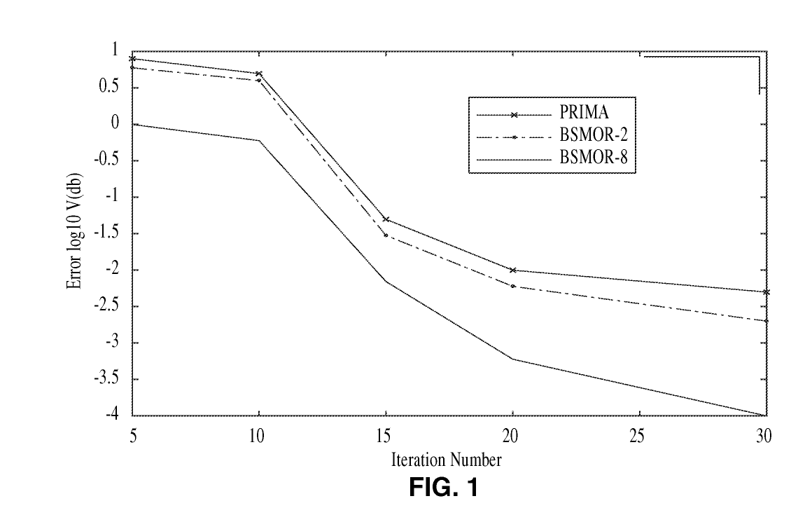

Referring more specifically to the drawings, for illustrative purposes the present invention is embodied in the apparatus generally shown in FIG. 1 through FIG. 45B. It will be appreciated that the apparatus may vary as to configuration and as to details of the parts, and that the method may vary as to the specific steps and sequence, without departing from the basic concepts as disclosed herein.

(A) Block Structure Preserving Model Order Reduction

1. Introduction to Block Structure Preserving Method

To improve upon PRIMA, a structure-preserving model reduction (SPRIM) was proposed which partitions the state matrix in the MNA (modified nodal analysis) form into a natural 2×2 block matrices, i.e., conductance, capacitance, inductance, and adjacent (G;C; L;Eₛ) matrices. Accordingly the projection matrix is partitioned and the number of its columns is doubled. As a result, SPRIM matches the twice poles of the models by using the projection matrix given by PRIMA. In addition, the block structure of state matrices is preserved, which facilitates the realization of the reduced model. However, such a simple 2×2 partition does not leverage the regularity of the substrate network. On the other hand, the explicit hierarchical decomposition is proposed to handle a large number of ports. The teachings herein overcome a number of the shortcomings of these methods utilizing a block structure preserving model reduction (BSMOR) method.

The BSMOR method generalizes SPRIM in the sense that the G, C, L and Eₛ matrices are further partitioned into blocks. The blocks can be derived based on special c applications such as block current characterization of the substrate as per the present invention. It is shown that increasing the block number leads to more matched poles or moments using the same Krylov space. Compared to PRIMA, BSMOR can lead to more efficient reduction under the same accuracy. In addition, BSMOR can also preserve the sparsity for reduced block matrices, which gives further efficiency boost to constructing a macro-model. The resulting macro-model consists of order-reduced blocks, each containing a subset of ports. To analyze a macro-model with a large number of ports, a bordered-block diagonal (BBD) partitioning and hierarchical clustering of reduced blocks is also taught which is referred to herein as BBDC analysis. The testing shows that under the same accuracy, the processing reduction of this novel approach is 20×times faster than PRIMA in reducing a circuit with 1M elements, and the BBDC analysis is 30× faster in relation to analyzing the original macromodel.

2. Block Structure Preserving Model Reduction

In this section, a block structure preserving model reduction (BSMOR) is presented that implicitly uses the block structure information of the matrix during the reduction. It is shown that by increasing the block number, more poles or moments can be matched using the same Krylov subspace, which is also confirmed by experimental results described herein. In addition, the concept of the structured Krylov subspace is introduced to summarize the contribution of this application.

2.1 Background on MNA, PRIMA, and SPRIM

Consider a modified nodal formulation (MNA) of the circuit equations in the frequency domain:
Gx(s)+sCx(s)=Biₚ(s)
vₚ(s)=B^{T}x(s) (1)
where x(s) is the state variable vector, G and C (εR^{N×N}) are state matrices. B (εN^{N×n}^{ₚ}) is given by:
B=[B 0]^{T}, (2)
a port incident matrix. Eliminating x(s) in Eq. (1) yields
vₚ(s)=H(s)iₚ(s)
H(s)=B^{T}(G+sC)⁻¹B (3)
where H(s) is a multiple-input multiple-output (MIMO) transfer function. PRIMA finds a projection matrix V (εR^{N×q}) such that its columns span the q-th block Krylov subspace K(A,R,q), for example:
spanV=K(A, R, q) (4)
where A=(G+s₀C)⁻¹, R=(G+s₀C)⁻¹B and s₀ is the expansion point that ensures G+s₀C is nonsingular. The resulting reduced transfer function is
Ĥ(s)=\hat{B}^{T}(Ĝ+sĈ)⁻¹\hat{B} (5)
where
Ĝ=V^{T}GV, Ĉ=V^{T}CV, \hat{B}=V^{T\hat{B}} (6)
has the identical expanded first q-th moments with H(s). It is referred to as the Grimme's projection theorem. It should be noted that Ĝ,ĈεR^{q×q}, and \hat{B}εR^{q×n}^{ₚ}. SPRIM observes that instead of using the Krylov subspace K(A,R,q) for the projection matrix \tilde{V}, one can use any projection matrix such that the space spanned by the column in V contains the q-th block Krylov subspace, an example is
K(A,R,q)⊂\hat{V} (7)

In SPRIM, a 2×2 partition is naturally used as a linear state matrix in the MNA form has a 2×2 block structure

$$G = [ \begin{matrix}G & {E}_{s}^{T} \\ - {E}_{s} & 0\end{matrix} ] , C = [ \begin{matrix}C & 0 \\ 0 & L\end{matrix} ] \qquad ( 8 )$$

where G(εRⁿ^{₁}^{×n}^{₁}), C(εRⁿ^{₁}^{×n}^{₁}), L(εRⁿ^{₂}^{×n}^{₂}) are conductance, capacitance and inductance matrix, and Eₛ(εRⁿ^{₂}^{×n}^{₁}) is the adjacent matrix indicating the branch current flow at the inductor. It should be noted that n₂+n₁=N. Therefore, a structured projection vector \tilde{V} can be constructed by partitioning the projection vector V obtained from the q-th PRIMA iteration

$$V = [ \begin{matrix}{V}_{1} \\ {V}_{2}\end{matrix} ] \to \hat{V} = [ \begin{matrix}{V}_{1} & 0 \\ 0 & {V}_{2}\end{matrix} ] \qquad ( 9 )$$

where V₁εRⁿ^{₁}^{×q}, V₂εRⁿ^{₂}^{×q}, \tilde{V}εR^{N×2q} As a result, the number of columns in V is twice of that in \tilde{V}. Accordingly the new reduced state matrices are

$${\tilde{G}}^{′} = [ \begin{matrix}\tilde{G} & {\tilde{E}}_{s}^{T} \\ - {\tilde{E}}_{s} & 0\end{matrix} ] , {\tilde{C}}^{′} = [ \begin{matrix}\tilde{C} & 0 \\ 0 & \tilde{L}\end{matrix} ] \qquad ( 10 )$$

where \tilde{G}=V₁^{T}GV₁, \tilde{E}ₛ=V₂^{T}EₛV₁, \tilde{C}=V₁^{T}CV₁, and \tilde{L}=V₂^{T}LV₂. Similarly, the size of \tilde{G}′, \tilde{C}(εR^{2q×2q}), and \tilde{B}(εR^{2q×n}^{ₚ}) is twice than that of \tilde{G}′, \tilde{C}′ and \tilde{B}′ reduced by using V. Therefore, the moments of the reduced model with state matrices \tilde{G}′ and \tilde{C}′ are twice those of the reduced model with state matrices Ĝ′ and Ĉ′. In other words, the reduced model by \tilde{V} matches 2q poles or moments of the original model instead of q poles or moments by V.

Since the reduced model is written in the first order form in Eq. (10), the model reduced by SPRIM is twice larger than that produced by PRIMA. However, the reduced model by SPRIM preserves the structure of the original model and can be further reduced into the second-order form using node elimination base on the Schur's decomposition:

$${\tilde{G}}_{NA}^{′} = \tilde{G} + s \tilde{C} + \frac{1}{s} {\tilde{A}}^{T} {\tilde{L}}^{- 1} \tilde{A} ,$$

where \tilde{G}′_{NA} is the reduced state matrix in NA form, which has the same size of the reduced matrix by using V. Note that the difference is that each element in \tilde{G}′_{NA} becomes a second-order rational function of s instead of first-order polynomial of s. Hence the SPRIM algorithm essentially consists of two reduction steps: the first step is the structure-preserving projection-based reduction and the second step is block node elimination based on Schur's decomposition. As a result, SPRIM can match more poles than PRIMA, which uses V as the projection matrix, but both result in a same size of the reduced model. Looking at the first step, SPRIM simply matches more moments by using more columns in the projection matrix \tilde{V}, thus produces larger reduced state matrices in the first-order form.

2.2 BSMOR Method

It should be appreciated that SPRIM is based on a 2×2 partitioning of the state matrices. However, in response to increasing the number of partitions (each partition called a block), more columns can be added into the project matrix \tilde{V}, thus matching a substantially larger number of poles within the same Krylov space K(A,R,q).

Specifically, it is assumed that the conductance matrix G′ can be written in m blocks

$${G}^{′} = [ \begin{matrix}{G}_{1 , {1}_{( {n}_{1} \times {n}_{1} )}}^{′} & {G}_{1 , {2}_{( {n}_{1} \times {n}_{2} )}}^{′} & ⋯ & {G}_{1 , {m}_{( {n}_{1} \times {n}_{m} )}}^{′} \\ {G}_{2 , {1}_{( {n}_{2} \times {n}_{1} )}}^{′} & {G}_{2 , {2}_{( {n}_{2} {n}_{2} )}}^{′} & ⋯ & {G}_{2 , {m}_{( {n}_{2} \times {n}_{m} )}}^{′} \\ ⋮ & ⋮ & ⋰ & ⋮ \\ {G}_{m , {1}_{( {n}_{m} \times {n}_{1} )}}^{′} & {G}_{m , {2}_{( {n}_{m} \times {n}_{2} )}}^{′} & ⋯ & {G}_{m , {m}_{( {n}_{m} \times {n}_{m} )}}^{′}\end{matrix} ] \qquad ( 11 )$$

where each block has the size

$${n}_{k} ( {\sum }_{k = 1}^{m} {n}_{k} = N ) .$$

A similar block structure can be found for the C′ matrix. Then, B becomes

$$B = {[ {B}_{{1}_{( {n}_{1} \times {n}_{p} )}} , {B}_{{2}_{( {n}_{2} \times {n}_{p} )}} , ⋯ {B}_{{m}_{( {n}_{m} \times {n}_{p} )}} ]}^{T} \qquad ( 12 )$$

where each basic block contains user specified n_{Pk} ports

$$( {\sum }_{k = 1}^{m} {n}_{{p}_{k}} ) .$$

It should be recognized that these blocks can be derived for specific applications, such as block current characterization of the substrate as discussed in Section 4. Accordingly, the projection matrix V obtained from PRIMA is further partitioned according to the block structure in state matrices from Eq. (11).

$$V = [ \begin{matrix}{V}_{{1}_{( {n}_{1} \times q )}} \\ {V}_{{2}_{( {n}_{2} \times q )}} \\ ⋮ \\ {V}_{{m}_{( {n}_{m} \times q )}}\end{matrix} ] \to \tilde{V} = [ \begin{matrix}{V}_{{1}_{( {n}_{1} \times q )}} & 0 & ⋯ & 0 \\ 0 & {V}_{{2}_{( {n}_{2} \times q )}} & ⋯ & 0 \\ ⋮ & ⋮ & ⋰ & ⋮ \\ 0 & 0 & ⋯ & {V}_{{m}_{( {n}_{m} \times q )}}\end{matrix} ] \qquad ( 13 )$$

wherein \tilde{V}εR^{N×mq}. This construction is referred to herein as m×m Block Structure preserving Model Reduction (BSMOR), where m is the number of blocks. The order reduced state matrices can be obtained by projecting \tilde{V}:
\tilde{G}′=(\tilde{V})^{T}G′\tilde{V}, \tilde{C}=(\tilde{V})^{T}C\tilde{V}, \tilde{B}=(\tilde{V})^{T}B (14)

Element wise, the result is
\tilde{G}′_{i,j}=Vᵢ^{T}G′_{i,j}Vⱼ, \tilde{C}_{i,j}=Vᵢ^{T}C_{i,j}Vⱼ, \tilde{B}ᵢ=Vᵢ^{T}Bᵢ, (15)
where \tilde{G}′_{i,j} represents the blocks at i block row and j block column in reduced matrix \tilde{G}′, similarly \tilde{C}_{i,j}, \tilde{B}ᵢ represent reduced matrices to simplify notations. Using such a matrix \tilde{V}, a reduced-order model is defined with the following transfer function
\tilde{H}(s)=\tilde{B}^{T}(\tilde{G}′+s\tilde{C})⁻¹\tilde{B} (16)

This result extends 2×2 case given by SPRIM. If the number of columns in V is k, then the number of columns in \tilde{V} is mk. As a result, \tilde{G}′ is m times larger than G′. Conceivably, \tilde{H}(s) has m times more eigenvalues than that of Ĥ(s). Based on the Grimme's projection theorem, \tilde{H}(s) should match m times more poles or moments than Ĥ(s). Similar to SPRIM, the reduced model of passive network obtained by Krylov-subspace projection preserves passivity. One important observation is that, if the couplings among blocks are weak, introducing more partitions or blocks can archive the same reduction accuracy by using a smaller Krylov subspace, which can in turn improve reduction efficiency. On the other hand, it has been observed that the partitioned projection matrix \tilde{V} leads to localized projection as shown by Eq. (15). In other words, the block projection matrix \tilde{V}ᵢ is used only for matrix blocks G′_{i,x} and G′_{x,i} (x=1, . . . m). In this sense, Krylov subspace given by \tilde{V} becomes a structured Krylov subspace in \tilde{V}. Each structured block projection matrix \tilde{V}ᵢ will lead to the localized model order reduction for block i, which is represented by G′_{i,x} and G′_{x,i} matrix blocks (x=1, . . . m). Conceivably, the order reduced block \tilde{G}′_{i,x} and \tilde{G}′_{x,i} will match G′_{i,x} and G′_{x,i} to the first q moments. Yet, the whole system consisting of the m blocks will match mq poles instead q poles by PRIMA.

FIG. 1 depicts a comparison of maximum error using PRIMA and BSMOR for a 256×256 RC-mesh (320K circuit elements), for example up to 20 GHz. The figure compares maximum error frequency responses by PRIMA, 2×2, and by 8×8 BSMOR with respect to iteration number during reduction. At the same iteration number, it shows that using more partitions (block number) to construct the projection matrix can have better accuracy than using less partitions as PRIMA does. In other words, BSMOR can generate more compact model with improved pole matching ability.

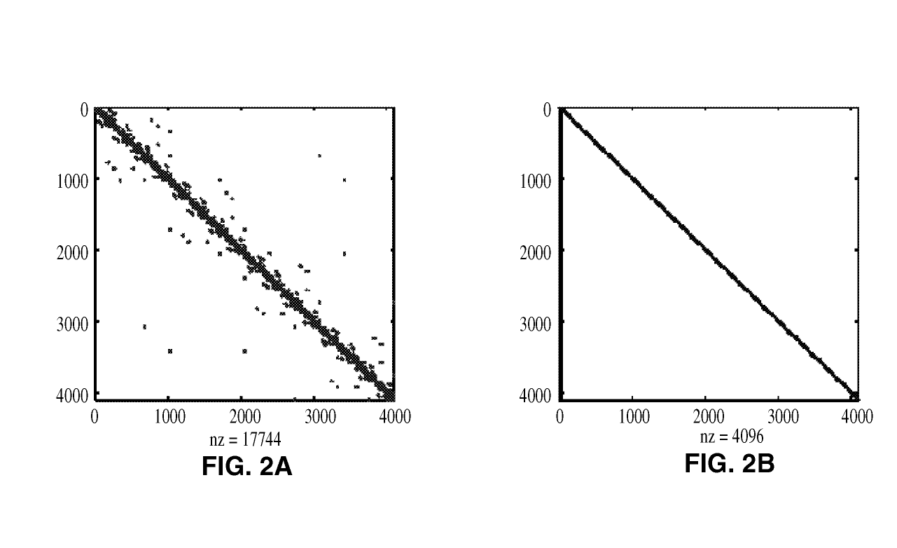

FIGS. 2A-2B are graphs of non-zero patterns before reduction.

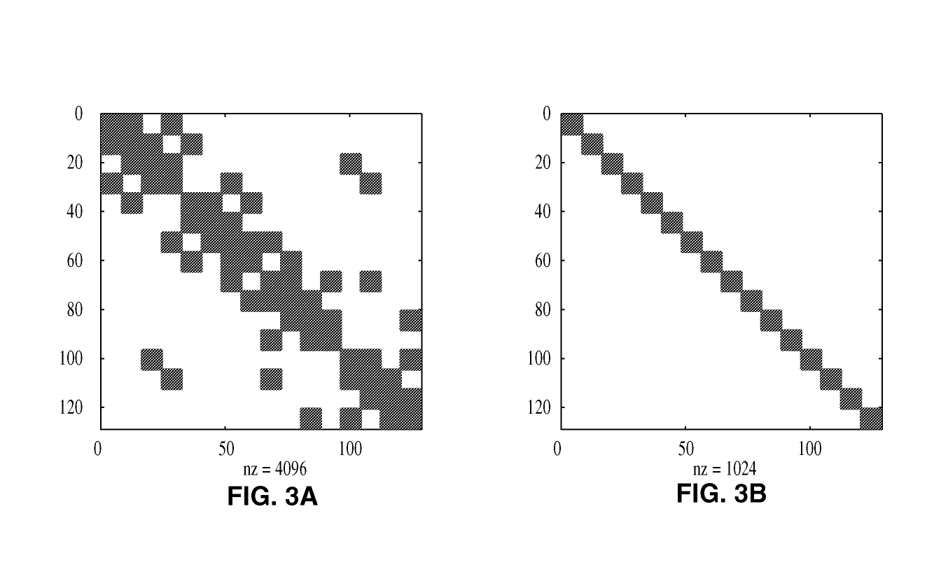

FIGS. 3A-3B depict non-zero patterns for G, C matrices of a preferably uniform RC-mesh (256×256) after a 16×16 BSMOR reduction with 8 iterations, where NZ is the number of non-zero poles. It should be appreciated that due to the structured construction of \tilde{V} by Eq. (13), BSMOR preserves the sparsity of \tilde{G}′, \tilde{C}′ matrices even after the reduction. For example, for the 256×256 RC-mesh above, FIGS. 3A-3B shows the structure of these two state matrices after the 16×16 BSMOR reduction. The \tilde{G}′, \tilde{C}′ matrices show 72% and 93% sparsification ratio, respectively. It is another advantage to use BSMOR other than PRIMA, as PRIMA generates a fully dense state matrices after the reduction. Moreover, the sparsification ratio increases when increasing the block number.

This can be envisioned conceptually because when a block contains only one element, the “reduced” state matrices become exactly the same as the original sparse state matrices.

3. Bordered-Block Diagonal Partitioning with Hierarchical Clustering

In this section, the generation of the flat macro-model is described by the reduced state matrices from Section 2.2. To efficiently handle the flat macro-model with a large number of ports, a bordered-block diagonal (BBD) partitioning is described for solving each block individually. Moreover, a hierarchical clustering method is discussed to further improve efficiency.

3.1 Flat Macro-Model

For the frequency-dependent application in the analog/RF simulation like the substrate noise analysis, an Y-parameter based multiple port macro-model is widely used instead. An nₚ×nₚ MIMO admittance matrix Y′(s) can be obtained by taking the eigen decomposition of Ã=(\tilde{G}+s₀\tilde{C})⁻¹\tilde{C}

$$\begin{matrix}{Y}^{′} ( s ) = [ \begin{matrix}{Y}_{1 , 1}^{′} & ⋯ & {Y}_{1 , np}^{′} \\ ⋮ & ⋰ & ⋮ \\ {Y}_{np , 1}^{′} & ⋯ & {Y}_{np , np}^{′}\end{matrix} ] , \\ with & ( 17 ) \\ {Y}_{i , j}^{′} = {c}^{i , j} + {\sum }_{n = 1}^{q} \frac{{k}_{n}^{i , j}}{s - {p}_{n}} , & ( 18 )\end{matrix}$$

where kₙ and pₙ are the residues and poles. It should be recognized that eigenvalues of Ã^{(q)} represent the reciprocal poles of Y′(s). Due to the preserved sparsity, the eigen-decomposition becomes more efficient when using the \tilde{G}′, \tilde{C}′ from the BSMOR other than using those from PRIMA. Furthermore, as the structure is preserved during reduction, additional aspects are preserved, including the following. (i) The reciprocity of the network (i.e., the Y′(s) is symmetrical). In contrast, PRIMA does not preserve this property. (ii) The block structure is preserved as well. It means the reduced block can be distinguished by a subset of ports specified before BSMOR. As a result, an additional port-partitioning can be further applied, precisely, bottom-up port clustering to handle the large number of ports as discussed later on. To partition a given network, the nodal admittance of Eq. (17) is first transformed into a branch admittance network:

$${Y}_{ii} = {\sum }_{j = 1}^{{n}_{p}} {Y}_{ij}^{′} , {Y}_{ij} = {Y}_{ij}^{′} \qquad ( 19 )$$

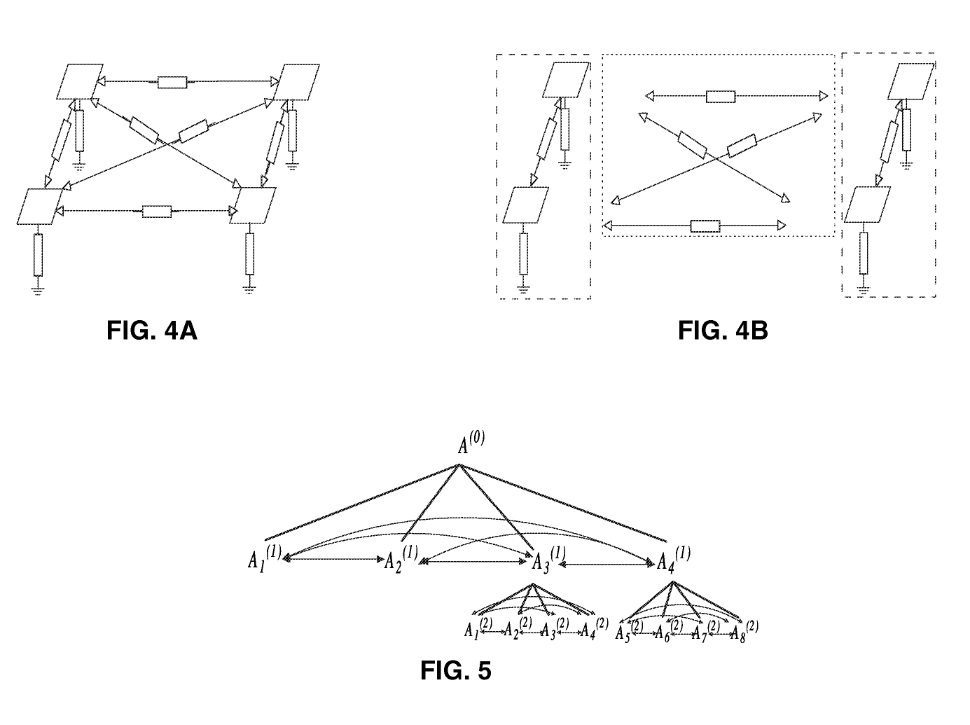

FIGS. 4A-4B depict an example of four-port admittance with two reduced blocks. In FIG. 4A a realization in a branch admittance network is shown; while in FIG. 4B the network is represented by two reduced blocks with an additional coupling block. It should be appreciated that the flat macro-model consists of m order reduced blocks, where each reduced block contains n_{Pk} ports with ground and coupling branch admittances. There also exists coupling branch admittances between any pair of reduced blocks. FIG. 4A illustrates a transformed branch admittance network for a four-port admittance matrix. To partition the branch admittance network Y, one natural approach is to reserve each reduced block, and pack all the coupling branch admittances into one block, referred to as a coupling block that connects all reduced blocks. An example of such a partitioning (or representation of the macro-model from BSMOR) is shown in FIG. 4B for the four-port admittance matrix.

3.2 Bordered-Block Diagonal Matrix

For the k th reduced block
Yₖvₖ=iₖ+ĩₖ, (20)
where

$${( {Y}_{k} )}_{ii} = {\sum }_{j = 1}^{{n}_{pk}} {Y}_{ij}^{′} , {( {Y}_{k} )}_{ij} = - {Y}_{ij}^{′} ( j ∈ {n}_{pk} ) \qquad ( 21 )$$

and vₖ, iₖ are the port voltage and current vectors, where iₖ is part of iₚ:

$${i}_{k} = {i}_{p} ( … \underbrace{ {i}_{k 1} ..}_{{n}_{p k}} … ) .$$

Moreover, ĩₖ is referred to as the “correlation current” from the other reduced block through the coupling block. The branch equation for the coupling block is:
(Y₀)⁻¹i₀=v₀ (22)
where Y₀ is the branch admittance matrix describing the branches in the coupling block. It is a diagonal matrix such that its inversion is easily obtained as 1/(Y₀)ᵢᵢ. It should be recognized that its size depends on the number of couplings among reduced blocks, and it can be efficiently implemented with the sparse matrix data structure. The variables v₀ and i₀ represent branch voltage and current vectors. They relate to the port voltage/current vectors vₖ/iₖ at the k th block by

$${\tilde{i}}_{k} = {c}_{k 0} {i}_{0} , {v}_{0} = - {\sum }_{k = 1}^{m} {( {c}_{k 0} )}^{T} {v}_{k} \qquad ( 23 )$$

where cₖ₀ is the cut matrix composed by {0,1,−1} to indicate the direction of branch currents between kth reduced block and the coupling block. Combining Eqs. (21)-(23), yields the following hybrid matrix equation

$$[ \begin{matrix}{Y}_{1} & 0 & ⋯ & 0 & {C}_{10} \\ 0 & {Y}_{2} & ⋯ & 0 & {C}_{20} \\ ⋮ & ⋮ & ⋰ & ⋮ & ⋮ \\ 0 & 0 & ⋯ & {Y}_{{}_{m} ( l )} & {C}_{m 0} \\ {( {C}_{10} )}^{T} & {( {C}_{20} )}^{T} & ⋯ & {( {C}_{m 0} )}^{T} & - {( {Y}_{0} )}^{- 1}\end{matrix} ] [ \begin{matrix}{v}_{1} \\ {v}_{2} \\ ⋮ \\ {v}_{1} \\ {i}_{0}\end{matrix} ] = [ \begin{matrix}{i}_{1} \\ {i}_{2} \\ ⋮ \\ {i}_{m} \\ 0\end{matrix} ] \qquad ( 24 )$$

This hybrid matrix shows a bordered-block-diagonal (BBD) structure. It enables Algorithm 1 (below) to solve each reduced block individually without using the explicit inversion. Each reduced block matrix is first solved individually with LU factorization and substitution (see Algorithm 1 steps 1.1-1.5), the results from each reduced block are then used further to solve the coupling block (steps 2.1-2.4), and the final vₖ of each reduced block is updated (steps 3.1-3.4) with the result from the coupling current i₀.

Algorithm 1

```
Solve bordered-block-diagonal (BBD) matrix 1.
1. Solve Yₖ individually
for every k in m do:
  (1.1) input: Yₖ, Cₖ₀, iₖ;
  (1.2) factor: Yₖ = LₖUₖ;
  (1.3) solve: LₖΦₖ = Cₖ₀ for Φₖ, ΨₖUₖ = (Cₖ₀)^{T} for Ψₖ,
          and Lₖξₖ = iₖ for ξₖ;
  (1.4) form: Fₖ = Φₖ^{T}Ψₖ, and Gₖ = Ψₖ^{T}ξₖ
  (1.5) output: Fₖ, Gₖ.
end for
2. Solve Y₀
  (2.1) input: Y₀, Fₖ, Gₖ;
  (2.2) form: F = Y₀⁻¹ + Σₖ₌₁^{m}Fₖ, G = Σₖ₌₁^{m}Gₖ;
  (2.3) solve: Fᵢ₀ = G for i₀;
  (2.4) output: i₀.
3. Update Yₖ individually
for every k in m do
  (3.1) input: i₀, Φₖ, ξₖ, Uₖ;
  (3.2) form: ξₖ = ξₖ − Φₖi₀;
  (3.3) solve: Uₖvₖ = ξₖ for vₖ;
  (3.4) output: vₖ.
end for
```

Typically, LU factorization requires n³/3 multiplications and back/forward substitution requires n²/2 multiplications. The computational cost of Algorithm 1 is therefore,

$${\sum }_{k = 1}^{m} ( {n}_{{p}_{k}}^{3} / 3 + {n}_{{p}_{k}}^{2} / 2 ) + ( {n}_{0}^{3} / 3 + {n}_{0}^{2} / 2 ) ,$$

where n_{Pk} is the port number (reduced block size) of each reduced block, and n₀ is the size of the coupling block. If parallel execution is utilized, then it should be noted that the summation becomes the maximum execution time among blocks. To reduce computational cost without the use of parallel execution, costs need to be controlled for reduced blocks and the coupling block as discussed below.

3.3 Hierarchical Clustering

As the factorization cost decreases with the size of the reduced block, apparently the computation cost will be small when the network is partitioned based on the reduced basic block from BSMOR. However, the size of Y₀ increases with the reduced block number, and it increases the computation cost. To wisely arrange this trade-off, a hierarchical tree structure is used.

FIG. 5 illustrates an example of a hierarchical tree structure according to an aspect of the present invention, wherein each node represents an abstract block. There are links connecting each pair of correlated blocks, representing inter-block couplings. The tree is constructed by iteratively clustering the reduced blocks from the bottom. The degree and the level is chosen to bound the size of the coupling block below a threshold. At the leaf level, a cluster of reduced blocks are siblings of a parent node, an abstract block. A cluster-coupling block is introduced to model the coupling between siblings. There is no direct coupling between abstract blocks which are not in the same cluster, while their coupling is modeled by cluster-coupling blocks for parent nodes. Therefore, a constant link number (couplings) can be maintained at each tree level. It should be noted that the following merge operation is performed when two blocks k and l are clustered
_{new}=[iₖ,iₗ], v_{new}=[vₖ,vₗ]
and

$${( {Y}_{new} )}_{ii} = {\sum }_{j ∈ {n}_{{p}_{k}} ⋃ {n}_{{p}_{l}}} {Y}_{ij}^{′} , {( {Y}_{new} )}_{ij} = - {Y}_{ij}^{′}$$

At the bottom level, each clustered block is solved using Algorithm 1. It is inefficient to calculate vₖ directly on the higher levels since the block size get larger and larger. Fortunately this is not necessary, because one can use the already calculated vₖ of the children, same as is done to attach the voltage sources to the coupling block at parent node. To do this i₀ needs to be updated from (l−1) th level to l th level by

$${v}_{0}^{( l - 1 )} = - {\sum }_{k = 1}^{{m}^{( l - 1 )}} {( {c}_{k 0}^{( l )} )}^{T} {v}_{k}^{( l - 1 )} , {i}_{0}^{( l - 1 )} = {Y}_{0}^{( l )} {v}_{0}^{( l - 1 )} \qquad ( 24 )$$

and then solve vₖ at the l th level by steps (3.1-3.4) in Algorithm 1. Moreover, with the hierarchical tree structure, vₖ is recursively updated by a bottom-up depth-first traversal of the tree, where it is assumed that the cut matrices and block branch admittance are pre-computed and stored hierarchically. For simplicity of presentation, the BBD analysis with hierarchical clustering is called BBDC analysis. It should be noted that when the factorization cost of a large matrix at the top level is large, an error-bounded sparsification technique is further applied to the branch admittance matrix. As the sparsification is performed at the top level, this error is bounded.

4. Block Specification in Substrate Noise Analysis

In this section, the application of BSMOR and BBDC analysis to the substrate macro-modeling and noise analysis is discussed. The substrate outside of active/contact areas can be treated as a uniformly doped layer, where an electrostatic Maxwell's equation is:

$$ɛ \frac{\partial }{\partial t} ( ∇ \cdot E ) + \frac{1}{ρ} ( ∇ \cdot E ) = 0 \qquad ( 25 )$$

The Eddy current term (the primary cause of substrate loss) can be ignored if the substrate is highly doped, wherein the conduction current is dominant. It should be recognized that the equation can be discretized in differential form using finite-difference or integral forms using boundary element (BEM) methods. As the BEM method relies on finding a numerically stable multi-layer Green's function, it is generally a non-trivial matter to construct when the layout geometry becomes arbitrary. The finite-difference based discretization is used herein to generate the RC mesh/grid as the substrate circuit model. As the electric field varies nonlinearly as a function of the distance, the finite-difference method approximates this variation as a piecewise constant function by carefully choosing the pitch of the mesh according to the current density, such as the strength of the electrical field.

For leading-edge integrated circuits, the gate count is typically on the order of millions of gates. The number of possible locations to place contacts of sensitive analog/RF circuits is also quite large. Accordingly, a flat multi-port description of each individual substrate noise injector and receptors is impractical. Consequently, it is assumed that the chip is partitioned into smaller circuits, (i.e., blocks) based on the switching current density. As a result, within a given block all noise current injections can be clustered into one independent current source at one single injection port. Such a block has a maximum current spectrum envelope to characterize the injection noise sources in a bottom-up fashion. The noise current injected by the gate G at frequency fₚ is denoted i_{G}(fₘ), and fₘ=m×f₀ (m=0,1,2, . . . M),where f₀ is the clock frequency and M is the sampling bound. Then, the total noise current of c_{N} gates in k th block is

$${i}_{{C}_{k}} = {\sum }_{k = 1}^{{C}_{N}} {i}_{{G}_{k}} ( {f}_{m} ) ,$$

and by a library-based characterization of the primary input transition vₚ, the block current envelope spectrum is found by iₖ^{max}(fₘ)=maxᵥₚ|i_{C}_{ₖ}(fₘ)|.

Therefore, if there are m characterized blocks, each block would contain n_{Pk} user specified ports, including one input port representing the injecting current noise source according to the above block current assumption, and (n_{Pk}−1) output ports representing all possible contact locations for analog/RF modules. There are a total of

$${n}_{p} ( {n}_{p} = {\sum }_{k = 1}^{m} {n}_{{p}_{k}} )$$

specified ports. The port current vector iₚ becomes:

$${i}_{p} = [ \underbrace{{i}_{1}^{max} … 0}_{{n}_{{p}_{1}}} \underbrace{{i}_{k}^{max} … 0}_{{n}_{{p}_{k}}} \underbrace{{i}_{m}^{max} … 0}_{{n}_{{p}_{m}}} ] ,$$

where all omitted entries are zeros standing for probing output ports. It will be noted that the propagated noise is observed from vₚ.

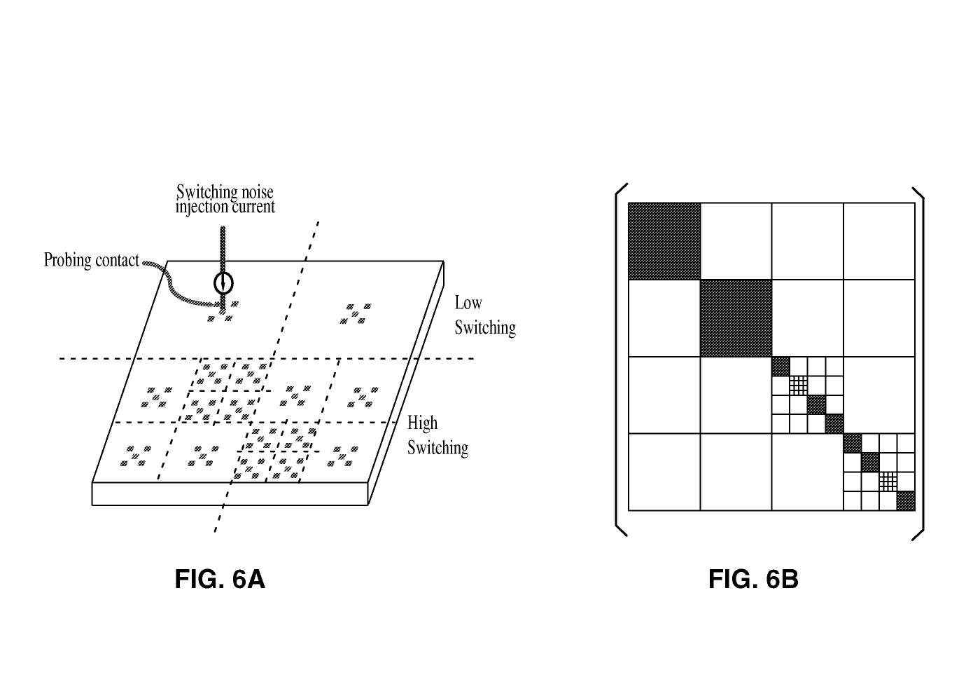

FIGS. 6A-6B illustrates characterization of mesh networks. FIG. 6A depicts a non-uniform substrate mesh network characterized by the switching current density, while FIG. 6B depicts the corresponding block structure of conductance/capacitance matrices.

With the use of the power management techniques like clock gating, the i_{C}ₖ(fₘ) can be significantly non-uniform for each block across the chip. For the block with the high current density, the electric field tends to vary largely, and finer grids are necessary to produce an accurate approximation. Otherwise, for lower current densities a coarse grid may be utilized instead. For example, the substrate plane in FIG. 6A has four parts subject to different switching current densities and results in a non-uniform mesh structure. As a result, this example demonstrates a block structure according to the block current density. For example, FIG. 6B depicts a block structure for the block current distribution in FIG. 6A.

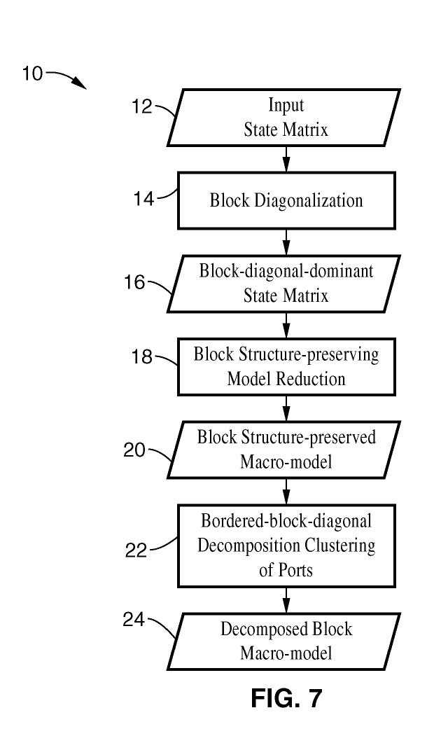

FIG. 7 illustrates a summary flowchart 10 of the BSMOR method. Block diagonalization of the state matrix is performed at step 12 to provide a block diagonalization at block 14. A block preserving model reduction is applied at block 18 to the diagonal matrix to yield a block-structure preserved macro-model as per block 20. A bordered block diagonal decomposition clustering of ports is performed as per block 22 to yield a decomposed block macro model shown in block 24.

5. BSMOR and BBDC Test Results

BSMOR and BBDC analysis were implemented on a Linux workstation (P4 2.66 GHz, 1 G RAM). The mesh structures of the substrate were generated from the typical mixed signal circuit application. In this section, the scalabilities are studied by increasing the circuit size and number of ports. As an example, the noise map is also presented for a 256-contact array injected by a frequency-varying ring oscillator at DC and 10 GHz.

5.1 Scalability Study Under Same Accuracy

The efficiency of the reduction convergence by BSMOR and PRIMA is described herein, with different block numbers utilized according to the different circuit sizes. An error bound is set as shown in Table 1, defined by the maximum error of the frequency response at one port up to 20 GHz. Then reductions of BSMOR and PRIMA are performed by increasing their iterations until accuracies meet the desired bound. As shown in Table 1, BSMOR requires fewer iterations (e.g., ≦8) than PRIMA does for meeting the error bound. As a result, the reduction time of BSMOR is also smaller than that of PRIMA. For example, for the mesh circuit with 1M elements, BSMOR achieves 20× (240.22 seconds for BSMOR as compared with 4982.76 seconds for PRIMA) speedup under the error bound 1 e⁻⁴. In this example a relatively small block number (64) is chosen for the circuit (1M), as BSMOR uses additional steps to construct the projection matrix, and utilizes a somewhat larger state matrix which increases the cost of matrix-vector multiplication. Hence, the BSMOR speed increase can be somewhat compromised if a large block number is chosen. In general, the result illustrates that using more partitions to construct a project matrix within BSMOR can match more poles than the PRIMA technique and hence the reduction time can be significantly reduced under the same accuracy.

The simulation of time scalability in the partitioned macro-model is further studied by BBDC. In this example, PRIMA is used to generate the flat macromodel, while BSMOR is used to generate the partitioned macro-model with hierarchy, and different block numbers are used to generate the macro-model according to the port number. Each reduced block contains 10 ports. The original, flat and partitioned models are all simulated in frequency domain up to 20 GHz. The maximum error of the frequency response (relative to the original model) up to 20 GHz at a selected port is used for comparison.

It was observed that when the port number is less than 50 ports, the simulation time of the partitioned macro-model is up to 30× times faster than the flat macro-model with a similar accuracy. This speedup is achieved largely from two sources, as follows. (i) The cost of the eigen-decomposition to construct a flat macro-model is reduced by BSMOR as the sparsity of reduced state matrices is reserved. On the other hand, PRIMA produces a dense reduced state matrices that are computation expensive during the eigen-decomposition. (ii) The partitioned solution further reduces the simulation time as no expensive computation is involved for the large system matrix. To achieve a similar efficiency for the circuits with a large number of ports (>100), hierarchical clustering (degree 10) is further used with sparsification (e.g., 5% error bound) to control the size and sparsity of the coupling blocks. In this case for 1-level and 2-level hierarchical solutions, the admittance matrices are sparsified at the bottom level and the second level, respectively.

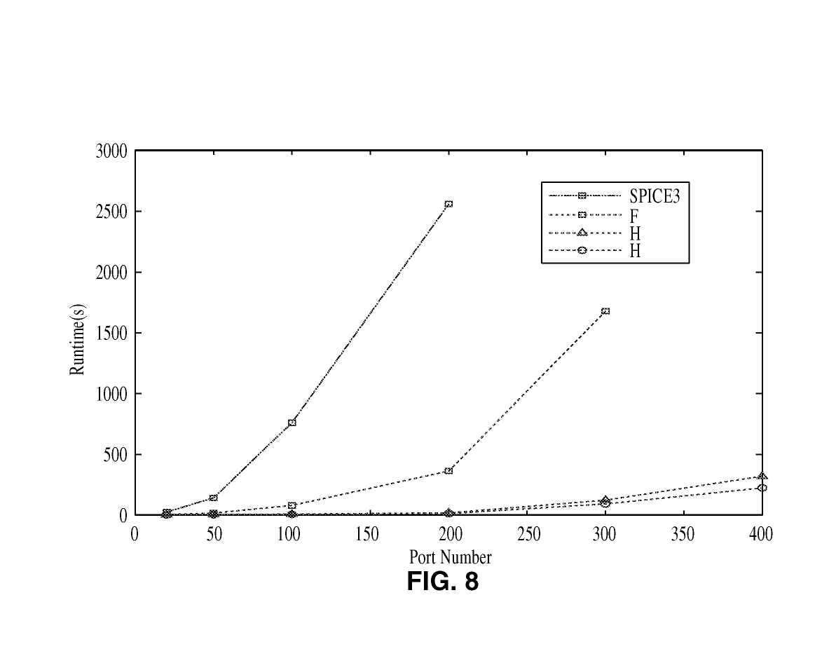

FIG. 8 illustrates the scalability trend of simulation time for the original model, flat macro-model, and partitioned models with different hierarchical levels. Since the error at local matrix can propagate up, the solution is found by sparsification at the 1-level partition is less accurate than that found at the 2-level partition. Moreover, it is found that the flat macro-model can not be completed for a 400-port circuit. From the clear scalability trend of FIG. 8 it is seen that the simulation time of the flat macro-model grows rapidly in response to the number of ports, thus illustrating a similar trend-line as the original model. This is due to the fact that the dense matrix structure degrades the overall performance when compared to the original larger but sparser matrix. In contrast, with the use of the BBDC analysis, the simulation time grows much more slowly than the flat macro-model.

5.2 Map of Substrate Noise Spectrum

The partitioned macro-model is then applied to generate a map of substrate noise spectrum. The injection current of a frequency varying ring oscillation is characterized at f₀=100 MHz; 1 GHz. The maximum currents are characterized in time domain and then FFT (2048 samplings) is used to obtain the current envelope in frequency domain. The substrate considered here is a 3 mm×3 mm plane with a 200 μm thick p-type substrate (σ=0.1 [Ωcm]⁻¹). In this example it is assumed that the contacts are in a 16×16 array, and that all noise current injection sources (e.g., ring oscillators) are placed diagonally in the array. The original substrate circuit is a 256×256 RC-mesh with 320K elements, and a 32×32 BSMOR is performed to obtain a 256-port macro-model, representing a 16×16 contact array. The reduction time is about 120 seconds. A two-level hierarchical partition is used to generate a port-matrix response within 90 s.

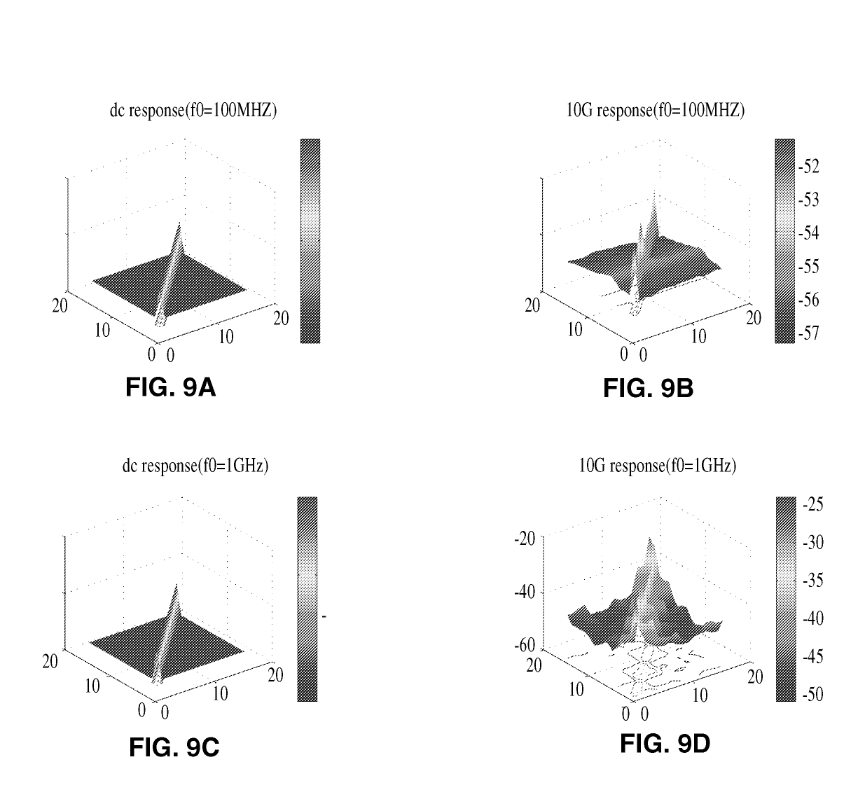

FIGS. 9A-9D depicts noise envelope mapping for a 16×16 contact array at DC levels and then injected by frequency controllable ring oscillators at f₀=100 MHz and f₀=1 GHz. FIGS. 9A, 9C shows the map of the noise envelope (voltage bounce magnitude) at DC, and in FIGS. 9B, 9D at 10 GHz. Clearly, reducing the central clock frequency from 1 GHz (FIG. 9B) to 100 MHz (FIG. 9D) can reduce 25 db peak noise at the high frequency (10 GHz), but the noise envelope at DC is not reduced. Moreover, the substrate noise coupling is localized at DC but it can diffuse across the contact array at 10 GHz. As a high conductivity substrate is assumed, the use of the guard ring is effective for this type of substrate. A p+-guard ring is used for the isolation with the conductivity σ=100 [Ωcm]⁻¹. Herein, the effect of this isolation is modeled by changing the surrounding resistance of the contact for each ring oscillator.

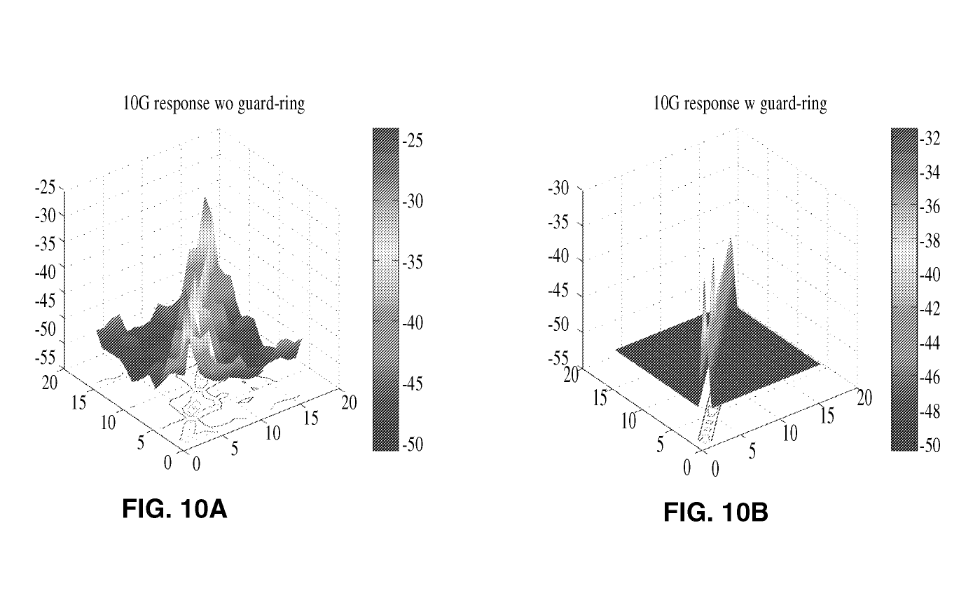

FIGS. 10A-10B depict noise maps at high frequency 10 GHz (f₀=1 GHz) with and without guard rings. As shown in these figures with the use of a guard ring, such as at 10 GHz for f₀=1 GHz, the substrate noise is confined around the injection sources at the diagonal of the contact array.

6. Conclusions for BSMOR

In this section a block structure preserving model reduction (BSMOR) has been taught in which increasing block number leads to more matched poles or moments than can be arrived at using PRIMA with the same number of iterations. BSMOR in turn improves the model reduction efficiency compared to PRIMA under the same error bound. For a circuit with 1M elements, BSMOR has a 20× smaller reduction time than PRIMA does. As BSMOR preserves the structure of state matrices, it generates sparse reduced state matrices. For a circuit with 320K elements, the reduced state matrices (G′,C′), has 72% and 93% sparsification ratio after a 16×16 BSMOR reduction. It leads to an efficient construction of a MIMO macro-model when using eigen-decomposition. To be able to handle the resulting macro-model with large number of ports, bordered-block diagonal partition with hierarchical clustering (BBDC) was further utilized to decompose the macro-model into blocks with the manageable size. The tests illustrated that BBDC reduced simulation time by over 30-fold as compared with the original macro-model.

(B) Fast Analysis of Structured Power Grid by Triangularization Based Structure Preserving Model Order Reduction

7. Introduction to Structured Grid Triangularization

Power integrity verification is an essential phase in designing on-chip Power/Ground (P/G) grids. It is beneficial to design a structured P/G grid that is globally irregular and locally regular according to the current density. This results in a P/G circuit model as a heterogeneously structured network as will be described herein.

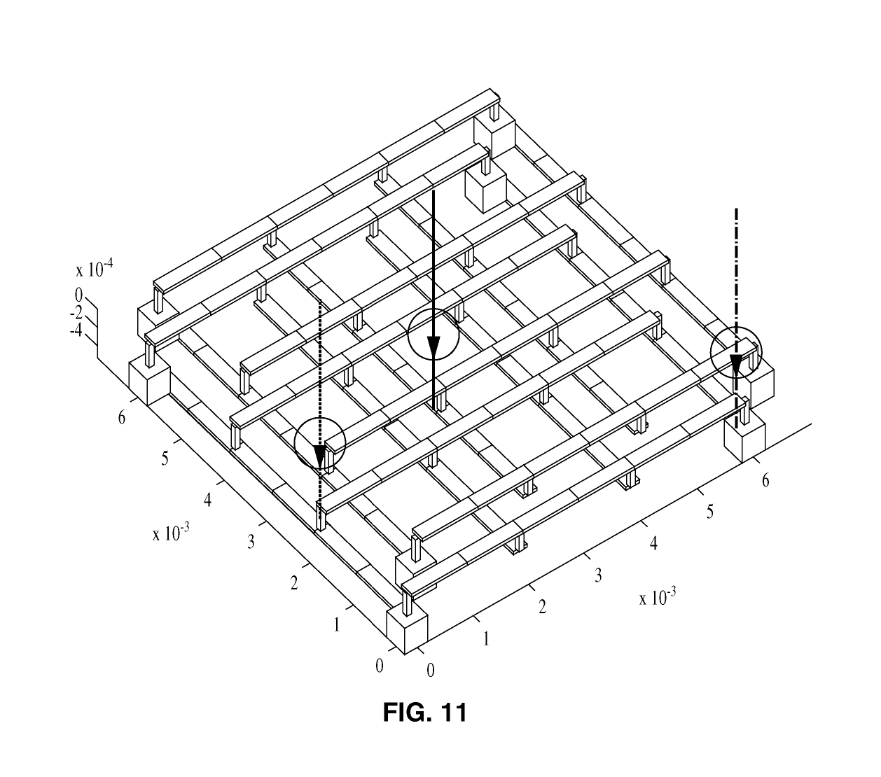

FIG. 11 illustrates an example P/G grid with select nodes marked. Real world examples may include millions of nodes. To ensure power integrity, specialized simulators for P/G grid are required to efficiently and accurately analyze the voltage bounce/drop using macromodels. In performing hierarchical analysis, internal sources are often eliminated to obtain a macromodel with only external ports. The entire grid is partitioned at, and connected by, those external ports. Because elimination results in a dense macromodel, an additional sparsification is often applied that is error-prone and inefficient. An alternative approach to obtain macromodels is to use projection based model order reduction (MOR) such as PRIMA. The reduced model by PRIMA from a projection matrix with order q can match n=[q/p] block moments (p is the port number). Although PRIMA can be implemented by iterative path-tracing to efficiently solve tree structured P/G grids, it is inefficient as applied to mesh structured P/G grids. The difficulty to apply MOR in P/G grid analysis appears to mainly stem from the following. The cost of Arnoldi orthonormalization is high for circuits of a large size, and the moment matching using block Krylov subspace is less accurate with an increased number of ports. In addition, the reduced macromodel is dense, which slows down simulation when the port number is large.

To reduce orthonormalization cost for large sized circuits, HiPRIME applies a partitioned PRIMA to reduce the entire circuit in a divide-and-conquer fashion. After gluing the reduced state matrices, HiPRIME performs an additional projection to further reduce the entire system. However, the PRIMA and HiPRIME approaches utilize a flat projection that leads to the loss of the block structure of the state matrices such as sparsity and hierarchy. As a result the macromodel becomes too dense to be efficiently factorized in the time/frequency-domain simulation.

To overcome these problems a triangularization based structure preserving model order reduction is taught, referred to herein as the TBS method. As discussed in Section 8, instead of matching block moments of the transfer function, moments of output are directly matched with an excitation current vector. As a result, the first q moments or q dominant poles of output can be matched using a projection matrix with order q, which is independent of port number. In contrast, the number of matched block moments by PRIMA decreases as the port number increases. Hence our approach has improved accuracy for circuits with large number of ports. As discussed in Section 9, we represent the original system by interconnected basic blocks. The basic blocks are obtained from the current density of locally regular structures in P/G grids. Each basic block is reduced independently with order q, its first q dominant poles are determined, and its corresponding projection matrix is obtained. A dominant-pole based clustering is then performed to obtain m clusters of basic blocks, where m is decided by the nature of structured networks. Each cluster is called as a compact block with a unique pole distribution and a projection matrix accordingly.

As discussed in Section 10, the system is further triangulated into a triangular system with m compact blocks in the diagonal. The poles of the resulting triangular system are determined only by m diagonal blocks. Projection matrices are constructed and applied for compact blocks separately. The reduced triangular system is provable to match mq poles of the original one, which is an important aspect of the present invention. It should be recognized that since PRIMA and HiPRIME can only match q poles using the same number of moments, the reduced system by TBS is more accurate, alternatively TBS can provide a higher reduction efficiency under the same error bound.

The BSMOR method, described in prior sections leverages the subblock structure in state matrices G and C. After obtaining a flat projection matrix by PRIMA, BSMOR constructs a new block-diagonal projection matrix accordingly. Its resulting macromodel matches more poles than PRIMA does and hence improves accuracy. However, in BSMOR the system poles are not solely determined by those blocks in the diagonal part of G and C. As a result, the polematching in BSMOR is not typically as accurate as that in TBS, while BSMOR can be somewhat inefficient for large sized circuits because it orthonormalizes the entire state matrix to obtain the projection matrix.

As discussed in Section 11, because the projection preserves the structure, the obtained macromodel by TBS is intrinsically sparse, and does not require the LP-sparsification procedure used in some hierarchical analysis of power distribution networks. In addition, the macromodel by TBS can be efficiently analyzed by a two-level relaxation analysis in both frequency and time domain, where the implicit integration is used in TBS to obtain the time domain response. As a result, the reduction and simulation of macromodels by TBS are both performed at block level, while their computational cost is small, although triangularization increases system size. In contrast, the reduced model by PRIMA or HiPRIME is dense and can not be analyzed directly with relaxation. Section 12 presents test results, while Section 13 provides conclusions.

8. Power Integrity Verification

8.1 Grimme's Moment Matching Theorem

Using the modified nodal analysis (MNA), the system equation of a P/G grid in the frequency(s)-domain is
(G+sC)×(s)=BI(s), y(s)=L^{T}x(s) (26)
where x(s) is the state variable vector, G and C are state matrices for conductance and capacitance with size N, B and L (εR^{N×p}) are input/output port incident matrices with p ports, and I(s) is the input current sources. Eliminating x(s) in Eq. (26) yields
H(s)=L^{T}(G+sC)⁻¹B (27)

H(s) is a multiple-input multiple-output (MIMO) transfer function. Its expanded (s₀) columns are contained in n th-order (n=[q/p]) block-Krylov subspace K (A, R, n), for example
K(A, R, n)=span(V)={R, AR, . . . , Aⁿ⁻¹R} (28)
where two moment generation matrices are A=(G+s₀C)⁻¹C and R=(G+s₀C)⁻¹B. Using the Arnoldi method, PRIMA finds a orthonormalized projection matrix V(εR^{N×q}), whose columns span block-Krylov subspace K(A, R, n). The reduced transfer function is
Ĥ(s)=\hat{L}T(Ĝ+sĈ)⁻¹ \hat{B} (29)
where Ĝ=V^{T}GV, Ĉ=V^{T}CV, \hat{B}=V^{T}B, \hat{L}=V^{T}L. It should be noted that Ĝ and Ĉ (εR^{q×q}), and \hat{B} and \hat{L} (εR^{q×p}). It has been shown that Ĥ(s) preserves the block moments of H(s), as seen below.

Theorem 1.

If K(A, R, n)⊂span(V), then the first n expanded block moments at s₀ are identical for Ĥ(s) in Eq. (29) and H(s) in Eq. (27).

8.2 Moment Matching of Output Response

According to Theorem 1, if there is only one port, i.e., a (single-input single-output) SISO system, the reduced model can match q moments. When the port number p is large, which is typical for P/G grids, the number of matched block moments n reduces and the reduced transfer function Ĥ(s) is less accurate. In this case, it can be preferably to define an excitation current vector
J=BI(s)
and to directly match the moment of output
x(s)=L^{T}(G+sC)⁻¹J (30)

The new moment generation matrices become A=L^{T}(G+sC)⁻¹C, and R=L^{T}(G+s₀C)⁻¹J. Using the Arnoldi method, a qth-order orthonormalized projection matrix can be found to contain the new Krylov subspace K(A, R, q). As a result, the reduced output response \hat{x}
\hat{x}(s)=\hat{L}^{T}(Ĝ+sĈ)⁻¹Ĵ (31)
matches the first q moments of y, and is independent of the port number p. It should be appreciated that Ĵ=V^{T}J, which is because a MIMO system with right-handside Bu can be transformed into superposed SISO systems with J. The following Theorem, Theorem 2, has been proven in the industry.

Theorem 2.

Assume an MIMO system with unit-impulse current source u, and define the excitation current vector J=BI(s), where I(s)εR^{p} and JεR^{N}. When the q columns of projection matrix V are obtained, the reduced response at the output \hat{x}(s) in Eq. (31) Ĵ=V^{T}J matches the first q moments of the original \hat{x}(s) in Eq. (30).

The following two systems have the same output x(s)
(G+sC)×(s)=Bu(s), (G+sC)×(s)=J(s)

In addition, J can be decomposed into p non-zero excitation components

$$J = {\sum }_{i = 1}^{p} {J}_{i} = {[ \begin{matrix}{J}_{1} & 0 & … & 0\end{matrix} ]}^{T} + … + {[ \begin{matrix}0 & … & {J}_{P} & 0\end{matrix} ]}^{T} .$$

Clearly for each Jᵢ (i=1,2, . . . , p), it is equivalent to excite an SISO system with input Jᵢ. The according reduced output \hat{x}ᵢ(s) matches the first q moments of xᵢ(s). With superposition, it is easy to verify that

$${\sum }_{i = 1}^{p} {\hat{x}}_{i} ( s )$$

matches the first q moments of

$${\sum }_{i = 1}^{p} {x}_{i} ( s ) .$$

In contrast to this, PRIMA matches n=[q/p] block moments of the transfer function with the input matrix B. This theorem has been verified by experiments and extended to inputs with non-impulse current sources by using a generalized excitation current source with an augmented Arnoldi orthonormalization. In addition we have the following corollary.

Corollary 1.

The first q dominant poles of x(s) in Eq. (30) are matched by \hat{x}(s) in Eq. (31). Poles are calculated from the eigen-decomposition of the order reduced moment matrix Ã=\tilde{G}⁻¹\tilde{C}(εR^{q×q}). With an input of excitation current vector J, the first q moments are identical for x(s) and \hat{x}(s). So do the first q dominant poles. In this present invention, the reduction is performed to match the moment of output x(s).

9. Compact Block Formulation

To handle large sized P/G grids and generate an accurate and sparse macromodel, we represent the original grid in compact blocks, where the overlap of pole distribution between compact blocks is minimized.

FIG. 12 illustrates representations of two P/G blocks and a total of eight nodes. It will be appreciated that a number of interconnected basic blocks can be used to represent both homogeneous and heterogeneous circuits.

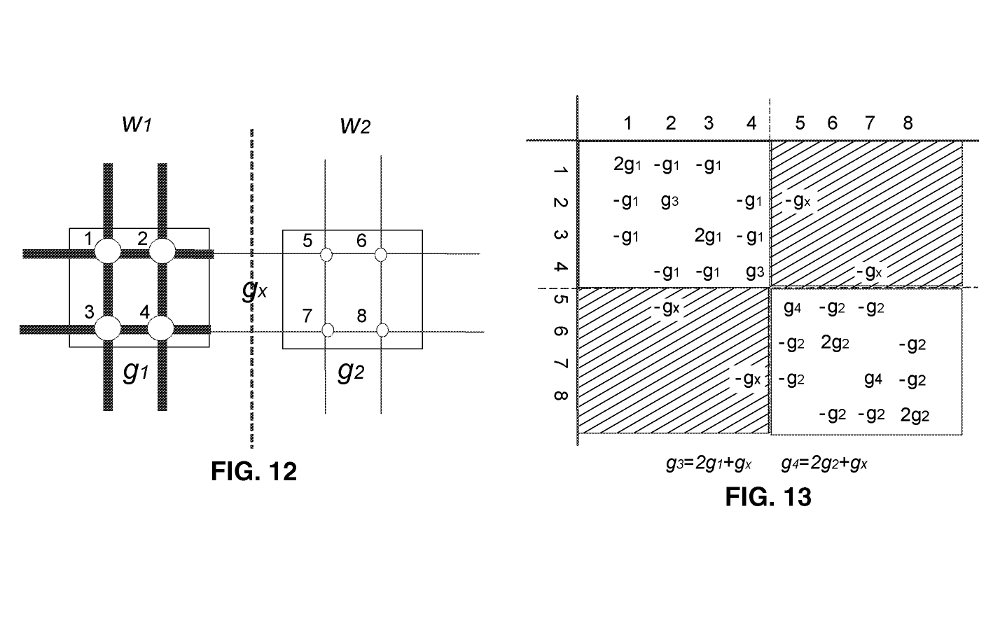

FIG. 13 illustrates off-diagonal matrices representing the nodes of FIG. 12. Each of the basis blocks has a time constant, while different basic blocks can share the same or similar time constant.

9.1 Two-Level Organization of Basic Block

The original P/G grids can be partitioned into m₀ basic blocks, wherein a dense grid with a small pitch is used for a region having a high current density, while a sparse grid with a large pitch is used for a region having low current density. The i th basic block has state matrices gᵢᵢ and cᵢᵢ. Due to the heterogeneous structure of grids, each block can have different RC time constant. Moreover, gᵢᵢ and cᵢᵢ are interconnected by the coupling block gᵢⱼ and cᵢⱼ (i≠j), respectively. The resulting block-based state matrices are

$$G = [ \begin{matrix}{g}_{11} & … & {g}_{1 {m}_{0}} \\ ⋮ & ⋰ & ⋮ \\ {g}_{{m}_{0} 1} & … & {g}_{{m}_{0} {m}_{0}}\end{matrix} ] \\ C = [ \begin{matrix}{c}_{11} & … & {c}_{1 {m}_{0}} \\ ⋮ & ⋰ & ⋮ \\ {c}_{{m}_{0} 1} & … & {c}_{{m}_{0} {m}_{0}}\end{matrix} ] \\ J = {[ {J}_{1} … {J}_{{m}_{0}} ]}^{T} , x = {[ {x}_{1} … {x}_{{m}_{0}} ]}^{T} . \qquad ( 32 )$$

In addition, G and C can be decomposed into the following two-level representation containing diagonal part Y₀(s), and off-diagonal part Y₁(s), where
Y₀(s)+Y₁(s)=G+sC (33)

Clearly, Y₀(s)=G₀+sC₀ with
G₀=diag[g₁₁, . . . ,gₘ_{₀}ₘ_{₀}], C₀=diag[c₁₁, . . . ,cₘ_{₀}ₘ_{₀}]

It should be noted that each block matrix gᵢᵢ or cᵢᵢ is symmetric positive definite (s.p.d), for example each basic block is stable. The off-diagonal part (Y₁)ᵢⱼ is composed by the coupling block gᵢⱼ and scᵢⱼ (i≠j). Its entries are usually smaller than those in basic blocks in the diagonal. Accordingly, the moment generation matrices for each basic block are
(A₀)ᵢ=(gᵢᵢ+s₀cᵢᵢ)⁻¹cᵢᵢ, (R₀)ᵢ=(gᵢᵢ+s₀cᵢᵢ)⁻¹Jᵢ

This two-level decomposition facilitates structure-preserving model order reduction and two-level analysis in Sections 10 and 11.

9.2 Clustering

The behavior of each basic block can be approximately determined by its q dominant poles, such as the first q most dominant eigen-values (λ₁≦ . . . ≦λ_{q}). However, this form of basic block representation is not compact. There are numerous basic blocks with similar time-constants as well as many basic blocks with quite dissimilar time-constants. To obtain a more compact block representation, a bottom-up clustering algorithm is put forth herein based on the dominant poles. Let basic block i have a q-dominant-pole set
Λᵢ={λ₁≦ . . . ≦λ_{q}},
its pole distance from another basic block j is defined as
d(Λᵢ, Λⱼ)=max{min{|λₘ−λₙ|:λₙεΛⱼ}:λₘεΛᵢ}.

The two basic blocks have a similar pole distribution and are clustered if d(Λ′ᵢ, Λᵢ)<ε where ε is a small value specified by the user. After clustering basic block i (gᵢᵢ, cᵢᵢ) with (gⱼⱼ, cⱼⱼ) and their interconnection (gᵢⱼ, cᵢⱼ), the q-dominant-pole set of the clustered block becomes
Λ′ᵢ={λ′₁≦ . . . ≦λ′_{q}},

Additional basic blocks can be merged into this cluster if they have a similar pole distribution as the cluster. On the other hand, a basic block itself is a cluster if it does not share a similar pole distribution with other blocks. For clustering purpose, the first q dominant poles for a basic block is obtained by model order reduction. A qth-order projection matrix Vᵢ is found for basic block i by
span(Vᵢ)=K((A₀)ᵢ,(R₀)ᵢ,q) i=1, . . . ,m₀. (34)

The above results in a order reduced (Ã₀)ᵢ (εR^{q×q}), whose reciprocal eigen-values are poles of the reduced system, and match the first q dominant poles of the original system according to Corollary 1. The cost of eigen-decomposition is inexpensive if the size of reduced model is small. Because the excitation current vector is used during the moment matching of the output, the size q of the reduced model with desired accuracy is small even when the original basic block contains large number of ports. In contrast, the block moment matching by PRIMA may result in a larger cost of eigen-decomposition. The clustering obtains m clusters of basic blocks, where m is decided by the nature of P/G grids and ε. Clusters are referred to herein as a form of compact block. The clustering results in an interconnected compact block representation, where the sets of q-dominant poles for compact blocks have minimum overlap between them. Therefore, the present method reduces redundant information because fewer compact blocks are needed to represent the structured system.

10. TBS Model Order Reduction

Although clustering results in m blocks, each with a unique pole distribution, the poles of the entire grid are not determined only by those diagonal blocks. Discussion proceeds In this section about forming of the upper triangular system (G′, C) that are equivalent to the original system (G, C), and the system poles of (G′, C) are determined only by its diagonal blocks. This enables block structured projection that can match more poles than the flat projection.

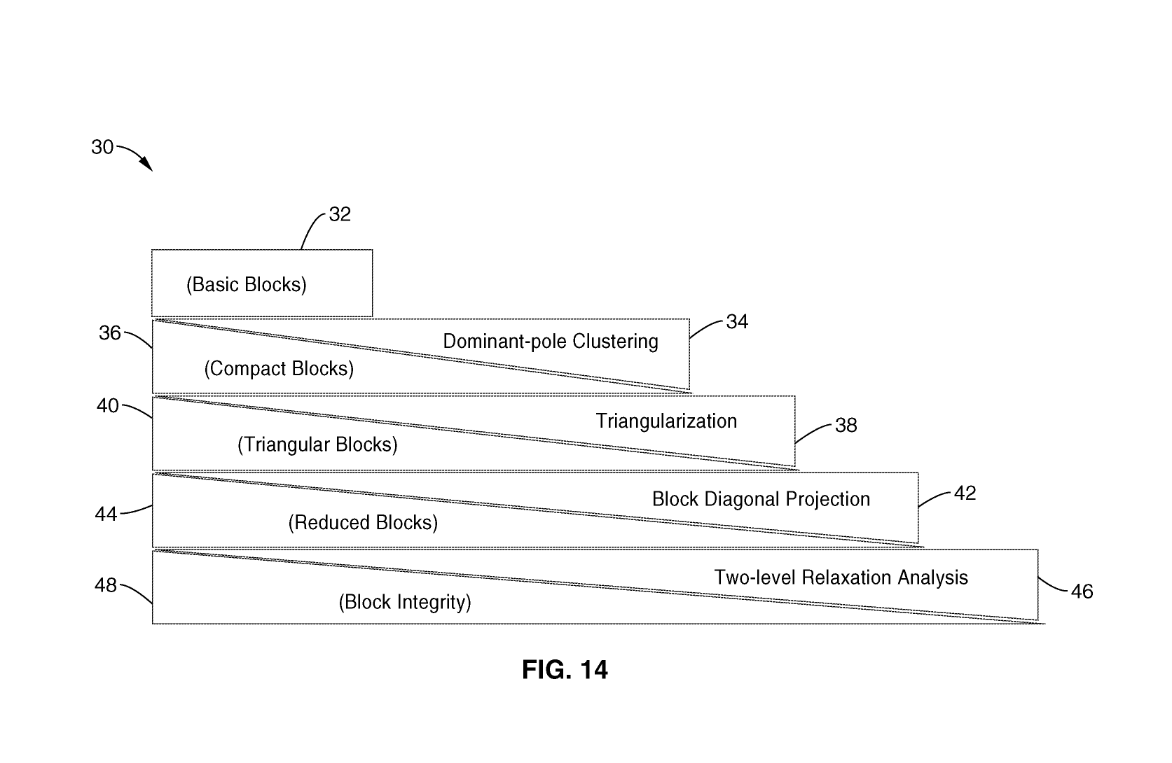

FIG. 14 is a combination flow-data diagram 30 for the triangular block structured moment matching process according to this aspect of the present invention. Basic blocks of triangle 32 are subjected to dominant-pole clustering as per triangle 34 and yielding compact blocks as per triangle 36. Triangularization at 38 converts the compact blocks to triangular blocks 40. After block diagonal projection 42 a set of reduced blocks 44 are generated. The use of a two-level relaxation analysis 46 further reduces simulation cost to output blocks 48 with higher block integrity.

10.1 Triangularization

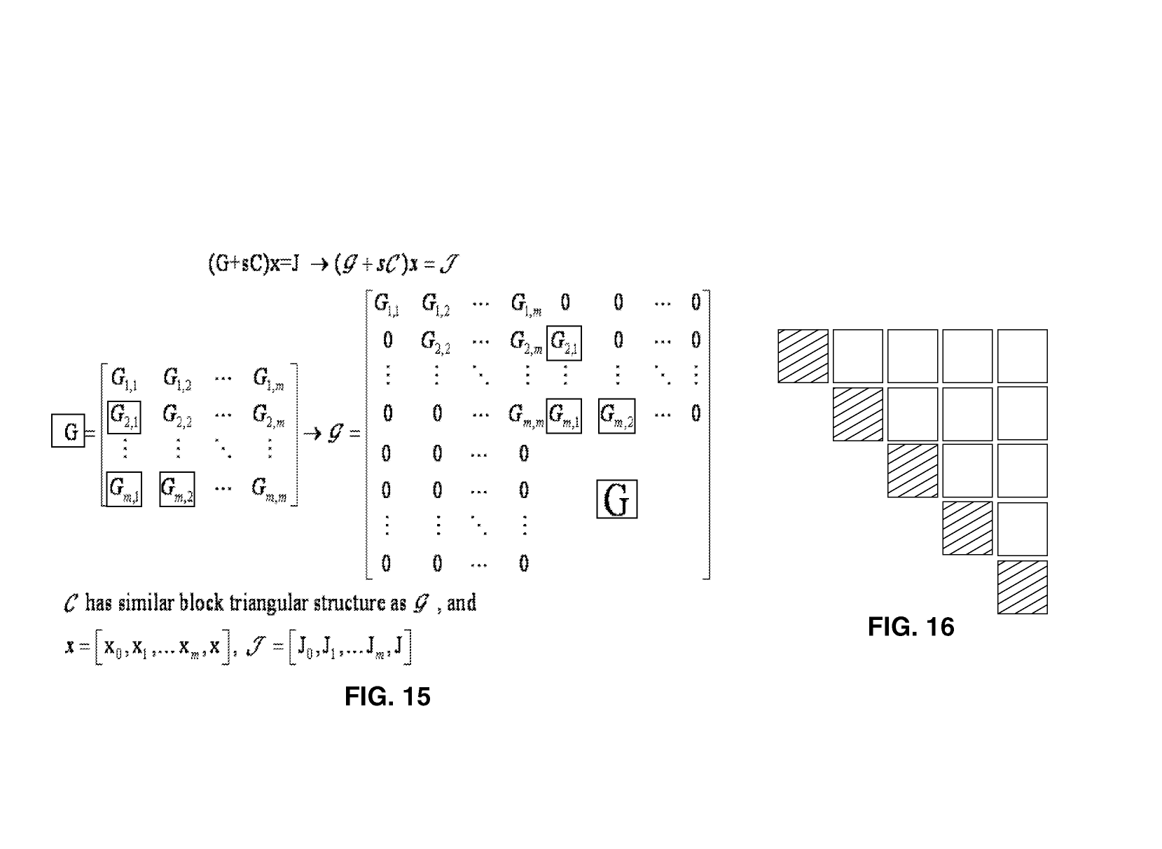

FIG. 15 and FIG. 16 are shown by way of introduction of the triangularization method according to the present invention. In FIG. 15 a replica block is shown stacked diagonally, with the lower-triangular portions moved to the new upper-triangular portions. This process is preferably implemented by a block matrix data structure without increasing memory usage. The result is shown in the upper-triangular portion of FIG. 16 and provides a number of advantages, including the following. (1) Block duplication results in an equivalent solution. (2) System poles are determined only by those compact blocks in the diagonal. (3) A triangular system has a factorization cost which only arises from the diagonal blocks.

The following proceeds with a specific example as shown in the left portion of FIG. 15. With respect to the following G after the clustering discussed in Section 9.2

$$G = [ \begin{matrix}{G}_{11} & {G}_{12} & … & {G}_{1 m} \\ {G}_{21} & {G}_{22} & … & {G}_{2 m} \\ ⋮ & ⋮ & ⋰ & ⋮ \\ {G}_{m 1} & {G}_{m 2} & … & {G}_{m m}\end{matrix} ] , \qquad ( 35 )$$

the triangularization introduces a replica of G, and moves those lower triangular blocks Gᵢⱼ (i<j) to the upper triangular parts at G_{i,m+j}. This results in an upper triangular state matrix G

$$G = [ \begin{matrix}\underline{\begin{matrix}{G}_{11} & {G}_{12} & … & {G}_{1 m} \\ 0 & {G}_{22} & … & {G}_{2 m} \\ ⋮ & ⋮ & ⋰ & ⋮ \\ 0 & 0 & … & {G}_{m m}\end{matrix}} \\ 0 \\ \begin{matrix} & & & & \end{matrix}\end{matrix} \vert \begin{matrix}\underline{\begin{matrix}0 & 0 & … & 0 \\ {G}_{21} & 0 & … & 0 \\ ⋮ & ⋮ & ⋰ & ⋮ \\ {G}_{m 1} & {G}_{m 2} & … & 0\end{matrix}} \\ G \\ \begin{matrix} & & & & \end{matrix}\end{matrix} ] , \qquad ( 36 )$$

can be transformed in a similar fashion. In addition, the new state variable x is
x=[x₁ x₂ . . . xₘ x]^{T},
where x is defined in Eq. (32), and the port matrix B′ and L′ have similar structures as x. The resulting triangular system equation is
(G′+sC)x(s)=J′,y(s)=L′^{T}x(s) (37)

It is easy to verify that the solution x(s) from Eq. (37) is the same as x(s) from Eq. (26). The following sets forth that this new triangular system is stable.

Theorem 3.

The upper block triangular system (G′, C) is stable.

Proof: The eigen-values of the triangular system are given by the product of determinants of diagonal blocks

$$\vert {G}^{′} \vert = {\prod }_{i = 1}^{m + 1} \vert {( {G}^{′} )}_{i} \vert = \vert {( {G}_{0} )}_{1} \vert … \vert {( {G}_{0} )}_{m} \vert \vert G \vert .$$

Because each block (G₀)ᵢ (1≦i≦m) and G are positive definite, G′ is positive definite as well. The same procedure can be used to prove that C is positive definite. Therefore, G′+G′^{T} and C+C^{T} are both s.p.d, and hence the triangular system is stable.

It should be noted that directly solving Eq. (37) involves a similar cost to solve as Eq. (26) as the replica block at the lower-right corner needs to be factorized first. In addition, the dimension of the triangular system is increased. However, because the reduction in TBS is performed at the block level, the orthonormalization cost is small. Moreover, as shown below, its benefits can be further appreciated after a structure-preserving model order reduction, wherein the state variable of each reduced block can be solved independently with q matched poles.

10.2 Mq-Pole Matching

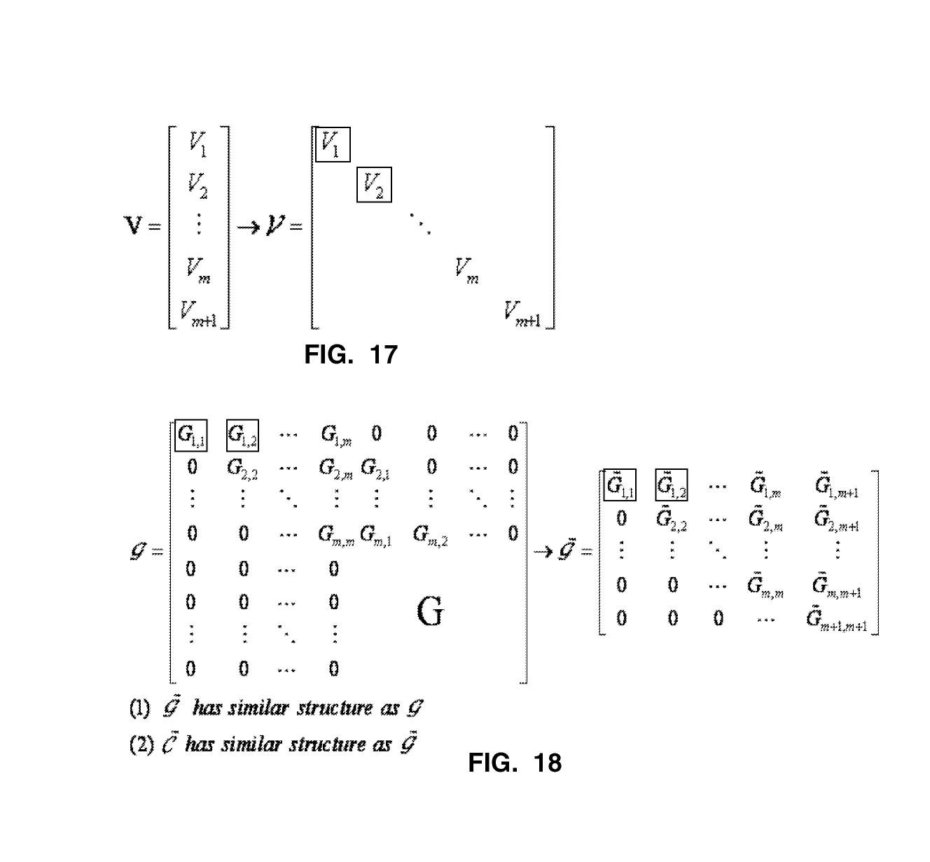

FIG. 17 and FIG. 18 are shown introducing the concept of the block diagonal projection process. In FIG. 17 a flat matrix v is shown split into a structured V with an increased rank by a factor of cluster number. In FIG. 18 the state matrices are reduced block by block while preserving upper-triangular structure. The block diagonal projection provides a number of advantages, including the following. (1) System moments and poles are matched locally. (2) The creation of more matched poles improves accuracy. (3) The reduced model preserves block triangular structure and structure of latency. Reduced blocks can be factorized independently while each can have different time constants.

After the clustering discussed in Section 9.2, a set of projection matrices [V₁_{₍ₙ}_{₁}_{×q)}, . . . , Vₘ_{₍ₙ}_{ₘ}_{×q)}] can be obtained, one for each diagonal compact block with size nᵢ. The projection matrix Vₘ₊₁ for the replica block can be obtained from a q-th order orthonormalization or practically constructed from
Vₘ₊₁=[V₁, . . . , Vₘ]^{T} (εR^{N×q}) (38)

Furthermore, instead of constructing a flat projection matrix
V=[V₁, . . . , Vₘ, Vₘ₊₁]^{T} (εR^{2N×q}) (39)
a block-diagonal structured projection matrix V′ is reconstructed:
V′=diag[V₁_{₍ₙ}_{₁}_{×q)}, . . . , Vₘ_{₍ₙ}_{ₘ}_{×q)}, Vₘ₋₁_{_{(N×q)}}] (40)
where

$${V}^{′} ∈ {R}^{2 N \times ( m + 1 ) q} , {\sum }_{i = 1}^{m} {n}_{i} = N .$$

It should be noted that V′^{T}V′=I, for example each column of \tilde{V} is still linearly independent and hence the total column-rank is increased by a factor of the block number m. With the use of V′ to project G′, C′ and B′ matrices at block level, respectively, we can obtain the order reduced state matrices
\tilde{G}′=V′^{T}G′V′, \tilde{C}′=V′^{T}C′V′, \tilde{J}′=V′^{T}J′.

The diagonal blocks in reduced G′ and C′ are referred to as reduced blocks. The reduced G′ matrix preserves the upper block triangular structure

$$\begin{matrix}{\tilde{G}}^{′} = [ \begin{matrix}{\tilde{G}}_{A}^{′} & {\tilde{G}}_{B}^{′} \\ 0 & {\tilde{G}}_{D}^{′}\end{matrix} ] , \\ where & ( 41 ) \\ {\tilde{G}}_{A}^{′} = [ \begin{matrix}{V}_{1}^{T} {G}_{11} {V}_{1} & {V}_{1}^{T} {G}_{12} {V}_{2} & … & {V}_{1}^{T} {G}_{1 m} {V}_{m} \\ 0 & {V}_{2}^{T} {G}_{22} {V}_{2} & … & {V}_{2}^{T} {G}_{2 m} {V}_{m} \\ ⋮ & ⋮ & ⋰ & ⋮ \\ 0 & 0 & … & {V}_{m}^{T} {G}_{m m} {V}_{m}\end{matrix} ] , \\ {\tilde{G}}_{B}^{′} = [ \begin{matrix}0 & 0 & … & 0 \\ {V}_{1}^{T} {G}_{12} {V}_{2} & 0 & … & 0 \\ ⋮ & ⋮ & ⋰ & ⋮ \\ {V}_{m}^{T} {G}_{m 1} {V}_{1} & {V}_{m}^{T} {G}_{m 2} {V}_{2} & … & 0\end{matrix} ] , \\ {\tilde{G}}_{D}^{′} = {V}_{m + 1}^{T} {GV}_{m + 1} . & ( 42 )\end{matrix}$$

Since BSMOR does not use triangularization, it's system poles are not determined by those diagonal blocks. Therefore, it's reduced macromodel does not exactly have mq poles matching.

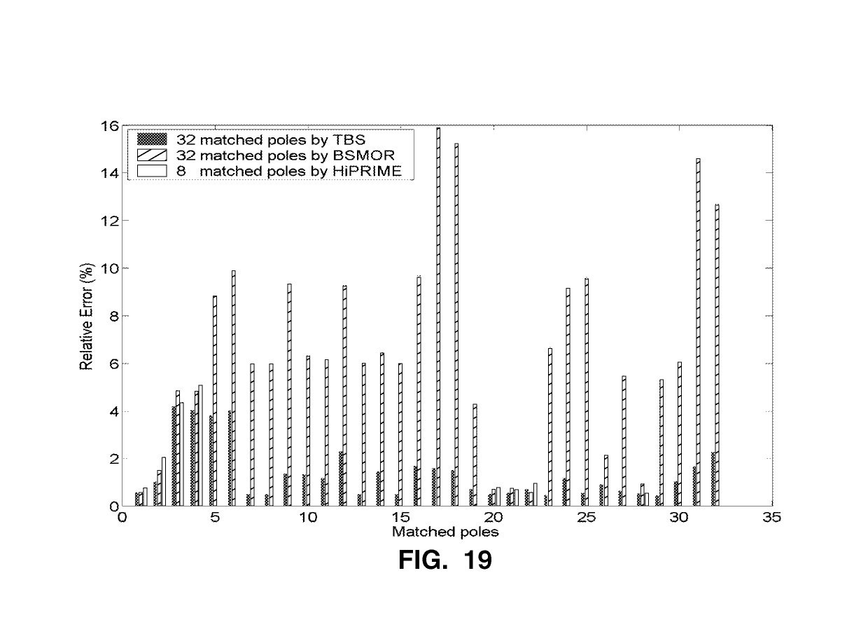

FIG. 19 illustrates pole matching via comparing mq poles matched by TBS and BSMOR, and q poles matched by HiPRIME, the tests are described in Section 12. In contrast, TBS can exactly match mq poles as discussed below.

Theorem 4.

For the state matrices G′, C in the upper triangular block form, if there is no overlap between eigen-values of the reduced blocks (\tilde{G}ᵢᵢ, \tilde{C}ᵢᵢ) (εR^{q×q}), for example,
|(\tilde{G}₀₀)₁+s(\tilde{C}₀₀)|∪ . . . ∪|(\tilde{G}₀₀)ₘ+s(\tilde{C}₀₀)ₘ|=Null, (43)
the reduced system (\tilde{G}′+s\tilde{C}) exactly matches mq poles of the original system (G′+sC).

Proof: Because the original G′ and C are in the upper triangular form, and the projection by V′ preserves the structure, the reduced \tilde{G}′ and \tilde{C} are in the upper triangular block form as well. For an upper triangular block system \tilde{G}′+s\tilde{C}, its poles (eigen-values) are the roots of its determinant |\tilde{G}′+s\tilde{C}|, which are determined only by the diagonal blocks

$$\vert {\tilde{G}}^{′} + s \tilde{C} \vert = {\prod }_{i = 1}^{m + 1} \vert {\tilde{G}}_{ii} + s {\tilde{C}}_{ii} \vert .$$

It should be seen that the eigenvalues of |\tilde{G}′+s\tilde{C}| represent the reciprocal poles of the reduced model. For the reduced block \tilde{G}ᵢᵢ+s\tilde{C}ᵢᵢ with input J′ᵢ, its output \tilde{x}ᵢ matches q moments and the first q domain poles of the output xᵢ for block Gᵢᵢ+sCᵢᵢ in the triangular system. Since the entire system consists of m compact blocks, each with unique pole distribution, the reduced model by TBS can match mq poles. The redundant poles obtained from the replica block are not counted here. With more matched poles, TBS is more accurate than HiPRIME and BSMOR, as will be verified by the test results described in Section 12.

11. Two Level Analysis

Because the projection in TBS preserves the structure, the reduced state matrices are sparse if the original ones are sparse. In contrast, when projected by flat projection V in PRIMA and HiPRIME, the resulted Ĝ is

$$\hat{G} = {\sum }_{i = 1}^{m + 1} {\sum }_{j = 1}^{m + 1} {V}_{i}^{T} {G}_{ij} {V}_{j} . \qquad ( 44 )$$

which loses the structure in general, and the reduced state matrices are dense. This slows down simulation when Ĝ and Ĉ are stamped back to MNA. Due to the structure-preserving, the reduced triangular system by TBS can be further analyzed efficiently either by a direct backward substitution or a two-level relaxation analysis. As the two-level analysis enables the parallelized solution and can be extended to the hierarchical analysis, it is utilized by way of example to obtain the solution in both frequency and time domains. As a result, the state variable of each reduced block can be solved independently with matched q poles. Using the two-level representation discussed in Section 9.1, the system equation for the reduced model is
\tilde{Y}′x=\tilde{b}. (45)

In frequency domain at a frequency point s, Eq. (45) becomes
\tilde{Y}′=\tilde{G}′+s\tilde{C}=\tilde{Y}′₀(s)+\tilde{Y}′₁(s), \tilde{b}=\tilde{J}′(s),
and in time domain at a time instant t with time step h, Eq. (45) becomes

$${\tilde{Y}}^{′} = {\tilde{G}}^{′} + \frac{1}{h} \tilde{C} = {\tilde{Y}}_{0}^{′} ( h ) + {\tilde{Y}}_{1}^{′} ( h ) , \\ \tilde{b} = \frac{1}{h} \tilde{C} x ( t - h ) + {\tilde{J}}^{′} ( t ) .$$

It should be noted that the time step h can be different for each reduced block according to its dominant-pole (λ₁). The state vector x can be solved for each block in a fashion of the two-level relaxation analysis, where
x=P⁽⁰⁾−PQ. (46)
with
P⁽⁰⁾=(\tilde{Y}′₀)⁻¹\tilde{b}, P=(\tilde{Y}′₀)⁻¹\tilde{Y}′₁, Q=(I+P)⁻¹P⁽⁰⁾. (47)

To avoid explicit inversion, LU or Cholesky factorization is applied to \tilde{Y}′₀ and I+(\tilde{Y}′₀)⁻¹\tilde{Y}′₁. As \tilde{Y}′₀ shows in the block diagonal form, each reduced block matrix is first solved independently with LU/Cholesky factorization and substitution at the bottom level. The results from each reduced block are then used further to solve the coupling block at the top level, and the final xₖ of each reduced block is updated. In addition, because the reduced \tilde{Y}′ has preserved block triangular structure, an implicit Back-Euler integration with the relaxation can stably converge.

12. Results for Power Grid Triangularization

The TBS was implemented and tested on a Linux workstation (e.g., P4 2.66 GHz, 1 Gb RAM). The RC mesh structures of the P/G grid were generated from industrial applications. In this section TBS is first verified, as to it preserving triangular structure (sparsity) and matching mq poles, and then its accuracy and runtime is compared with other method. The excitation current sources (unit-impulse) are explicitly considered in all MOR based methods to avoid block moment matching. The clustered block structure obtained from TBS is used as the partition for HiPRIME and HAPD (Hierarchical Analysis of Power Distribution), and the same block number is used for BSMOR although each block has the same size. A Back-Euler method is used for time-domain simulation, and a two-level analysis is applied for TBS, BSMOR and HAPD. In the comparison of the macromodel building and simulation time, all reduced models have similar accuracy. In the comparison of the waveform error, all MOR methods use the same number of matched moments, and macromodels for TBS and HAPD have the similar size and sparsification ratio.

12.1 Accuracy Comparison

A non-uniform RC mesh (size 2K×2K) it utilized with 32 same sized basic blocks and 32 unit-impulse current sources located at centers of basic blocks. Each basic block has a different RC time constant. The number of connections between a pair of basic blocks are also different. HiPRIME, BSMOR and TBS all use q=8 moments to generate the reduced model. The clustering algorithm found 4 clusters, each with 4, 4, 8, 16 basic blocks respectively. As a result, TBS constructs a block structured projection using 4 blocks with the aforementioned sizes. In contrast, BSMOR constructs a block structured projection using 4 blocks with same size.

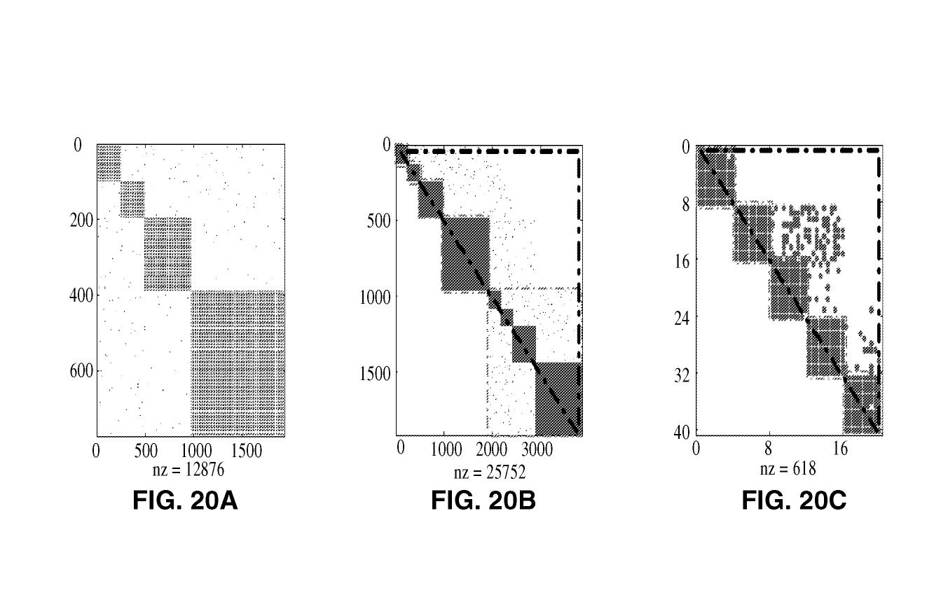

FIGS. 20A-20C illustrate nonzero-entry patterns of conductance matrices. In particular FIG. 20A illustrates the original system, FIG. 20B the triangular system, and FIG. 20C the reduced system by TBS. It should be noted that FIGS. 20A-20C have different dimensions, while FIGS. 20B-20C have the same triangular structure and same diagonal block structure. The similar block triangular structure verifies that TBS preserves block structure. Due to the intrinsic sparsity by TBS, the reduced model in this instance had a 40.1% sparsification ratio. In contrast, HiPRIME generates fully dense state matrices after the reduction and the sparsity in the reduced HAPD model is obtained by an additional LP-based sparsification. To compare pole-matching, an observation port was chosen that is not at the source node. The relative errors are calculated as the magnitude difference of poles between the reduced and original models. As shown by FIG. 19 HiPRIME only approximated 8 poles of the original model, while TBS and BSMOR approximated 32 poles due to increased column rank in the projection matrix. Moreover, for poles matched by both TBS and BSMOR, TBS is about 6× more accurate on average. This result arises, as discussed in Section 10.2, because the poles of triangularized system in TBS are determined only by its diagonal blocks.

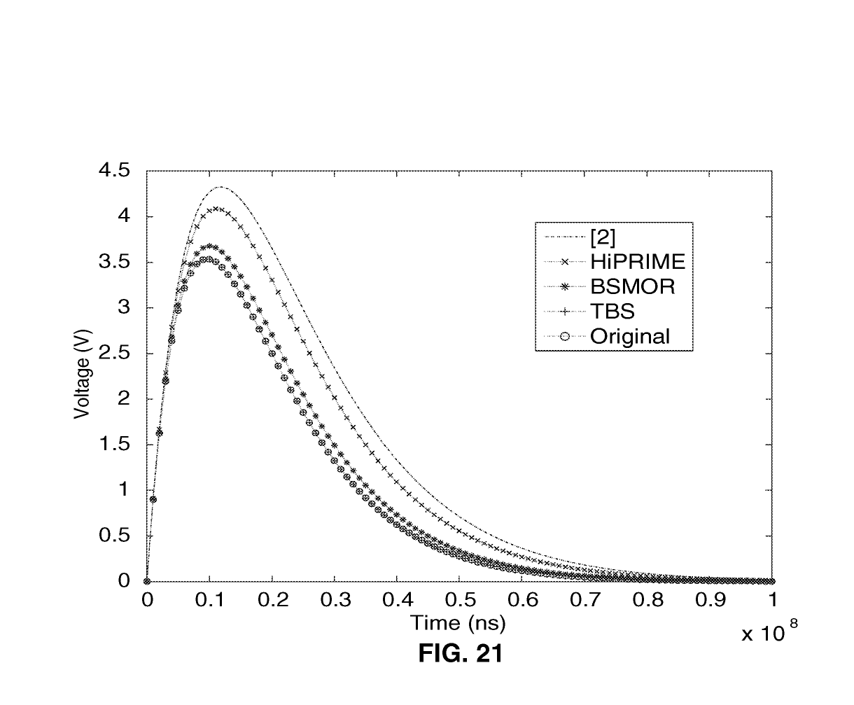

FIG. 21 compares the time-domain response at one port for HiPRIME, BSMOR, HAPD, TBS and the original under a unit-impulse input. The time-domain waveform error is counted as the relative deviation at peak voltage. The reduced model by TBS is visually identical to the original model, but HiPRIME has up to 36% error due to much fewer matched poles, and HAPD has up to 64% error due to the sparsification. As mentioned before, the projection matrix constructed by BSMOR uses 4 blocks with the same size. Consequently, it is not exact in matching poles and results in up to 23% error.

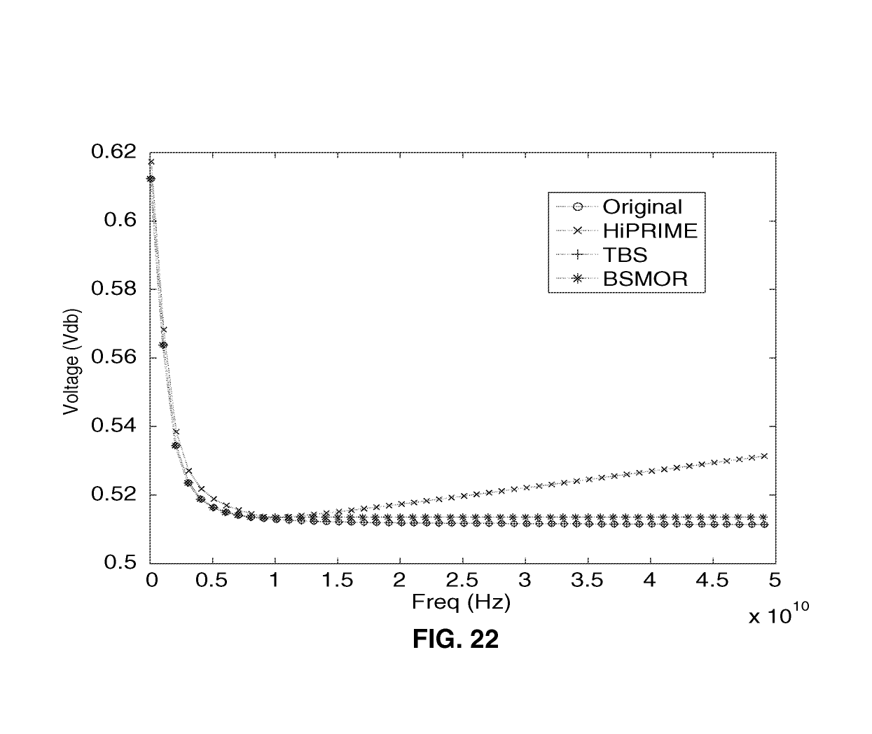

FIG. 22 is a graph that further presents the frequency domain response under an impulse input. Using same number of moments, it is observed that the reduced model by TBS is identical to the original up to 50 GHz, but the one by BSMOR or HiPRIME has non-negligible deviations beyond 10 GHz.

12.2 Scalability Study

Table 2 compares the accuracy scalability of reduced macromodel by HAPD, HiPRIME, BSMOR and TBS. All reduced models by MOR use the same number of moments. The standard deviation of waveform differences between the reduced and the original models is used as the measure of error. A higher order reduced model (by 4×) is used as the baseline for comparison if the waveform of the original model is unavailable. It was found that the accuracy of HAPD degrades when a large sparsity ratio is needed, because LP-based sparsification can not preserve accuracy. On the other hand, using moment matching based projection with preserved sparsity, TBS generates a macromodel with higher accuracy. For example, it has a 38× higher accuracy than HAPD when reducing a 7.68M circuit with 4800 ports to a (1K) macromodel with 32% sparsity. For the same circuit, TBS is 17× more accurate than BSMOR due to the exact mq-pole matching, and is also 33× more accurate than HiPRIME due to more matched poles. Because HAPD and BSMOR are inefficient to build macromodels and HiPRIME is inefficient to simulate macromodels, only TBS can handle a 7.68M circuit with 6.14M ports for less 1% waveform error.

Table 3 compares the run-time scalability of reduced macromodel by HAPD, HiPRIME, BSMOR and TBS. The runtime time here includes both the macromodel building time and macromodel simulation time (time-domain). The same circuits in Table 2 are used (but reduced state matrices are constructed with the similar accuracy). As for the macromodel building time, HAPD needs the additional LP-based sparsification, which is inefficient for large sized P/G grids. For example, for a RC-mesh with 7.68M nodes, the method in HAPD needs 4 hr:43 min:18 s to build a reduced macromodel with 1K nodes and sparsity 30%, but TBS only spends 2 min:8 s (133× speedup) to build the similar sized macromodel. Moreover, TBS also has 54× speedup than BSMOR (1 hr:45 min) because orthonormalization is applied to each block independently in TBS. HiPRIME orthnormalizes each block independently, but its building time is still larger than TBS. This is due to that a higher order (4×) is required to generate a reduced model with similar accuracy as TBS. Moreover, as for the simulation time, because HiPRIME still uses flat projection, it results in a dense macromodel, loses the structure information and can not be analyzed hierarchically. Therefore, it becomes inefficient to be used for time-domain simulation, wherein its simulation time is much larger than the other macromodels. On the other hand, HAPD, BSMOR and TBS enable the two-level analysis. For a circuit with 100K nodes and 480 ports, TBS achieves 109× runtime speedup compared to HiPRIME. In addition, for the circuit with 7.68M nodes and 6.14M ports, only TBS can handle it with 6 min: 16 s to build and 1 day:1 hr:29 min to simulate.

13. Conclusions for Structured Grid Triangularization

The present invention puts forth an accurate and efficient TBS model order reduction method to verify integrity of for large sized P/G grids in the time-domain. Using triangularization, it is shown that the original system is stably transformed into a form with upper triangular block structure, where system poles are determined only by m diagonal blocks, and m is decided by the nature of the structured network. With an efficient dominant-pole based clustering and a block structured projection, the reduced triangular system can match mq poles of the original system. Experiments show that the waveform error is reduced 33× compared to the flat projection method by HiPRIME. Moreover, with a two-level block representation, the reduction and analysis in TBS can be performed for each block independently. Therefore, it reduces both macromodel building and simulation time. In these tests TBS has significant benefits, such as demonstrating it is up to 54× faster in building macromodels than BSMOR, and up to 109× faster in simulating macromodels in the time-domain than HiPRIME. In addition, as TBS preserves sparsity, it is up to 133× faster to build macromodels than HAPD.

(C) Thermal Via Allocation for 3D ICs Considering Temporally and Spatially Variant Thermal Power

14. Introduction to Thermal Via Allocation for 3D ICs

Vias are an effective heat-removal approach which improves thermal conductivity. However, current techniques do not fully exploit vias while often introducing an excessive number of vias. This aspect of the present invention optimizes the use of vias and in particularly well suited for use in 3D ICs.

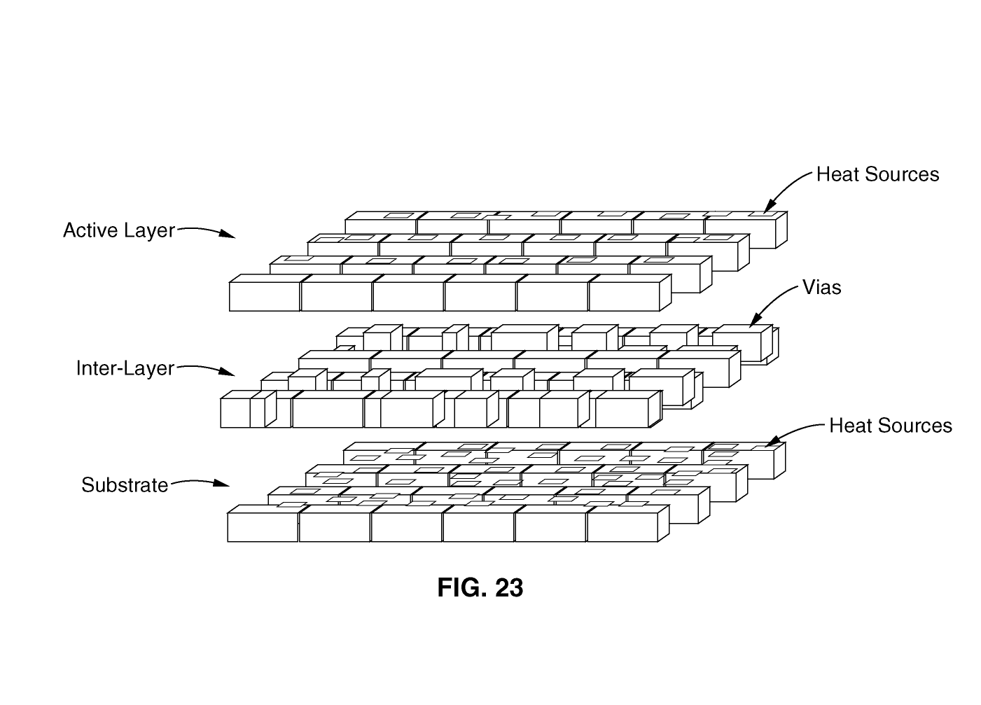

FIG. 23 shows the topology of typical 3D-IC designs including the active device layers, thermal-vias, and the substrate.

In view of different workloads and dynamic power management techniques such as clock gating technique extensively used in modern VLSI designs, power has both temporal and spatial variations. Transient thermal-power is the running average of the cycle-accurate power over the scale of the thermal constant. A cycle-accurate micro-architecture level thermal simulation referred to as Hotspot has been developed based on a thermal RC model to calculate the transient temperature. Assuming steady-state thermal analysis (based on thermal resistance model), thermal-via allocation has been studied during both placement and routing. Because the steady-state analysis ignores the temporal and spatial variations of the transient thermal-power, to obtain a solution without thermal violation, the current methods have to assume a maximum thermal-power simultaneously for all regions. As it is rare for different regions to simultaneously reach their maximum thermal-power, these current methods may lead to an excessive number of thermal vias. In addition, these techniques directly solve the matrix-formed state equation, and are unable to efficiently calculate the nominal temperature and its sensitivity with respect to the thermal-via density for large sized circuits. These current design procedures are either based on iterations, or on an approximated square-root relation between temperature and thermal-vias; wherein they may not converge or may produce inaccurate results. Therefore, accurate and efficient solutions to calculate temperature and temperature sensitivity should be developed.

The present invention provides an accurate yet efficient thermal-via allocation method that considers the temporal and spatial variations of the thermal-power. The transient temperature is calculated using a macromodel with a structured and parameterized model reduction, which also generates the temperature sensitivity with respect to the thermal-via density. By defining a thermal-violation integral based on the transient temperature, a nonlinear optimization problem is formulated to allocate thermal-vias and minimize thermal violation integral. This optimization problem is transformed into a sequence of subproblems using Lagrangian relaxation, and each subproblem is solved by quadratic programming with the sensitivities provided by the macromodel. Test results compared to the steady-state thermal analysis, indicate that this new method is over two orders of magnitude faster in obtaining the temperature profile, and cuts the number of thermal vias approximately in half under the same temperature bound.

15. Duality Between Electrical and Thermal System Models

15.1 Thermal Model

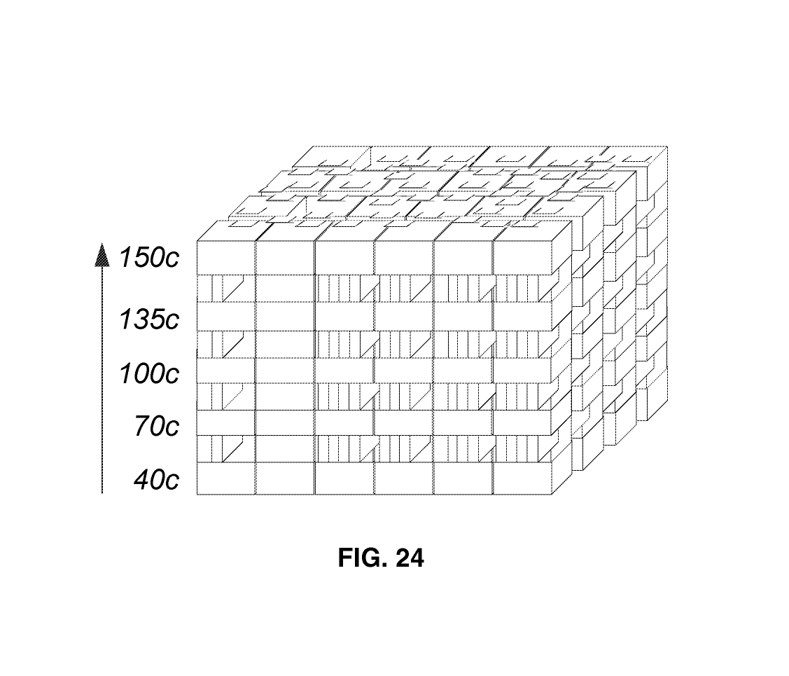

FIG. 24 illustrates an example of heat buildup in response to the poor thermal conductivity of the inter-layer dielectrics within an integrated circuit.

A well-recognized duality between exists between electrical and thermal systems (See Table 4). As temperature is analogous to voltage, the heat flow can be modeled by a current passing though a pair of thermal resistance and capacitance driven by the current source, modeling the power dissipation.

Thus 3D layout can be uniformly discretized into N tiles by the finite difference method, with the design variable being sought as the thermal-via density. The larger the thermal-via density in one tile, the more heat that can be convected away through layers to the heat sink. In this section, K critical tiles are assumed to be specified by users. An i th tile has a thermal-via area Aᵢ. Because Aᵢ is related to the thermal-via density ρᵢ by ρᵢ=Aᵢ/a, Aᵢ is utilized to represent the thermal-via density at the i th tile in the sequel, wherein a represents the unit area of the thermal-via determined by the process.

The equivalent thermal circuit by nodal analysis (NA) in the frequency(s) domain is

$$[ {G}_{0} + {sC}_{0} + {\sum }_{i = 1}^{K} {A}_{i} ( {g}_{i} + {sc}_{i} ) ] x ( A , s ) = Bu ( s ) \\ y ( A , s ) = {L}^{T} x ( A , s ) \qquad ( 48 )$$

where A=[A₁, . . . , A_{K}] is a parameter-vector of thermal-via density. It should be noted that G₀ and C₀ (εR^{N×N}) are conductive and capacitive matrices of discretized thermal networks,

$${\sum }_{i = 1}^{K} {A}_{i} {g}_{i}$$

and

$${\sum }_{i = 1}^{K} {A}_{i} {c}_{i}$$

are conductive and capacitive matrices of thermal vias, respectively. In addition, x(A,s) (εR^{N}) is the state variable of node temperatures, B(εR^{N×p}) is the adjacent matrix to select input u, and L(εR^{N×p}) is the adjacent matrix to select output y. The notations are summarized in Table 5.

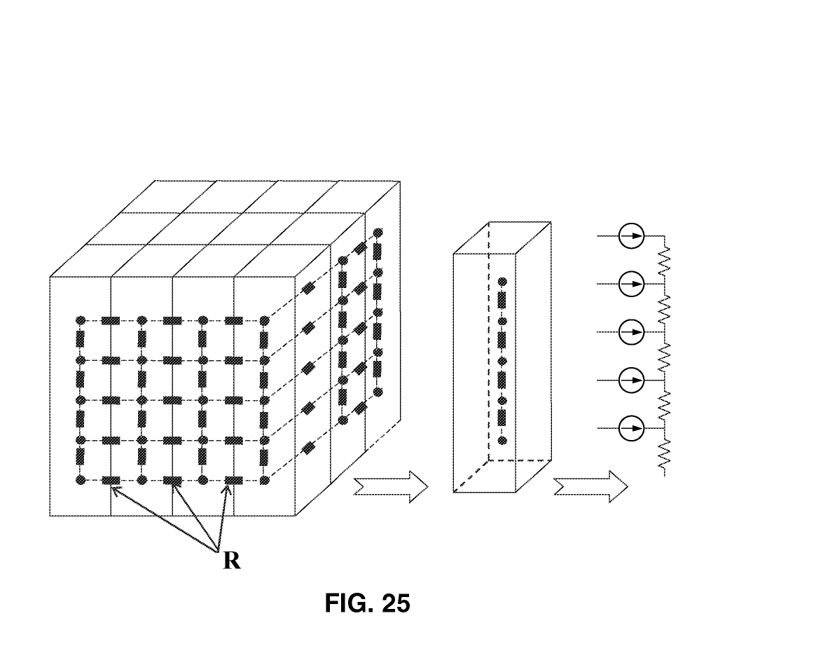

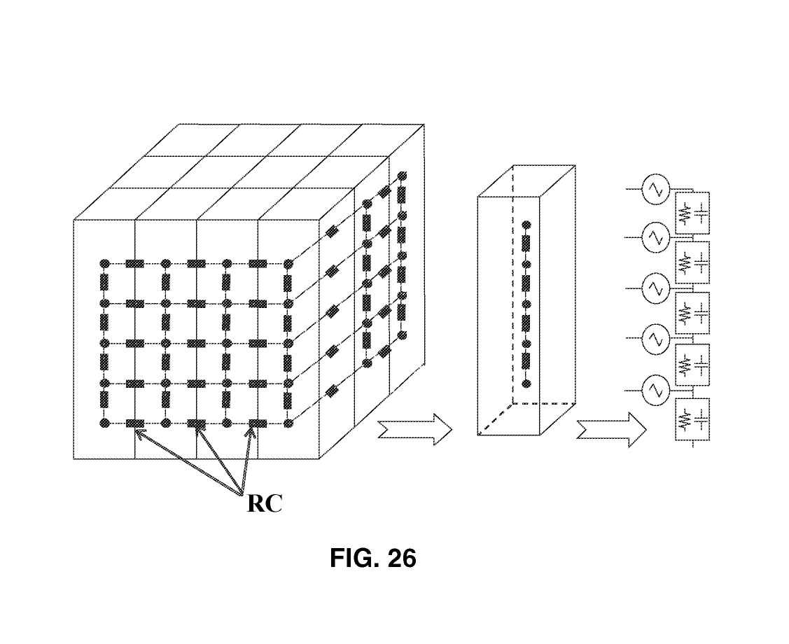

FIG. 25 illustrates discretizing active devices and inter-dielectric layers into interconnected tiles. The tiles are shown coupled by thermal resistance in this model. FIG. 26 illustrates a transient model with tiles connected with a thermal resistance and capacitance and heat sources modeled as time-variant current sources.

The thermal-via is inserted as follows. An insertion (incident) matrix X (εR^{N×N}) is used to record the location and the number of added vias. If a via is added between two nodes m and n at two between two vertical-adjacent layers, its insertion matrix is

$$X ( k , l ) = X ( l , k ) = \{ \begin{matrix}- 1 & if k = m , l = n \\ {\sum }_{l} \vert X ( k , l ) \vert & if k = l \\ 0 & else\end{matrix} \qquad ( 49 )$$

Accordingly, the result is gᵢ=(k₁/t)Xᵢ and cᵢ=(k₂t)Xᵢ, where k₁ and k₂ are thermal conductive/capacitive constants of the thermal-via and w and t are the width and thickness of the thermal-via.

Moreover, it should be understood note that u (εR^{p×1}) is the current source to model the thermal-power input. It should be appreciated that there are several types of thermal-power as defined. Thermal power is defined by the running average of the cycle-accurate (often in the range of ns) power, over several thermal time constants (often in the range of ms). When the set of architectural model/constraints and the particular instruction sets and working loads driving the chip are available, a transient thermal-power signature can be further defined as the thermal power with a worst-case trace input. In addition, a constant maximum thermal-power signature is defined as the maximum of the transient thermal-power signature.

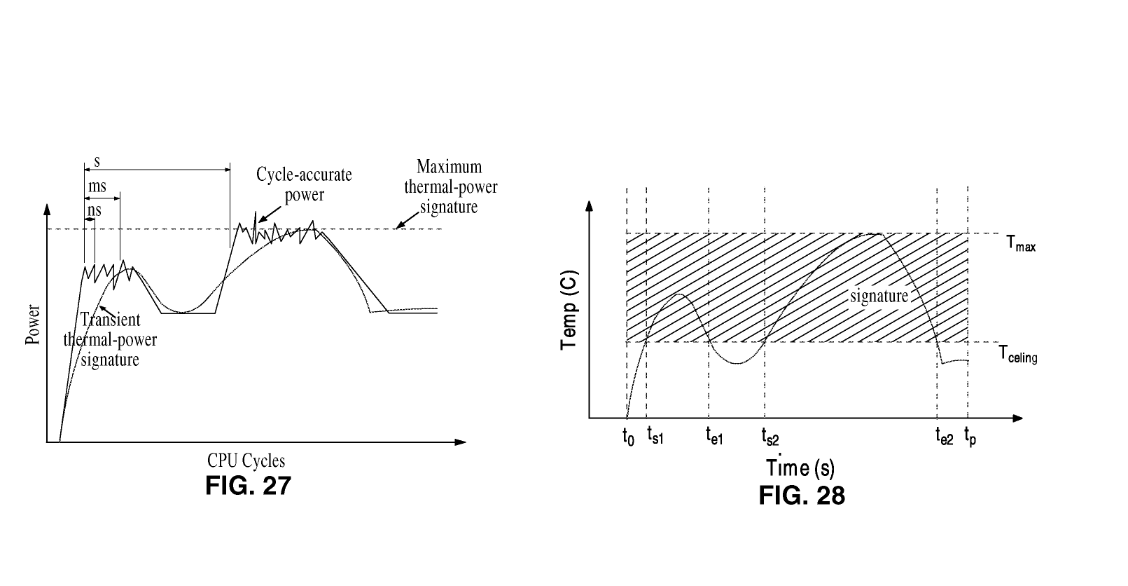

FIG. 27 is a graph depicting the different power representations of cycle-accurate power, transient thermal-power signature, and maximum thermal-power signature at the different scale of time constant.

15.2 Thermal Analysis

The direct solution is not efficient to solve Eq. (48) for large sized circuits. Similar to the macromodeling for the electrical RC network, moment matching based model order reduction can be used to obtain a compact thermal RC model, which not only has a reduced matrix size but also preserves the dominant system response. The existing macromodeling approach from electrical analysis is mainly based on the subspace projection by expanding the system equation, Eq. (48) at some frequency points. After projection, an order-reduced state equation can be obtained with preserved low-order moments to represent the dominant response of the original system.

To further obtain sensitivity information, the parameterized moments can be obtained by expanding Eq. (48) at selected parameter points.

However, this is impractical, because the parameterized moments have coupled frequency and parameter variables whose dimensions grow exponentially. This is improved in by separately expanding moments of parameters from the frequency, and results in an augmented state matrix containing the nominal state and the expanded states, i.e., sensitivities with respect to parameters. Nevertheless, all these approaches apply a projection during the reduction. The reduced state matrices and state variables have coupled nominal values and sensitivities. It is unknown how to separate parameterized sensitivities from the reduced macromodel and apply those sensitivities in the optimization.

16. Structured And Parameterized Macromodel

In this Section it is shown that the separated nominal temperature and its sensitivities can be obtained by a structured and parameterized reduction.

This technique is then applied to obtain a structured and parameterized macromodel for the thermal RC network. Here the parameter to be expanded is the thermal-via density Aᵢ.

As a consequence of the output sensitivity being large with respect to the frequency, but small with respect to the geometric parameter, the temperature state variable x(A₁, . . . , A_{K}, s) can be approximated by the Taylor expansion:

$$x ( S , s ) = {\sum }_{{i}_{1}}^{∞} … {\sum }_{{i}_{K}}^{∞} {x}_{1 , … , K}^{( {i}_{1} + … + {i}_{K} )} ( s ) {( δ {A}_{1} )}^{{i}_{1}} … {( δ {A}_{K} )}^{{i}_{K}} . \qquad ( 50 )$$

This is similar to the method of modeling variations for the electrical system. Substituting Eq. (50) for Eq. (48), and explicitly matching the moment for each Aᵢ up to the second-order, Eq. (48) can be reformulated into an augmented parameterized state equation:

$$\begin{matrix}( {G}_{ap} + {sC}_{ap} ) {x}_{ap} = {B}_{ap} u ( t ) , {y}_{ap} = {L}_{ap}^{T} {x}_{ap} \\ with & ( 51 ) \\ {G}_{ap} = [ \begin{matrix}{G}_{0} & 0 & … & 0 & 0 & 0 & … & 0 \\ {A}_{1} {g}_{1} & {G}_{0} & … & 0 & 0 & 0 & … & 0 \\ ⋮ & ⋮ & ⋰ & ⋮ & ⋮ & ⋮ & ⋰ & ⋮ \\ {A}_{K} {g}_{K} & 0 & … & {G}_{0} & 0 & 0 & … & 0 \\ 0 & {A}_{1} {g}_{1} & 0 & … & {G}_{0} & 0 & … & 0 \\ 0 & {A}_{2} {g}_{2} & {A}_{1} {g}_{1} & 0 & … & {G}_{0} & … & 0 \\ ⋮ & ⋮ & ⋮ & ⋮ & ⋰ & ⋮ & ⋰ & ⋮ \\ 0 & 0 & … & {A}_{k} {g}_{k} & … & 0 & … & 0\end{matrix} ] , \\ and \\ {x}_{ap} = {[ {x}_{0}^{( 0 )} , {x}_{1}^{( 1 )} , … , {x}_{K}^{( 1 )} , {x}_{1 , 1}^{( 2 )} , … , {x}_{K , K}^{( 2 )} ]}^{T} \\ {B}_{ap} = {[ B , 0 , … , 0 , 0 , … , 0 ]}^{T} \\ {L}_{ap} = {[ L , δ {A}_{1} L , … , δ {A}_{K} L , δ {A}_{1} δ {A}_{1} L , … , δ {A}_{K} δ {A}_{1} L ]}^{T} . & ( 52 )\end{matrix}$$

It should be seen that Cₐₚ has the same lower-triangular structure as Gₐₚ does. In addition, the system state variable yₐₚ at output for those critical tiles can be also divided into three parts: nominal value y⁽⁰⁾=y₀⁽⁰⁾(εR¹), first-order sensitivity y⁽¹⁾={y₁⁽¹⁾, . . . , y_{K}⁽¹⁾} (εR^{K}), and second-order sensitivity y⁽²⁾={y_{1,1}⁽²⁾, . . . , y_{K,K}⁽²⁾} (εR^{K×K}). As result, solving Eq. (51) results in the nominal value of temperature y⁽⁰⁾, and its according first-order sensitivity y⁽¹⁾ and second-order sensitivity y⁽²⁾ with respect to each parameter Aᵢ.

Because the dimension of the system equation, Eq. (51) is large, its order needs to be reduced using projection with preserved moments (of s) up to q-th order. A flat projection matrix V can be constructed recursively using the Arnoldi method. However, directly projecting Eq. (51) by V leads to a reduced macromodel and loses the lower-triangular block structure of Gₐₚ and Cₐₚ, as a result of which, y⁽⁰⁾, y⁽¹⁾ and y⁽²⁾ are coupled with each other.

Instead of using the flat projection matrix V, a structured projection matrix is introduced

$${V}^{′} = diag [ {V}_{0} , \underbrace{{V}_{1} , … , {V}_{K}}_{K} , \underbrace{{V}_{K - 1} , … , {V}_{{K}^{2}}}_{{K}^{2}} ] , \qquad ( 53 )$$

by partitioning V according to the dimension of x⁽⁰⁾, x⁽¹⁾ and x⁽²⁾. As a result, the order-reduced state matrices
\tilde{G}ₐₚ=V′^{T}GₐₚV′, \tilde{C}ₐₚ=V′^{T}CₐₚV′, B′ₐₚ=V′^{T}BₐₚV′, \tilde{L}ₐₚ=V′^{T}LₐₚV′.

Because V⊂V′, a q-th ordered projection by V′ still preserves at least q moments.

The time-domain transient response of the reduced model can be solved by Backward-Euler method, wherein the reduced system equation at time instant t with time step h is

$$\begin{matrix}{\tilde{G}}_{ap} = \frac{1}{h} {\tilde{C}}_{ap} {\tilde{x}}_{ap} ( t ) = \frac{1}{h} {\tilde{C}}_{ap} {\tilde{x}}_{ap} ( t - h ) + {\tilde{B}}_{ap} u ( t ) \\ {\tilde{y}}_{ap} ( t ) = {\tilde{L}}_{ap}^{T} {\tilde{x}}_{ap} ( t ) \\ where & ( 54 ) \\ {\tilde{G}}_{ap} = [ \begin{matrix}{\tilde{G}}_{0} & 0 & … & 0 & 0 & 0 & … & 0 \\ {A}_{1} {\tilde{g}}_{1} & {\tilde{G}}_{0} & … & 0 & 0 & 0 & … & 0 \\ ⋮ & ⋮ & ⋰ & ⋮ & ⋮ & ⋮ & ⋰ & ⋮ \\ {A}_{K} {g}_{K} & 0 & ⋯ & {\tilde{G}}_{0} & 0 & 0 & ⋯ & 0 \\ 0 & {A}_{1} {\tilde{g}}_{1} & 0 & ⋯ & {\tilde{G}}_{0} & 0 & ⋯ & 0 \\ 0 & {A}_{2} {g}_{2} & {A}_{1} {\tilde{g}}_{1} & 0 & ⋯ & {\tilde{G}}_{0} & ⋯ & 0 \\ ⋮ & ⋮ & ⋮ & ⋮ & ⋰ & ⋮ & ⋰ & ⋮ \\ 0 & 0 & … & {A}_{k} {\tilde{g}}_{K} & … & 0 & … & {\tilde{G}}_{0}\end{matrix} ] \\ and \\ \begin{matrix}{\tilde{y}}_{ap} = {[ {\tilde{y}}^{( 0 )} , {\tilde{y}}^{( 1 )} , {\tilde{y}}^{( 2 )} ]}^{T} \\ = {[ {\tilde{y}}_{0}^{( 0 )} , {\tilde{y}}_{1}^{( 1 )} , … , {\tilde{y}}_{K}^{( 1 )} , {\tilde{y}}_{1 , 1}^{( 2 )} , … , {\tilde{y}}_{K , K}^{( 2 )} ]}^{T}\end{matrix} & ( 55 )\end{matrix}$$

It can be seen that the reduced \tilde{C}ₐₚ has the same structure as \tilde{G}ₐₚ.

Because the reduction preserves the block structure, the reduced nominal value \tilde{y}⁽⁰⁾, first-order sensitivity \tilde{y}⁽¹⁾ and second order sensitivity \tilde{y}⁽²⁾ at output (critical tiles) can be solved independently. The temperature profile at those critical tiles perturbed by the parameter is
\tilde{y}(A,t)=\tilde{y}⁽⁰⁾(A,t)+\tilde{y}⁽¹⁾(A,t)+\tilde{y}⁽²⁾(A,t). (56)

A thermal-via planning based on the accurate yet efficient transient simulation with \tilde{y}(A,t) can be consequently designed. It should be appreciated that as the reduced system still has a lower-triangular structure, it can be efficiently solved using block back substitution, where there is only one factorization cost from the diagonal block, i.e., the reduced block of nominal state matrix.

17. Thermal-Via Allocation

In this section, an accurate figure of merit, thermal-violation integral is first defined to consider the transient temperature profile. A thermal-via allocation can consequently be formulated as a nonlinear optimization problem, which is relaxed and solved by a sequence of quadratic programming with use of sensitivities provided from the structured and parameterized macromodel.

17.1 Thermal-Violation Integral

A thermal-Violation Integral is defined by the integral of the transient temperature above a user-specified ceiling temperature T_{ceiling}

$$\begin{matrix}{f}_{i} ( A ) = {\int }_{{t}_{0}}^{{t}_{p}} max [ \tilde{y} ( A , s ) , {T}_{ceiling} ] ⅆ t \\ = {\int }_{{t}_{s}}^{{t}_{e}} [ \tilde{y} ( A , t ) - {T}_{ceiling} ] ⅆ t .\end{matrix} \qquad ( 57 )$$

where A=[A₁, . . . , A_{K}] is a parameter vector of thermal-via density, t₀ and tₚ defined time-period, and the interval [tₛ,tₑ] is determined by comparing
max[\tilde{y}(A,t), T_{ceiling}],
which can contain multiple intervals.

FIG. 28 is a graph illustrates a figure of merit using thermal-violation integral with defined ceiling temperature under an input of transient thermal-power signature. As shown in the figure, the integral is actually the area above the T_{ceiling}. This definition captures the fact that a thermal-violation occurs only when the temperature is above the temperature bound for a sufficient period of time. A similar merit figure is utilized in estimating noise. Moreover, the figure of merit for a group of critical tiles in the entire circuit is

$$f ( A ) = f ( A ) = {\sum }_{i = 1}^{K} {f}_{i} ( A ) \qquad ( 58 )$$

The above is referred to as total thermal-violation integral. The total thermal-violation integral is used as an accurate objective function in the sequel to be minimized by allocating thermal vias.

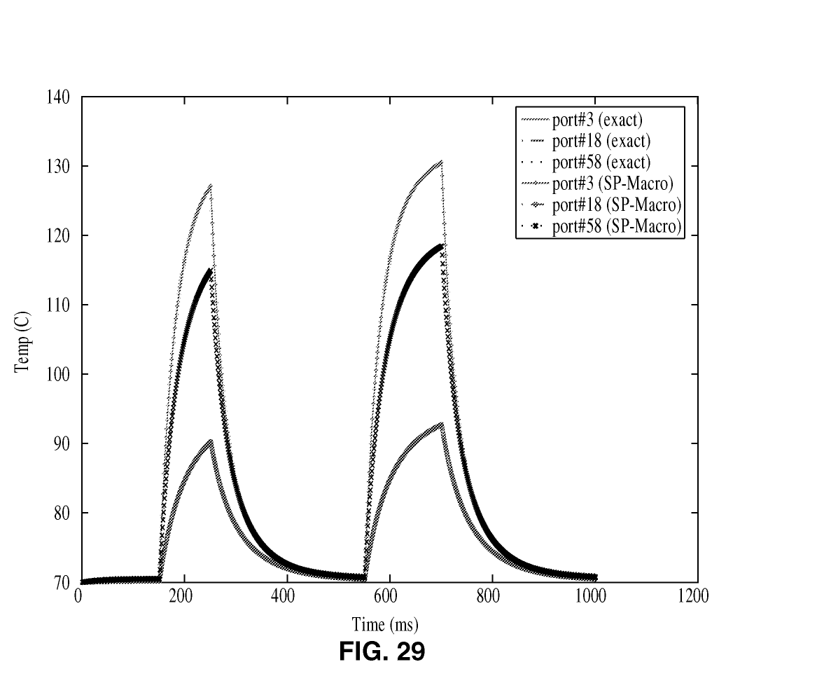

It should be noted that for steady-state analysis, the input of the maximum thermal-power signature results in a constant maximum temperature Tₘₐₓ. Hence the hotspot reduction by the steady-state solution is equivalent to reduce a rectangular area defined between Tₘₐₓ and T_{ceiling}, obviously an over-estimated violation integral (See FIG. 29). It becomes even worse for the total violation integral. The reason for this is that each critical tile has a different transient thermal-power signature, and hence their maximum usually does not happen at the same time. As a result, the thermal-violation integral from a transient solution is more accurate to guide the thermal-via allocation than from a steady-state one.

17.2 Problem Formulation

To minimize the total violation integral, thermal vias are allocated at each pair of adjacent layers. With consideration of the congestion from vertical signal vias, Aₘₐₓ and (Aᵢ)ₘₐₓ are the total available space and local-tile available space for inserting thermal vias, which are assumed to be provided by the user. Accordingly, an optimization problem is formulated as

Problem 1:

$$\begin{matrix}min f ( A ) \\ s . t . {\sum }_{i = 1}^{K} {A}_{i} \leq {A}_{max} , & ( 59 ) \\ 0 \leq {A}_{i} \leq {( {A}_{i} )}_{max} , ( i = 1 , … , K ) . & ( 60 )\end{matrix}$$

where the constraint of Eq. (59) is a global constraint implying that the total thermal-via density is limited by Aₘₐₓ, and the constraint of Eq. (60) is a local constraint implying that the local thermal-via density at i-th tile is limited by (Aᵢ)ₘₐₓ. Moreover, to compute f(A), t is discretized into finite intervals and Problem 1 becomes semi-definite, which can be further solved using Lagrangian relaxation.

Using matrix U(εR^{(K-1)×(K)})

$$U = [ \begin{matrix}1 & 0 & … & 0 \\ 0 & 1 & … & 0 \\ ⋮ & ⋮ & ⋰ & ⋮ \\ 0 & … & … & 1 \\ 1 & 1 & … & 1\end{matrix} ] , \qquad ( 61 )$$

the constraints of Eqs. (59) and (60) become Eq. (62)
UA≦Aₘₐₓ, (62)
where Aₘₐₓ=[(A₁)ₘₐₓ,(A₂)ₘₐₓ, . . . ,(A_{K})ₘₐₓ,Aₘₐₓ]^{T}. To efficiently solve Problem 1, the below Lagrangian relaxation is used to transform the original problem into a sequence of subproblems.

The constraint function can be added to the objective function using a vector of Lagrangian multiplier λ=[λ₁, . . . ,λ_{K}]. As a result, the primary problem of Problem 1, has the following dual problem:
L(A,λ)=f(A)+λ·h(A) (63)
where
h(A)=UA−Aₘₐₓ (64)

This relaxed problem can be transformed into sequential subproblems by subgradient optimization. At each iteration, each subproblem is constructed from a quadratic approximation of the nonlinear objective function, and a linearization of the constraints about the solutions from the previous iteration. The optimization terminates when the convergence criterion is achieved, which is referred to as sequential quadratic programming (SQP).

Expanding f(A) and h(A) with respect to A up to the second order, an approximated equivalent subproblem is

$$min ∇ {f ( A )}^{T} δ A + \frac{1}{2} δ {A}^{T} H δ A \qquad ( 65 )$$

s.t. ∇h(A)·δA≦h(A) (66)

Eq. (66) can be solved by the standard quadratic programming, where

$$∇ f = {\int }_{0}^{{t}_{p}} {\tilde{y}}^{( - 1 )} ⅆ t , ∇ h = const .$$

are first-order sensitivities, and

$$H = [ \begin{matrix}{\int }_{0}^{{t}_{p}} {\tilde{y}}_{1 , 1}^{( - 2 )} ⅆ t & … & {\int }_{0}^{{t}_{p}} {\tilde{y}}_{1 , K}^{( - 2 )} ⅆ t \\ ⋮ & ⋰ & ⋮ \\ {\int }_{0}^{{t}_{p}} {\tilde{y}}_{K , 1}^{( - 2 )} ⅆ t & … & {\int }_{0}^{{t}_{p}} {\tilde{y}}_{K , K}^{( - 2 )} ⅆ t\end{matrix} ] , ∇ h = const .$$

is the Hessian matrix composed by the second-order sensitivities. Both the first and second order sensitivities can be efficiently and independently solved by Eq. (54).

The sequential subgradient optimization procedure is outlined in Algorithm 2, below.

Algorithm 2
Subgradient Optimization using Structured Parameterized Macromodel

Initialize: (A₀,α₀, λ₀,H₀, k);
Solve: \tilde{y}₀ using Eq. (54);
Solve: δA₀ = quadprog(λ₀,\tilde{y}₀);
$Set : {s}_{0} = \frac{{UA}_{k} - {A}_{max}}{‖ {UA}_{k} - {A}_{max} ‖} ;$
Set: λ₁ = λ₀ α₀ · s₀;
While |L(λₖ₊₁) − L(λₖ)| > TOL do
${s}_{k} = \frac{{UA}_{k} - {A}_{max}}{‖ {UA}_{k} - {A}_{max} ‖} ;$
λₖ₊₁ = λₖ + αₖ · sₖ;
δAₖ = quadprog(λₖ,\tilde{y}ₖ);
Aₖ₊₁ = Aₖ + δAₖ;
Update: (Gₐₚ)ₖ₊₁ and (Cₐₚ)ₖ₊₁ with Aₖ₊₁;
Solve: \tilde{y}ₖ₊₁ using Eq. (54);
k = k + 1;
end while

In the above algorithm αₖ is the step size usually determined through a geometric regression. It should be noted that because the projection of Eq. (53) preserves the block structure, the reduced state matrices can be repeatedly used when updating the new parameter vector A. Therefore, there is only one reduction needed. In addition, since the reduced model is much smaller than the original one, and the factorization cost only comes from the nominal blocks in diagonal, its nominal value and sensitivities can be efficiently solved by the back-substitution of Eq. (54). Therefore, the optimization procedure in Algorithm 2 can be considered computationally efficient.

18. Results for Thermal Via Allocation Method

The structured and parameterized macromodeling (SP-Macro) and thermal-via allocation of the present invention have been shown by way of example being implemented in MATLAB and run on Linux workstation (e.g., Intel Pentium IV 2.66 GHz CPU and 2 GB RAM). The examples have been performed with the following settings: k₁ (thermal conductive constant) is 100 W/m·K for silicon and 400 W/m·K for copper, and k₂ (thermal capacitive constant) is 1.75×10⁶ J/m³·K for silicon and 3.55×10⁶ J/m³·K for copper. The substrate is 500 μm thick, the device layer is 6 μm thick and interlayer thickness is 1 μm thick. The examples illustrate the use of four silicon layers used with the thermal-vias assumed to be copper, although any number of layers and via construction can be utilized. The unit via area is2×2 μm². The overall chip size is 2×2 cm², and the number of individual modules and its according size are from MCNC benchmarks. A random power distribution at each node is used. 90% of tiles have power densities from 0 to 2×10⁶ W/m², and their clock gating pattern has a period of 500 ms, where the power in the standby mode is 5% of the running mode. The other 10% of tiles having power densities from 3×10⁶ W/m² to 9×10⁶ W/m², and their clock gating pattern has a period of 250 ms where the power in the standby mode is 20% of the running mode.

A detailed 3D thermal RC circuit having four layers, with each layer containing about 10K tiles, was utilized to verify the process. Within each layer 64 tiles were selected as critical tiles. The total thermal-via density constraint was set to 3000, and the local via number constraint is randomly generated from 10 to 100. Structured and parameterized model reduction is first applied to generate SP-Macro for the thermal-via allocation considering the transient effect. Then the entire circuit is used to generate the steady-state map of the temperature profile.

FIG. 29 is a graph illustrating transient temperature responses of exact and structured and parameterized macro (SP-Macro) models at ports 3, 18, and 58 of layer-1 with step-response input. For the SP-macro and original models, the graph of FIG. 29 compares the time domain transient temperature at selected three critical tiles (3, 18, 58) using Eq. (56). For the moment matching 16 moments were utilized. The reduced models are visually identical to original ones.

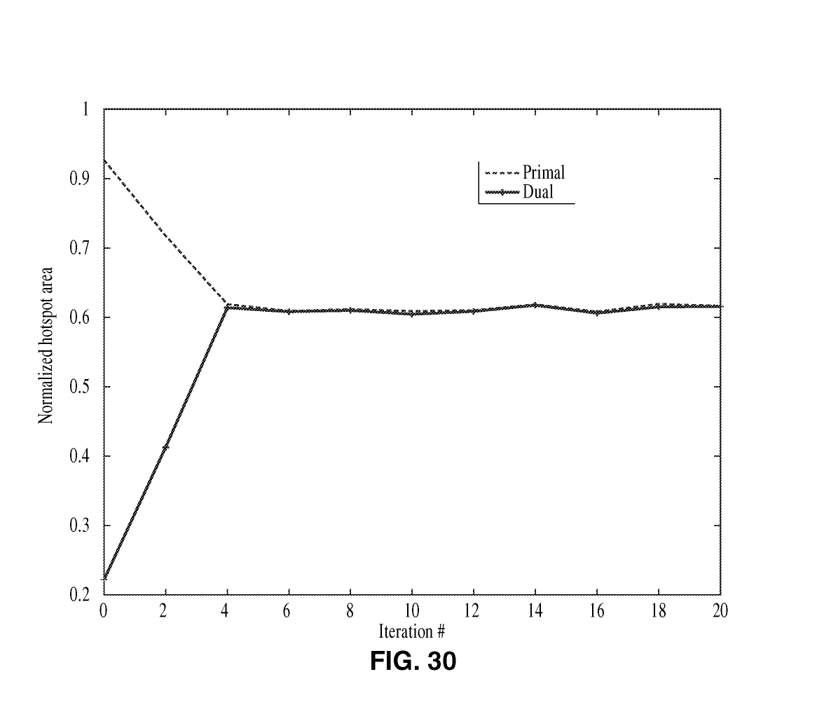

FIG. 30 is a graph depicting convergence of subgradient optimization of primal and dual problems, with the hotspot is represented by violation integral normalized to the maximum (α₀ here is set to 0.7). The figure shows the subgradient optimization procedure after a few iterations, where the dual problem converges with the primal problem.

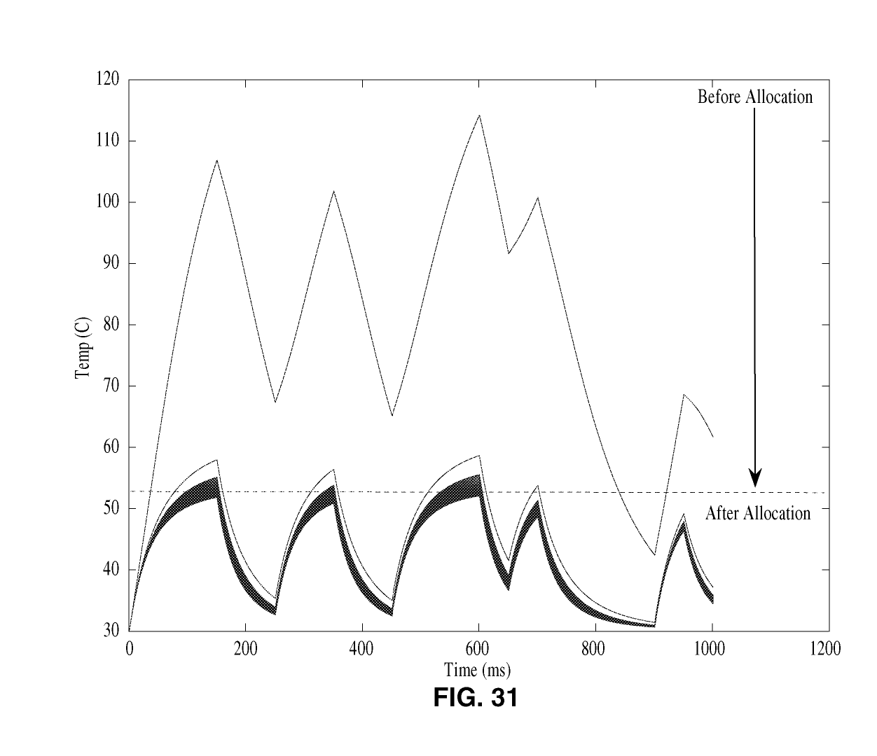

FIG. 31 depicts iterative optimizations as transient temperature at one port is cooled down to the ceiling point. The graphs shows hotspot reduction by thermal-via allocation under the input of transient thermal-power signature at port 32 of layer-1, with a ceiling temperature of 52° C.

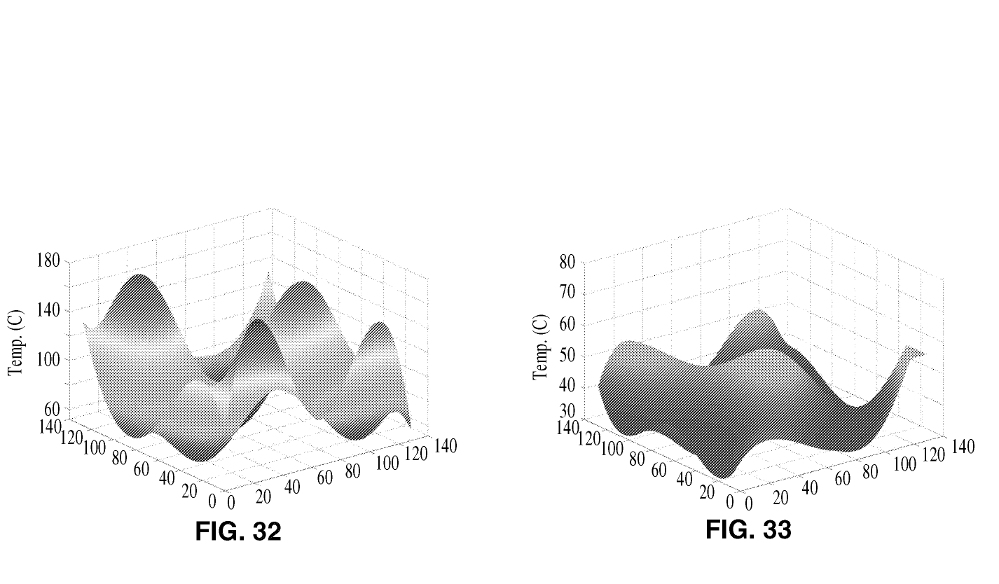

FIG. 32-FIG. 33 are 3D graphs depicting steady-state temperature maps of top layer (layer-1) before and after thermal-via allocation using transient temperature profile.

The initial chip temperature at the top layer is around 150° C., and its temperature profile at steady-state is shown in FIG. 32; in contrast, the allocation results in a cooled temperature profile that closely approaches the ceiling temperature as shown in FIG. 33.

Clearly, as can be seen from the above figures, the gradient approach speedily minimizes the thermal-violation integral, with FIG. 32 and FIG. 33 further illustrating show the steady-state temperature map across the top layer (layer-1).

Table 6 further analyzes the runtime scalability and allocated thermal-via density by the proposed method and the direct steady-state analysis. Since directly solving steady-state equation needs to handle large sized matrix, it has a long runtime and uses a lot of memory. In contrast, the macromodel can efficiently match the transient response using around 20 moments. For a circuit with 8192 tiles, our model reduces runtime by 126× (62 seconds versus 7809 seconds) compared to the steady-state analysis. More importantly, the allocated thermal-via density according to the present invention is much smaller than that produced by steady-state analysis, under the same targeted ceiling temperature. It will be appreciated that directly solving steady-state equations can not generate sensitivity for the optimization, wherein the allocated thermal-via of steady-state analysis is based on the reduced macromodel, where the thermal-violation integral is defined by the maximum temperature (See FIG. 28). For a circuit with 32768 tiles, the method of the present invention reduces the number of thermal vias by a factor 2.04× (11660 thermal vias versus 23800 thermal vias) compared to the steady-state analysis.

19. Conclusions on Thermal Via Allocation

An accurate yet efficient thermal-via allocation is proposed for the thermal-aware design of three-dimensional (3D) ICs. The previous thermal-via allocations utilize direct steady-state analysis and ignore the temporal and spatial variations of the thermal-power, and are thus inefficient in generating the nominal temperatures and its sensitives for large sized circuits. More importantly, the use of these methods result in a design having an excessive number of thermal vias, such as about twice as many.

The present invention, therefore, considers the temporally and spatially variant thermal-power input, a structured and parameterized model order reduction used to obtain a macromodel, which can efficiently provide the transient nominal temperature and its sensitives to thermal-via densities. A thermal-violation integral of the transient temperature is then defined to accurately capture the thermal violation, and a nonlinear optimization is formulated to minimize the thermal-violation integral. In addition, using parameterized sensitivities provided from the macromodel, the relaxed subproblems of the formulated problem are efficiently solved by a sequence of quadratic programming, where the reduced macromodel can be repeatedly used during the gradient search. Clearly, the proposed structured and parameterized macromodel and thermal-violation can be used for a number of integrity-driven physical synthesis problems.

(D) Simultaneous Power and Thermal Integrity Driven Via Stapling in 3D ICs

20. Introduction to V/T Stapling in 3D ICs

Three dimensional (3D) integration often lack power and thermal integrity in response to inefficient via stapling. This aspect of the present invention addresses those shortcomings with simultaneous power/thermal stapling methods.

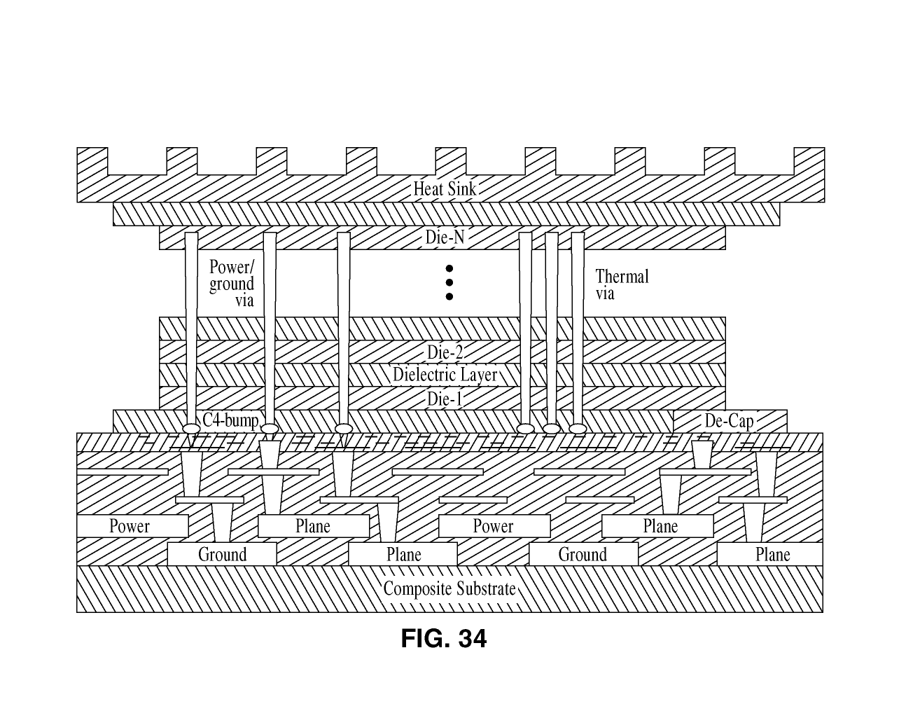

FIG. 34 illustrates typical 3D stacking of multiple active layers inside a single integrated circuit package. Power is supplied from the bottom, to the power and ground planes in the package. It is seen from the figure that C4 bumps connect the power and ground planes to the active device layers and through-vias referred to as power/ground vias are used to carry power between active layers. Due to the strong electromagnetic coupling between the package and the power delivery system (PDS), it is very important to optimize power integrity in performing three-dimensional designing of integrated circuits.

As shown by PDS designs in 2D ICs, stapling power/ground vias reduces the loop inductance of power/ground planes, and hence reduces the SSN (simultaneously switching noise) in a package. However, there is no in-depth study on design automation of PDS in 3D ICs. Moreover, because of the increased power density, heat dissipation is extremely important in 3D ICs. It is well known that excessively high temperature can significantly degrade interconnect/device reliability and performance. Since vias are good thermal conductors as well, adding through-vias as thermal vias between device layers has been found effective in removing heat. A heat-sink is typically required when chip power dissipation exceeds 25 Watts. When utilized, heat sinks are usually placed on the top of device layers to serve as the primary heat-removal path. As shown in FIG. 34, thermal vias can be inserted to more effectively remove heat from bottom (lower) device layers to the heat sink. It should be noted that the terms bottom, lower, or conversely top, or upper, are used in relation to one another; wherein although it would depart from convention one could invert the described device structures without altering the invention.

In the following discussion the power/ground and thermal vias are referred to as non-signal vias, the number of which may be very large. For example, it is common in the literature to have on the order of 100 thermal vias. Because large numbers of non-signal vias introduce congestion for signal vias, planning non-signal vias in 3D ICs has become increasing important. The use of existing via-stapling implicitly optimizes power and thermal integrity separately, where power/ground vias are inserted to satisfy power integrity constraints, and thermal vias are inserted to satisfy thermal integrity constraints. These vias are stapled according to the distribution of maximum temperature and voltage violations. Since maximum voltage violations are often located apart from maximum temperature violations, the resulting vias can have quite different patterns.

FIGS. 35A-35B illustrate example spatial distributions of normalized temperature and voltage violations for a typical 3D design before stapling vias. FIG. 35A depicts a temperature violation distribution map, while FIG. 35B depicts a supply voltage violation distribution map. Both images are for circuits before performing via stapling. The circular region in the midst of FIG. 35B (actually a dark red amidst a blue and dark blue background) indicates the maximum temperature or voltage value.

Since the combined power/ground planes work as a cavity resonator, it is known that large voltage violation can be found often in the center of the planes. On the other hand, the thermal hotspots are those regions close to the heating sources on the device layer and they may spread more uniformly for a thermal aware 3D placement and routing. This disparity leads to two different via-stapling patterns: (1) the vias tend to be stapled in the center for the power integrity, (2) but stapled uniformly across the plane for thermal integrity. As stapling vias in such a sequential fashion ignores the fact that non-signal vias could be used to minimize both the temperature and voltage violation, it may result in an over-design, and thus inefficient design. Furthermore, to obtain a valid solution, the existing thermal-via planning assumes a steady-state thermal analysis with the maximum thermal-power as inputs. Since it is rare, if not impossible, for different regions to simultaneously reach their maximum thermal-power, the assumption of steady-state analysis may also lead to excessive numbers of vias. Therefore, in view of this assumption a stapling method is put forth utilizing transient analysis to find the minimum number of non-signal vias, such that both power integrity in P/G planes and thermal integrity at device layers can be satisfied.

Accordingly, methods are formulated herein to solve the 3D via-stapling problem toward simultaneously minimizing non-signal vias subject to power and thermal integrity. Transient models are applied for temperature and supply voltage noise. As shown by test results for sequential power and thermal optimization, using transient analysis reduces stapled non-signal vias by an average of 11.5% compared to using steady-state analysis. Moreover, the use of simultaneous optimization of power and thermal integrity by transient analysis as taught herein reduces non-signal vias, on average about 34%, compared to the sequential optimization by steady-state analysis.

21. Modeling And Problem Formulation

21.1 Distributed Circuit Model

The 3D design is modeled by two parts: (1) distributed thermal RC circuit for thermal integrity, and (2) electrical-RLC circuit for power integrity. There is a well-known duality between electrical and thermal systems (refer back to Table 4). As temperature is analogous to voltage, the heat flow can be modeled by a current passing through a pair of thermal resistance and capacitance driven by the current source, which in turn models the power dissipation.

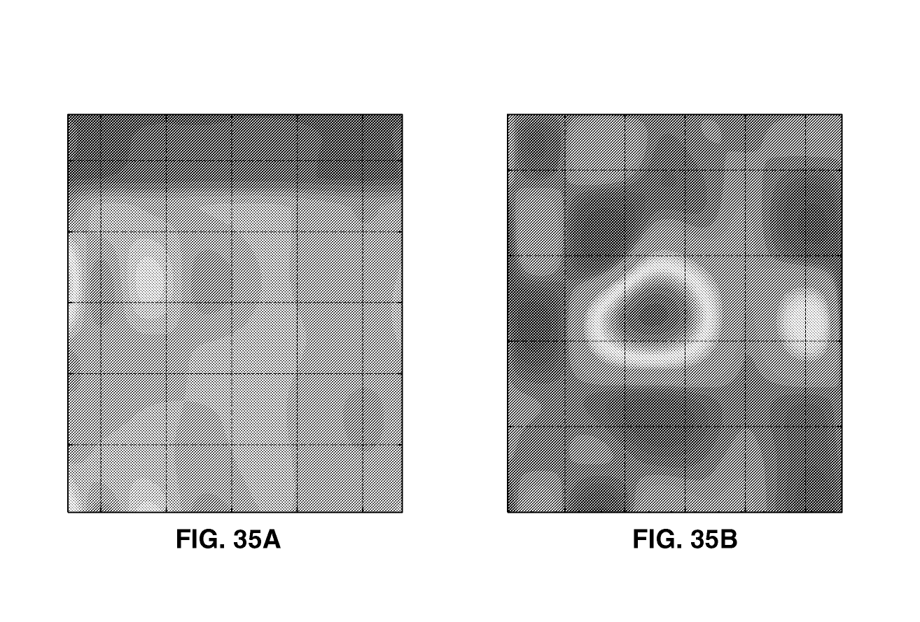

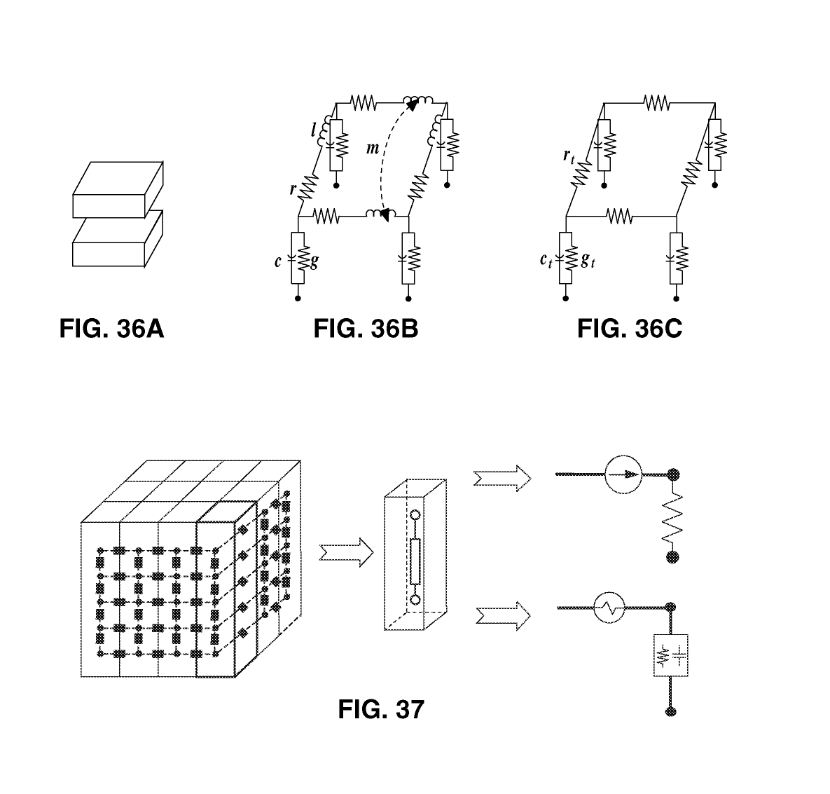

FIGS. 36A-36C illustrates tile models, showing in FIG. 36A a unit tile, in FIG. 36B an equivalent RLC cell, and in FIG. 36C an equivalent RC-cell. It will be recognized that the 3D layout of each silicon device layer and power/ground plane can be uniformly discretized by the finite difference method. As shown in FIGS. 36A-36C, each discretized tile can be represented by an RC-cell and an RLC-cell to construct distributed thermal-RC and electrical-RLC circuits, respectively. The via or C4 bump is modeled by a lumped RC pair for both thermal and electrical circuits. Moreover, partial inductance is utilized to consider the magnetic coupling in the electrical-RLC circuit.

FIG. 37 illustrates a comparison between a conventional steady state thermal model in comparison with a transient thermal model. In the transient model it will be appreciated that the tiles are connected with thermal resistance and capacitance.

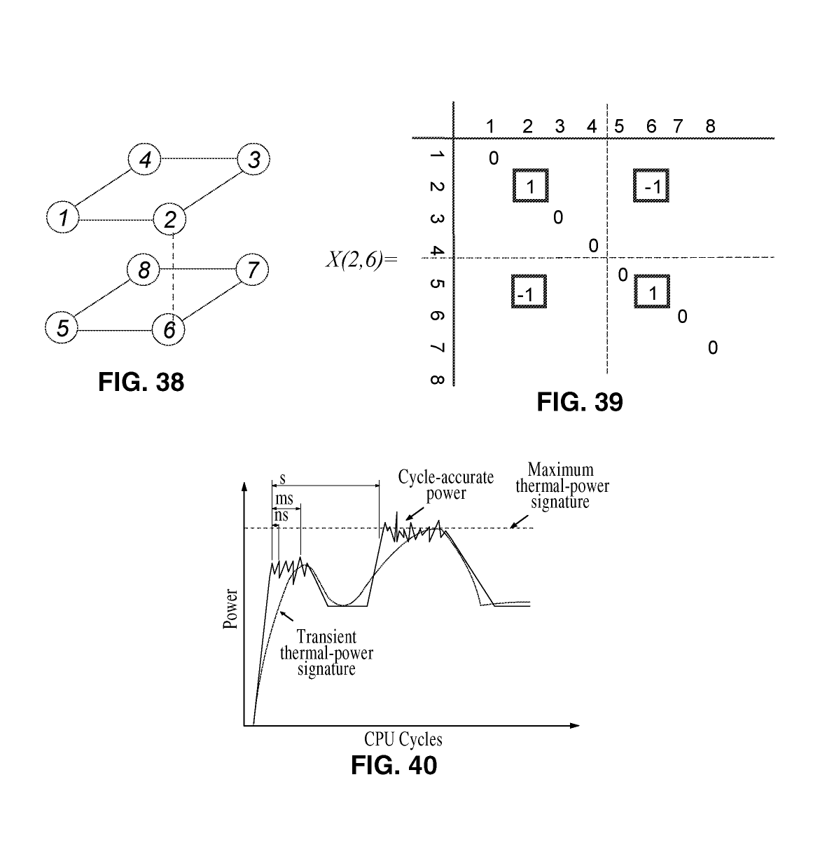

FIG. 38 is a diagram showing an example of stapling between tiles 2 and 6.

FIG. 39 is an adjacent matrix of X(2,6). The via conductance gᵢ and capacitance cᵢ are both proportional to the area Dᵢ or density Dᵢ/a (where a is unit area).

21.2 Thermal Analysis

A transient thermal-power is the running average of the cycle-accurate (often in the range of ns) power over the thermal time constant (often in the range of ms). When working loads are known, a constant maximum thermal-power can be calculated as the maximum of the transient thermal-power, and should be calculated for each region of the chip.

FIG. 40 illustrates differences of these power definitions, representing cycle-accurate power, transient thermal-power signature, and maximum thermal-power signature at the different scale of time constant.

Assuming steady-state thermal analysis (based on thermal resistance model), thermal-via allocation has been studied for the placement and routing. These previous methods have to assume the maximum thermal-power simultaneously for all tiles in the integrated circuit to obtain a solution without thermal violation, because the use of steady-state analysis ignores the temporal and spatial variations of the transient thermal-power. As it is rare, if not impossible, for different tiles to simultaneously reach their maximum thermal-power, these steady-state methods may lead to excessive number of thermal vias. In addition, these methods directly solve the matrix-formed state equation. Using these methods can not efficiently calculate the nominal temperature and its sensitivity with respect to the via density for large scale designs. The design procedure is either based on iterations, or based on an approximated square-root relation between temperature and thermal-vias, which may not converge or may lead to inaccurate results. Therefore, the present invention provides accurate and efficient solutions for performing transient temperature and temperature sensitivity.

21.3 Level Based Via Stapling Problem

During the early planning stage, vias are vertically stapled between each pair of aligned tiles in adjacent active device layers. The stapling may have different patterns, which can be described by levels:

Definition 1. Assuming each layer is discretized into N tiles, a level-i (i=1, . . . , K) stapling pattern is to hierarchically and symmetrically select 4ⁱ tiles from each layer by subdivision, and staple vias for each pair of aligned tiles in adjacent layers.

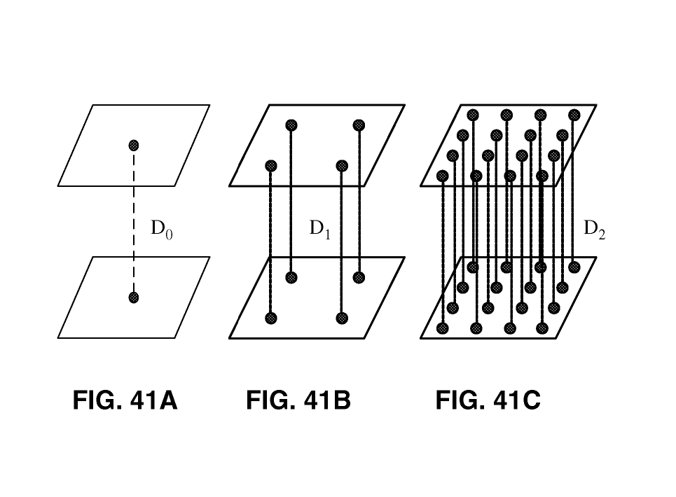

FIGS. 41A-41C illustrate an example of levelization via-stapling between each pair of adjacent layers: FIG. 41A at level=0; FIG. 41B at level=1; and FIG. 41C at level=2 to describe via patterns. A level-0 pattern means stapling vias in the center tile, and a level-1 pattern means stapling vias in each of the four partitions. As can be seen, the via-pattern becomes more uniform as the level increases. Multiple levels can be used simultaneously for a design, and it is assumed that the maximum level number K is provided by users.

Considering total K levels of via-stapling patterns, the design freedom is in the via-density (number of vias in one tile) for each level. Wherein, if a via-density vector is defined as
D=[D₁, D₂, . . . , D_{K}], (67)
each level is then associated with a via density Dᵢ to be decided during the via-stapling.

Accordingly the following problem formulation is put forth:

Formulation 1:

Given the allowed maximum voltage violation Vₘₐₓ in PIG planes and the allowed maximum temperature Tₘₐₓ in device layers, the via-stapling problem is to minimize the total via number, such that the temperature is smaller than Tₘₐₓ and the voltage violation is smaller than Vₘₐₓ.

This simultaneous power and thermal integrity driven problem can be represented by

$$min {\sum }_{i = 1}^{K} {n}_{i} {D}_{i} , \\ s . t . max ( V ) \leq {V}_{max} , \\ max ( T ) \leq {T}_{max} ,$$

and Dₘᵢₙ≦Dᵢ≦Dₘₐₓ (68)
where nᵢ is the number of tiles to be stapled in level i. The value of Dₘₐₓ is decided by the signal-via routing congestion and Dₘᵢₙ is decided by the current density (reliability). The key to solving Eq. (68) is an efficient yet accurate transient integrity analysis, as presented in the following section.

22. Integrity Analysis

22.1 Parameterized Description

Only the RLC circuit for modeling and algorithm description is presented, unless stated otherwise, because the distributed thermal-RC circuit is generally a simpler case for the electrical-RLC circuit.

It should be noted that the via density Dᵢ at one tile is related to the via area Aᵢ in the tile by Dᵢ=Aᵢ/(nᵢ·a). In this relation a is the unit area of via determined by the processing technology. Via density and unit area are implicitly proportional to the via density D as well, because conductance and capacitance values are all proportional to the area A. Therefore, the electrical-RLC circuit with the parameterized number of vias can be formulated in MNA (modified nodal analysis) in frequency (s) domain:

$$\begin{matrix}[ {G}_{0}^{′} + {sC}_{0} + {\sum }_{i = 1}^{K} {D}_{i} ( {g}_{i} + {sc}_{i} ) ] x ( D , s ) = BI ( s ) \\ y ( D , s ) = {B}^{T} x ( D , s ) \\ with & ( 69 ) \\ x ( s ) = [ \begin{matrix}{v}_{n} \\ {i}_{l}\end{matrix} ] , B = [ \begin{matrix}{E}_{i} \\ 0\end{matrix} ] . \\ and \\ {G}_{0}^{′} = [ \begin{matrix}G & {E}_{l} \\ - {E}_{l}^{T} & 0\end{matrix} ] , {C}_{0} = [ \begin{matrix}C & 0 \\ 0 & L\end{matrix} ] . & ( 70 )\end{matrix}$$

All notations in Eq. (70) are summarized in the notation list for system equations as given by Table 7. It should be noted for the table that M=Nᵥ+Nᵢ, and that B is the adjacent matrix composed by Eᵢ. The matrix describes pᵢ inputs and pₒ critical nodes to be probed, both provided by users.

To mathematically describe adding vias in a circuit equation, an insertion (adjacent) matrix X is introduced. For a level-i stapling, adding vias between tiles m and n results in:

$$\begin{matrix}{X}_{i} ( k , l ) = {X}_{i} ( l , k ) \\ = \{ \begin{matrix}- 1 & if k = m , l = n and k \neq l \\ {\sum }_{l} \vert {X}_{i} ( k , l ) \vert & if k = l \\ 0 & else\end{matrix}\end{matrix} \\ where \\ k , l ∈ 1 , 2 , … , {4}^{i} \\ i ∈ 1 , 2 , … , K . \qquad ( 71 )$$

Then, the unit conductance and capacitance matrices for the level-i stapling are:
gᵢ=gXᵢ, cᵢ=cXᵢ
where g and c are conductance and capacitance for the via with unit area a.

The vias are then added to the nominal G′₀ and C₀ as a perturbed adjustment:

$${G}^{′} = {G}_{0}^{′} + {\sum }_{i = 1}^{K} {D}_{i} {g}_{i} , {C}^{′} = {C}_{0} + {\sum }_{i = 1}^{K} {D}_{i} {c}_{i}$$

where G′ and C are the adjusted state matrices including the perturbation from vias. It should be appreciated that there are the following differences between thermal RC and electrical-RLC circuits in MNA. For a thermal-RC circuit, Eq. (70) becomes
G′₀=G, C′₀=C (72)
where G and C has larger RC values and results in a larger time constant than an electrical-RLC circuit does. In addition, the input I(s) for the thermal-RC circuit stands for thermal-power, while by contrast, I(s) stands for switching-current in electrical-RLC circuits. Moreover, output y at the selected critical nodes is temperature T and voltage V for the thermal-RC and electrical-RLC circuit, respectively.

22.2 Macromodel by Moment Matching

It is inefficient to directly solve Eq. (69) for large scale designs.

Macromodeling technique based on moment matching can obtain compact models for large distributed thermal-RC and electrical RLC circuits. The existing flat reduction is first reviewed in this subsection, and then a structured and parameterized reduction is introduced.

To build macromodel by moment matching, we first define moment generation matrices (expanded at sₒ) as
A′=(G′+s₀C′)⁻¹C′, R′=(G′+s₀C′)⁻¹B′.

The following projection matrix Q is then obtained that spans the qth block Krylov subspace by
K′(A′,R′,q)={A′, A′R′, . . . , A′^{q-1}R′}⊂Q′
which can be constructed by a block Arnoldi method, wherein a reduced system can be obtained by projection:
Ĝ′=Q′^{T}G′Q′, Ĉ′=Q′^{T}C′Q′, \hat{B}′=V^{T}\hat{B}′
with
Ĥ(s)\hat{B}′^{T}(Ĝ′+sĈ′)⁻¹\hat{B}′

The value Ĥ accurately approximates the original H by matching the first q block moments expanded at sₒ. This procedure can be applied for both thermal-RC and electrical-RLC circuits.

The above macromodeling, however, can only generate nominal values. By expanding Eq. (69) at design parameter points such as the via density at different levels, parameterized moments, i.e., the sensitivities of temperature and voltage with respect to the via density can be obtained. The dimensions of the parameterized moments grow exponentially and they may not be used in practice, because they have coupled frequency and parameter variables. This is improved by separately expanding moments of design parameters from those of frequency. However, applying a flat projection during the reduction destroys the matrix structure, wherein the nominal values and sensitivities after reduction can not be separated easily.

22.3 Structured and Parameterized Reduction

The approach according to this aspect of the present invention illustrates that nominal values and their sensitivities can be obtained separately by a structured and parameterized reduction. Because the sensitivity is large with respect to the frequency change but small with respect to the design parameter perturbation, the state variable x(D,s) can be approximated by Taylor expansion:

$$x ( D , s ) = {\sum }_{{i}_{1}}^{∞} … {\sum }_{{i}_{K}}^{∞} {x}_{1 , … , K}^{( {i}_{1} + … + {i}_{K} )} ( s ) {( δ {D}_{1} )}^{{i}_{1}} … {( δ {D}_{K} )}^{{i}_{K}} \qquad ( 73 )$$

This is similar to techniques utilized for dealing with process variations. Substitute Eq. (73) in Eq. (69), and explicitly matching the moment for each Dᵢ to the first-order, Eq. (69) can be reformulated into an augmented parameterized state equation:

$$\begin{matrix}( {G}_{ap} + {sC}_{ap} ) {x}_{ap} = {B}_{ap} I ( s ) , {y}_{ap} = {L}_{ap}^{′ T} {x}_{ap} \\ with & ( 74 ) \\ {G}_{ap}^{′} = [ \begin{matrix}{G}_{0}^{′} & 0 & … & 0 \\ {D}_{1} {g}_{1} & {G}_{0}^{′} & … & 0 \\ ⋮ & ⋮ & ⋰ & ⋮ \\ {D}_{K} {g}_{K} & 0 & … & {G}_{0}^{′}\end{matrix} ] \\ and \\ {x}_{ap} = {[ {x}_{0}^{( 0 )} , {x}_{1}^{( 1 )} , … , {x}_{K}^{( 1 )} ]}^{T} \\ {B}_{ap}^{′} = {[ B , 0 , … , 0 ]}^{T} \\ {L}_{ap}^{′} = {[ {B}^{′} , δ {D}_{1} {B}^{′} , … , δ {D}_{K} {B}^{′} ]}^{T} . & ( 75 )\end{matrix}$$

It should be noted that C′ₐₚ has the same lower-triangular structure as G′ₐₚ does.

The state variable yₐₚ at output for those critical tiles can be also divided into two parts:
y⁽⁰⁾=y₀⁽⁰⁾(εR¹), y⁽¹⁾={y₁⁽¹⁾, . . . , y_{K}⁽¹⁾}(εR^{K}).

As a result, solving Eq. (74) results in the nominal value, y^{(o)}, and its first-order sensitivity y⁽¹⁾ with respect to each parameter Dᵢ.

The large system equation (74) can be reduced using projection with preserved moments (of s) up to the qth-order. Because G′ₐₚ and C′ₐₚ have lower-triangular structures, a flat projection matrix Q′ₐₚ can be constructed recursively using an iterative Arnoldi method. However, other mechanisms have directly projected Eq. (74) by Q′ₐₚ, which leads to a reduced macromodel which loses the block structure for both state matrices and variables. As a result, y^{(o)} and y⁽¹⁾ are interleaved with each other.

Therefore, instead of using the flat projection matrix Q′ₐₚ

$${Q}_{ap}^{′} = [ {Q}_{0} , \underbrace{{Q}_{1} , … , {Q}_{K}}_{K} ] \qquad ( 76 )$$

a structured projection matrix is introduced

$${Q}_{ap}^{′} = [ \begin{matrix}{Q}_{0} & 0 & … & 0 \\ 0 & {Q}_{1} & … & 0 \\ ⋮ & ⋮ & ⋰ & ⋮ \\ 0 & 0 & … & {Q}_{K}\end{matrix} ] , \qquad ( 77 )$$

by partitioning Q′ₐₚ Qₐₚ according to the dimension of x⁽⁰⁾ and x⁽¹⁾. Note that G′ₐₚ Gₐₚ, C′ₐₚ and Q′ₐₚ have larger dimensions than G, C and Q. However, as G!ₐₚ, C′ₐₚ and Q′ₐₚ are in block triangular or block diagonal form, they can be implemented in a block-matrix data structure without memory usage increase.

More importantly, the projection by Q′ₐₚ preserves the block matrix structure. As a result, the order-reduced state matrices after projection by Q′ₐₚ are

$${\tilde{G}}_{ao}^{′} = {Q}_{ap}^{′ T} {G}_{ap}^{′} {Q}_{ap}^{′} , {\tilde{C}}_{ap}^{′ } = {Q}_{ap}^{′ T} {C}_{ap}^{′} {Q}_{ap}^{′} \\ {\tilde{B}}_{ap}^{′} = {Q}_{ap}^{′ T} {B}_{ap}^{′} , {\tilde{L}}_{ap}^{′} = {L}_{ap}^{′} = {L}_{ap}^{′} {Q}_{ap}^{′} \\ where \\ {G}_{ap}^{′} = [ \begin{matrix}{Q}_{0}^{T} {G}_{0}^{′} {Q}_{0} & 0 & … & 0 \\ {D}_{1} {Q}_{1}^{T} {g}_{1} {Q}_{0} & {Q}_{1}^{T} {G}_{0}^{′} {Q}_{1} & … & 0 \\ ⋮ & ⋮ & ⋰ & ⋮ \\ {D}_{K} {Q}_{K}^{T} {g}_{K} {Q}_{0} & 0 & … & {Q}_{K}^{T} {G}_{0}^{′} {Q}_{K}\end{matrix} ] , \qquad ( 78 )$$

It should be noted that the reduced \tilde{C}′ₐₚ has the same preserved lower-triangular structure as \tilde{G}′ₐₚ.

In addition, the structured and parameterized macromodel
\tilde{H}ₐₚ=\tilde{L}′ₐₚ(Ĝ′ₐₚ+sĈ′ₐₚ)⁻¹\tilde{B}′ₐₚ
has the following property:

Theorem 5.

The first q block moments expanded at sₒ are identical for \tilde{H}ₐₚ(s) and H(s).

Because Qₐₚ⊂Q′ₐₚ, a q-th ordered projection by Q′ₐₚ still preserves at least q moments.

The time-domain transient response of the reduced model can be solved by the Backward-Euler (BE) method. The reduced system equation at time instant t with time step h is

$$( {\tilde{G}}_{ap}^{′} + \frac{1}{h} {\tilde{C}}_{ap}^{′} ) {\tilde{x}}_{ap} ( t ) = \frac{1}{h} {\tilde{C}}_{ap}^{′} {\tilde{x}}_{ap} ( t - h ) + {\tilde{B}}_{ap}^{′} u ( t ) \\ {\tilde{y}}_{ap} ( t ) = {\hat{L}}_{ap}^{′ T} {\tilde{x}}_{ap} ( t ) \qquad ( 79 )$$

where
\tilde{y}ₐₚ=[ŷ⁽⁰⁾, \tilde{y}⁽¹⁾]^{T}=]\tilde{y}₀⁽⁰⁾, \tilde{y}₁⁽¹⁾, . . . , \tilde{y}_{K}⁽¹⁾]^{T}

The overall voltage/temperature (V/T) vector at those critical tiles perturbed by the via-density vector, i.e. D, is
\tilde{y}(D,t)=\tilde{y}⁽⁰⁾(D,t), \tilde{y}⁽¹⁾(D,t), (80)

Since our reduction preserves the block structure, the reduced nominal value \tilde{y}⁽⁰⁾ and first-order sensitivity \tilde{y}⁽¹⁾ at output (critical tiles) can be solved independently. Moreover, because the reduced system still has the lower-triangular structure, it is obvious that Eq. (79) can be efficiently solved using back substitution with only one LU factorization of

$${\tilde{G}}_{0}^{′} + \frac{1}{h} {\tilde{C}}_{0}^{′} .$$

As a result, such a structured and parameterized macromodel can be incorporated in a sensitivity based optimization for efficient yet accurate staple vias.

23. Sensitivity Based Optimization

Since the structured and parameterized macromodel taught herein provides both nominal values and sensitivities, they can be incorporated in any gradient-based optimization. However, the Hessian matrix used in gradient-based optimization is computationally expensive to obtain second-order gradients. If there are K parameters in the design, it needs K² parameterized second-order moments to generate a Hessian matrix. As a result, the cost to build and simulate a macromodel becomes excessively large and thus not efficient and unnecessary for via-planning during the early-design stage.

For the sake of speed in handling large scale problems, the technique used herein is a form of sensitivity-based heuristic. By successively increasing via density for the via-level with the largest gain in each iteration, the method presented herein staples a minimum number of vias to reduce both temperature and voltage violations in problem formulation of Eq. (68). This greedy heuristic optimizer can solve large scale designs efficiently and effectively.

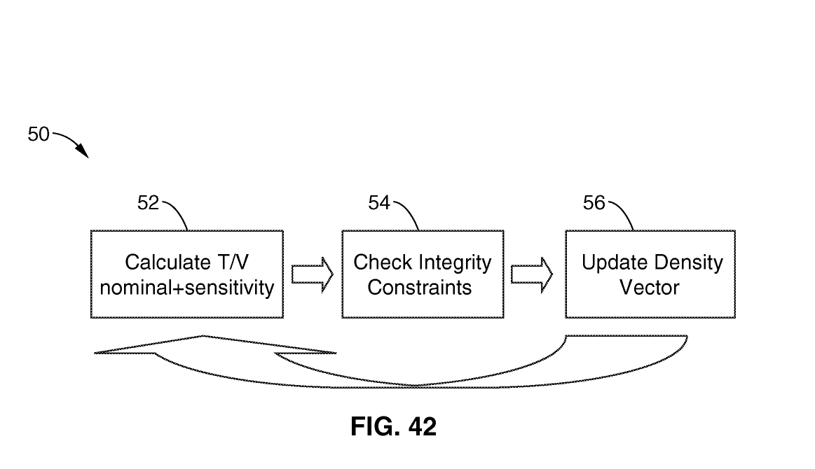

FIG. 42 illustrates a general flow 50 for performing iterative optimization. The process starts at block 52 with determining both nominal and sensitivity of thermal and voltage characteristics, verifies that integrity constraints are met at block 54, and updates the density vector at block 56. This process is performed iteratively until the desired optimization is reached.

The overall optimization to solve problem formulation of Eq. (68) is outlined in Algorithm 3. It will be noted that the weighted sensitivity vector S is a weighted-sum of normalized voltage-sensitivity vector S_{V} and thermal-sensitivity S_{T}:
S=α·S/∥S_{T}∥+β·S_{V}/∥S_{V}∥ (81)
where α and β are weights for S_{T} and S_{V}. The via density vector D is updated by
D^{(iter+1)}=D^{(iter)}+γ^{(iter)}·s^{(iter)},
where γ is an adaptive-controlled step size and decreases as the iteration proceeds.

Algorithm 3:

Via Stapling Procedure.

Input: Critical nodes, via pattern number K, signal congestion induced bound Dₘₐₓ and current-density induced bound Dₘᵢₙ
Step 0: Reduce Eq. (74) using structured and parameterized reduction;
Step 1: Compute nominal voltage (V)/temperature (T) and sensitivity S_{V}/S_{T} using Eq. (79) by backward-substitution;
Step 2: Determine Vₘₐₓ and Tₘₐₓ of critical nodes;
Step 3: Increase via density D according to weighted sensitivity S in the range of (Dₘᵢₙ; Dₘₐₓ);
Step 4: Update the structured and parameterized macro model according to Eq. (78);
Step 5: Repeat from Step 1 until maximum noise/temperature constraints are satisfied;
Output: Via density vector D

Only one reduction is needed and the reduced state matrices can be repeatedly used when updating the parameter vector D according to Eq. (78), because the macromodel of the present invention is parameterized. In addition, the reduced model is much smaller than the original one and has a lower-triangular structure. Its nominal value and sensitivities, therefore, can be efficiently solved by backward-substitution of Eq. (79) with only one LU factorization. As a result, the optimization procedure in Algorithm 3 is computationally efficient.

24. Results for 3D Via Stapling

The proposed modeling and algorithm have been implemented in C. By way of example and not limitation, testing was performed on a Sun-Fire-V250 workstation with 2G RAM, and the reported number of vias are all for no-signal vias. Silicon, copper and dielectric are assumed for via, heat-sink, active device layer, inter-layer and PG plane, respectively.

Table 8 and Table 9 summarize their electrical and thermal constants and dimensions. In addition, 20% of the device-layer tiles have a random input of thermal-power in the range of 1 to 5×10⁻¹ W/m². Their clock gating pattern has a period of 100 ms where the power in the standby mode is 20% of the running mode. While 10% of power/ground-plane tiles have random inputs of switching-currents in the range of 1 to 5×10⁻¹ A with rising time 0.01 ns. All power sources are uniformly distributed across the active device layer or PG-plane. The range of via density is set from 100 to 80000 for each level, and the weight α and β are equal for Eq. (81). A modest 3D stacking with one heat-sink, two device-layers, two dielectric-layers and two P/G-planes is assumed for these tests.

24.1 Verification of Macromodel and Optimization

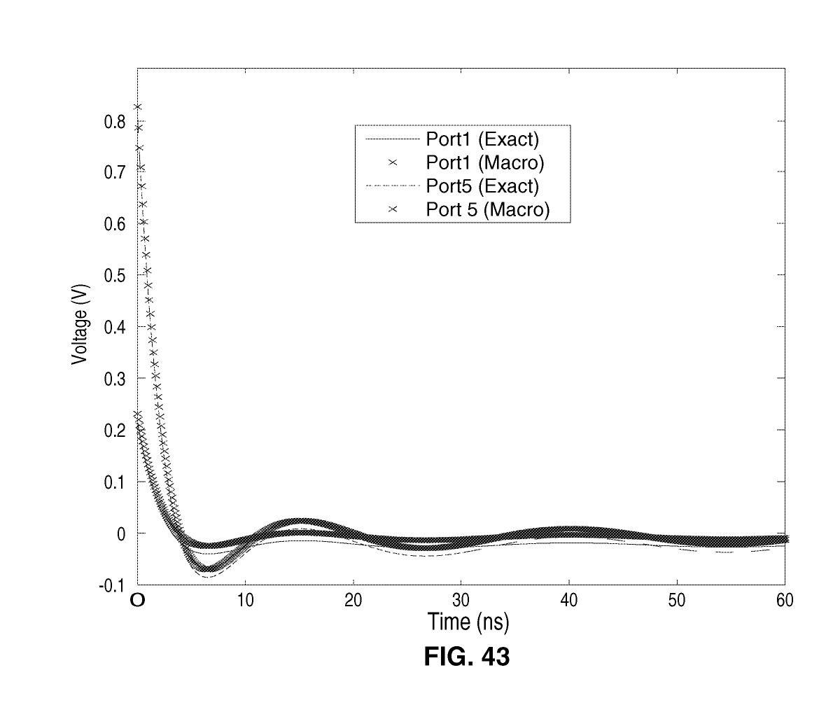

FIG. 43 depicts transient voltage responses of exact models of the macromodels used herein (order=40) at port 1 and 5 of layer-1. In this first example is a 3D stacking with 7900 total tiles and a level-4 via pattern. FIG. 43 compares the time-domain waveform between our macromodel and exact MNA solution at ports 1 and 5 of one selected P/G plane. The macromodel (expanded at s₀=0) uses order 40. Clearly, the macromodel according to the present invention is accurate.

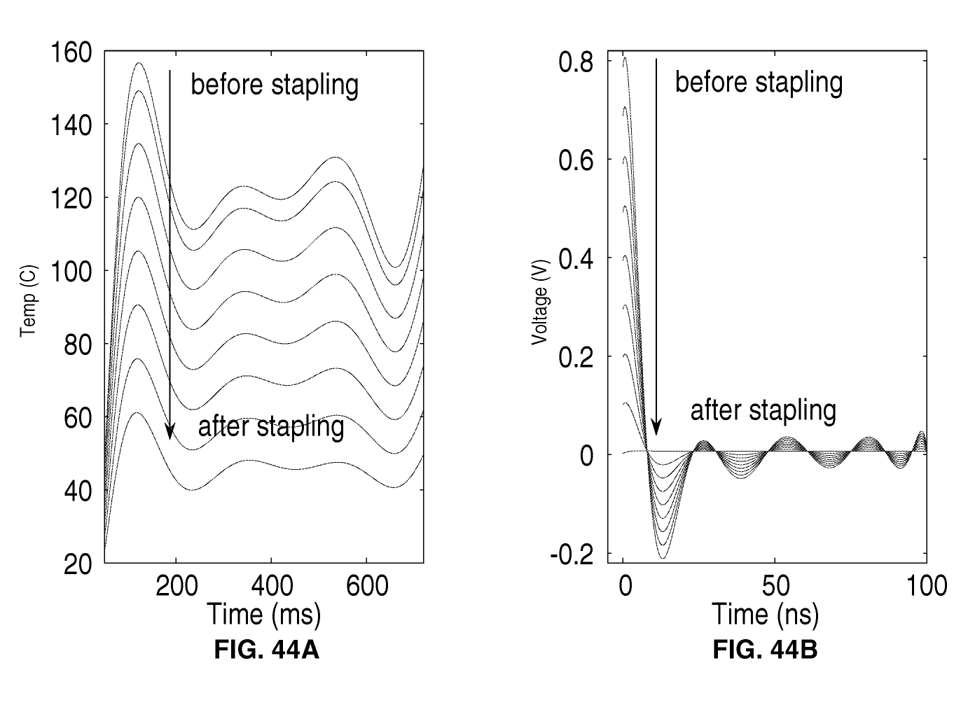

FIGS. 44A-44B illustrate iterative optimizations and show the reduction of temperature and voltage violation by via-stapling. These figures present the decreasing of the transient temperature and voltage violation during the simultaneous optimization procedure.

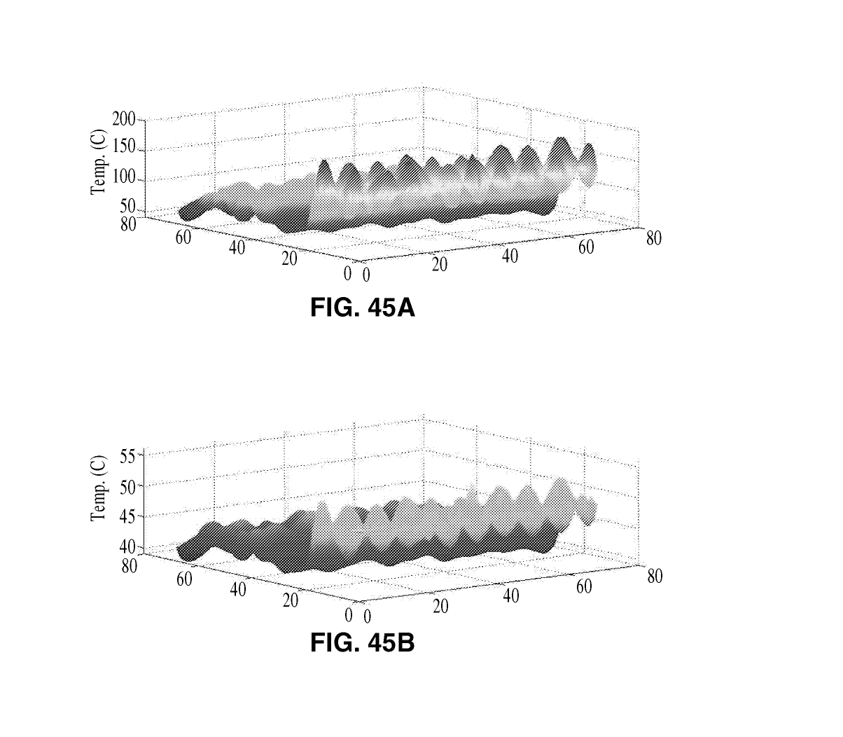

FIGS. 45A-45B illustrate steady-state temperature maps of bottom device layer before via-stapling, and after via-stapling. These figures are shown on different scales. The figure shows a steady-state temperature map across the top device layer. In this example, it is assumed that all thermal-power sources are located at one side of the device layer. The initial chip temperature at the top layer is around 150° C., and its temperature profile at steady-state is shown in FIG. 45A. In contrast, the via-stapling results in a cooler temperature that closely approaches the targeted temperature as shown in FIG. 45B.

24.2 Comparison Between Steady State and Transient Thermal Analysis

The runtime and the number of vias are further compared between the steady-state and transient thermal analysis. Circuit complexity was increased by increasing the number of discretized tiles, and more levels were needed for vias as the tile numbers become larger. Sequential optimization in this comparison is used. First vias are allocated to satisfy the power integrity constraints with targeted voltage violation Vₘₐₓ of 0.2V, and then vias are allocate to satisfy the thermal integrity constraints with targeted temperature Tₘₐₓ of 52° C. and considering the already stapled power/ground vias for heat removal.

Table 10 presents the results of the testing. The vias are over-designed when using steady-state analysis. Compared to the optimization by steady-state analysis, the optimization by transient thermal analysis reduces vias by 11:5% for a circuit with 27740 tiles. This is because the steady-state analysis has to assume a constant maximum thermal-power input for all tiles in order to get a valid solution. In reality, it seldom (if ever) happens that all tiles have their maximum input at the same time. In contrast, our transient thermal analysis can accurately generate the transient temperature using the input of transient thermal-power.

Furthermore, directly solving of state equations in the steady-state analysis results in longer runtimes. In contrast, the macromodel can efficiently match the transient response using around 20 moments. For the same circuit with 27740 tiles, our macromodel has a 155× smaller runtime compared to the steady-state analysis, and the steady-state analysis can not complete the largest example.

24.3 Comparison Between Sequential and Simultaneous Optimizations

The sequential optimization is further compared with simultaneous thermal/power optimization, and via patterns are discussed for thermal and power integrity, respectively. As shown in Table 11, for a circuit with 27740 tiles, when only using the thermal-constraint, more vias tend to be stapled for high-level patterns. As a higher level pattern means more uniform via distribution, the thermal constraint results in a more uniformly distributed via pattern. On the other hand, when only using P/G constraint, more vias are stapled in the center, i.e., using level-0 via pattern to reduce the power/ground plane loop inductance or SSN. Due to such an opposite stapling trend, a via-stapling in a sequential fashion results in excessive number of vias. In contrast, the vias are distributed more uniformly in all levels when simultaneously considering the thermal and power integrity. Finally, the results are compared using simultaneous optimization and sequential optimization. On average, simultaneous optimization of the present invention further reduces the number of vias by 34% compared to the sequential optimization by steady-state analysis in Table 10, and reduces by 22.5% the number of vias compared to sequential optimization with transient analysis.

25. Conclusions to V/T Stapling in 3D ICs

Inter-layer non-signal vias are effective to reduce power supply noise and temperature hotspots in 3D ICs. Existing work on via-stapling does not consider thermal and power integrity simultaneously, and uses steady-state thermal analysis. To reduce the number of vias for targeted power and thermal integrity, the present invention has presented methods for providing simultaneous power and thermal integrity driven via-stapling.

Simultaneous power and thermal integrity optimization of these methods minimizes non-signal vias subject to constraints on transient temperature and voltage violations, which are calculated by a structured and parameterized model reduction. This model reduction also generates parameterized sensitivities of temperature and voltage violations with respect to the via pattern and density. The resulting macromodel is used in the efficient greedy optimization simultaneously driven by power and thermal integrity.

Testing that has been performed with two active device layers show that for the sequential power and thermal optimization, using the transient thermal analysis reduces non-signal vias by on average 11.5% compared to using the steady-state thermal analysis. In addition, the simultaneous optimization of power and thermal integrity herein reduces on average 34% non-signal vias compared to the existing approach assuming the sequential optimization and steady-state thermal analysis. The via reduction could be higher for the 3D design with more device layers.

The power integrity taught within the present invention considers noise on power/ground planes in the package without considering on-chip power supply routing.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Reduction Time Comparison of Models

| ckt | | error | | BSMOR | | PRIMA | |
|---|---|---|---|---|---|---|---|
| mesh# | elements | boundary | blk # | iter# | time (s) | iter# | time (s) |
| 1 | 1K | 1e⁻⁸ | 2 × 2 | 4 | 0.03 s | 10 | 0.09 s |
| 2 | 10K | 1e⁻⁸ | 8 × 8 | 6 | 0.07 s | 20 | 0.28 s |
| 3 | 80K | 1e⁻⁶ | 16 × 16 | 6 | 0.42 s | 30 | 3.82 s |
| 4 | 160K | 1e⁻⁶ | 16 × 16 | 6 | 5.14 s | 40 | 46.98 s |
| 5 | 320K | 1e⁻⁴ | 32 × 32 | 6 | 10.27 s | 60 | 104.62 s |
| 6 | 1 M | 1e⁻⁴ | 64 × 64 | 8 | 240.22 s | 80 | 4982.76 s |

TABLE 2
Time-domain Waveform Errors of Different Reduction Models

| ckt # | node (N) | port (p) | order (q) | HAPD | HiPRIME | BSMOR | TBS |
|---|---|---|---|---|---|---|---|
| 1 | 1K | 48 | 8 | 5.54e⁻⁶ | 9.09e⁻⁶ | 4.87e⁻⁶ | 5.03e⁻⁷ |
| 2 | 10K | 320 | 40 | 1.21e⁻⁵ | 2.31e⁻⁵ | 7.93e⁻⁶ | 1.84e⁻⁶ |
| 3 | 100K | 480 | 60 | 1.31e⁻² | 6.82e⁻⁴ | 1.91e⁻⁴ | 3.02e⁻⁵ |
| 4 | 1 M | 800 | 100 | 6.01e⁻² | 9.67e⁻³ | 4.23e⁻³ | 1.27e⁻⁴ |
| 5 | 7.68 M | 4800 | 200 | 0.11 | 9.93e⁻² | 5.10e⁻² | 3.01e⁻⁻³ |
| 6 | 7.68 M | 6.14 M | 300 | -N/A- | -NA- | -NA- | 5.04e⁻⁻³ |

TABLE 3
Run-time Under Similar Accuracy for Different Reduction Models (h:m:s.s)

| | HAPD | | HiPrime | | BSMOR | | TBS | |
|---|---|---|---|---|---|---|---|---|
| ckt # | build | sim | build | sim | build | sim | build | sim |
| 1 | 0.44 | 0.08 | 0.15 | 1.02 | 0.12 | 0.08 | 0.09 | 0.08 |
| 2 | 2.19 | 1.24 | 0.54 | 1:42.0 | 0.63 | 1.18 | 0.11 | 1.02 |
| 3 | 1:17.0 | 1:51.0 | 5.76 | 2:48:20.0 | 1:02.0 | 1:38.0 | 1.62 | 1:32.0 |
| 4 | 34:58.0 | 21:32.0 | 47.3 | ˜1 day | 4:54.0 | 11:42.0 | 20.7 | 11:23.0 |
| 5 | 4:43:18.0 | 29:11:00.0 | 2:42.0 | ˜5 days | 1:45:00.0 | 25:36:00.0 | 2:08.0 | 24:18:00.0 |
| 6 | -NA- | -NA- | -NA- | -NA- | -NA- | -NA- | 6:16.0 | 25:29:00.0 |

TABLE 4
Thermal and Electrical Duality

| | |
|---|---|
| Temperature | Voltage state variables (x(t)) |
| Input Thermal-Power | Input Current sources (u(t)), (i(t)) |
| Thermal Conductance | Electrical Conductance (G) |
| Thermal Capacitance | Electrical Capacitance (C) |

TABLE 5
Notation List

| | |
|---|---|
| N (K) | number of tiles (critical tiles) |
| p | number of input/output ports |
| q | order of reduced models |
| G₀, C₀ | nominal thermal RC state matrices |
| Aᵢ | via density of i th tile |
| x (y) | state variable of temperature (at output) |
| x⁽⁰⁾ (y⁽⁰⁾) | nominal temperature (at output) |
| x⁽¹⁾ (y⁽¹⁾) | 1^{st}-order sensitivity (at output) |
| x⁽²⁾ (y⁽²⁾) | 2^{nd}-order sensitivity (at output) |

TABLE 6
Results from Thermal-via Planning Time and Number

| | | | direct | | | SP-macro | | | |
|---|---|---|---|---|---|---|---|---|---|
| ttl/critical | ttl | orig/ceiling | solve | solve | | redu | solve | qp-prog | allo- |
| tile # | via # | temp (° C.) | dc (s) | tran (s) | allocation | ckt (s) | sens (s) | plan (s) | via |
| 256/30 | 704 | 120/40 | 1.64 | 10.27 | 440 | 0.12 | 0.19 | 0.15 | 360 |
| 1024/60 | 2818 | 120/40 | 12.62 | 130.12 | 2281 | 1.08 | 0.96 | 0.42 | 1609 |
| 4096/80 | 5980 | 140/50 | 341.13 | 3872.98 | 5620 | 12.92 | 6.28 | 1.92 | 3217 |
| 8192/100 | 8218 | 140/50 | 7809.12 | -NA- | 8021 | 46.27 | 16.92 | 8.98 | 4382 |
| 16384/120 | 18000 | 160/60 | -NA- | -NA- | 17600 | 120.89 | 101.23 | 23.65 | 9280 |
| 32768/200 | 24000 | 160/60 | -NA- | -NA- | 23800 | 262.12 | 257.21 | 42.78 | 11660 |

TABLE 7
Notation List

| | |
|---|---|
| x(y) (∈ R^{M×1}) | State variable (at output) |
| vₙ (∈ R^{N}^{ᵥ}^{×1}) | Nodal voltage variables |
| iₗ (∈ R^{N}^{ₗ}^{×1}) | Inductive-branch current variables |
| G (∈ R^{N}^{ᵥ}^{×N}^{ᵥ}) | Nominal conductance matrix |
| C (∈ R^{N}^{ᵥ}^{×N}^{ᵥ}) | Nominal capacitance matrix |
| L (∈ R^{N}^{ₗ}^{×N}^{ₗ}) | Nominal inductance matrix |
| Eᵢ (∈ R^{N}^{ᵥ}^{×p}) | Input/output incident matrix |
| Eₗ (∈ R^{N}^{ᵥ}^{×N}^{ₗ}) | Inductive incident matrices |
| Dᵢ (∈ R^{M×M}) | Parameterized via-density |

TABLE 8
Electrical and Thermal Constants

| symbol | Silicon | Copper | Dielectric |
|---|---|---|---|
| σ | -NA- | 59.6 × 10⁶ S/m | -NA- |
| εᵣ | -NA- | -NA- | 3.3 |
| μᵣ | -NA- | -NA- | 1.0 |
| κ_{R} | 100 W/m · κ | 400 W/m · κ | 50 W/m · κ |
| κ_{C} | 1.75 × 10⁶ J/m³ · κ | 3.55 × 10⁶ J/m³ · κ | 0.7 W/m · κ |

TABLE 9
Dimensions of 3D ICs Layers

| layer | size | material |
|---|---|---|
| heat-sink | 2 cm × 2 cm × 1 mm | copper |
| device-layer | 1 cm × 1 cm × 4 μm | silicon |
| inter-layer | 1 cm × 1 cm × 1 μm | dielectric |
| P/G plane | 2 cm × 2 cm × 10 μm | copper |

TABLE 10
Comparison of Via number and Runtime

| | | Steady-state | | | | | |
|---|---|---|---|---|---|---|---|
| | | (direct) | | Transient (MACRO) | | | |
| total | level | solve dc | ttl via # | redu | solve | ttl via # | ttl via # |
| tile # | vector | (s) | by seq-opt | ckt | BE(s) | by seq-opt | by sim-opt |
| 620 | 0, 1 | 4.06 | 176877 | 0.01 | 0.12 | 156154 (−11%) | 118020 (−32%) |
| 2140 | 0, 1, 2 | 26.37 | 187422 | 0.13 | 0.17 | 166971 (−11%) | 127651 (−32%) |
| 7900 | 0, 1, 2, 3 | 167.9 | 235484 | 1.22 | 0.86 | 206482 (−12%) | 140433 (−36%) |
| 27740 | 0, 1, 2, 3, 4 | 1243.7 | 239379 | 5.12 | 1.07 | 211184 (−12%) | 143718 (−37%) |
| 55680 | 0, 1, 2, 3, 4, 5 | -NA- | -NA- | 15.87 | 3.65 | 216732 (NA) | 144998 (NA) |
| | | | | | | Avg. (−11.5%) | Avg. (−34%) |

TABLE 11
Comparison of Via Distribution at Different Levels

| opt- | level | | | | |
|---|---|---|---|---|---|
| method | 0 | 1 | 2 | 3 | 4 |
| P/G-only | 76832 | 3410 | 1901 | 876 | -NA- |
| Thermal-only | -NA- | 1157 | 43567 | 4007 | 79432 |
| Simultaneous | 67058 | 811 | 2500 | 2808 | 70541 |

What is claimed is:

1. A method of model-order reduction for RLC circuits using one sided projection, comprising:
modeling a circuit by stamping circuit RLC parameters into a modified nodal analysis matrix;
generating a projection matrix constructed from a Krylov subspace; and
obtaining an order reduced circuit, macro-model, replacing the original circuit by projecting the original model using the projection matrix in the congruence transformation matrix.

2. A method as recited in claim 1, further comprising performing a structured analysis of reduced macro-model, comprising:
stamping the original model into a bordered-block-diagonal (BBD) form by partitioning;
finding the projection matrix for the BBD model; constructing the structured projection matrix and performing a structure-preserving projection; and
analyzing the reduced macro-model with preserved BBD structure in both frequency and time domain.

3. A method as recited in claim 2, wherein said plurality of blocks comprises more than a 2×2 partitioning of state matrices.

4. A method as recited in claim 2, wherein said structured projection comprises:
splitting a flat projection matrix into a structured projection matrix; and
reducing the state matrices block-by-block preserving a bordered-block-diagonal structure.

5. A method as recited in claim 2, further comprising performing a fast analysis of the reduced macro-model with use of bordered-block-diagonal (BBD) structure.

6. A method as recited in claim 2, wherein said method is applied to substrate noise analysis, comprising:
discretizing a substrate into a distributed RC model;
partitioning the distributed RC model into blocks;
stamping partitioned blocks into a bordered-block-diagonal (BBD) form;
constructing a structured projection matrix from the BBD matrix;
performing a BBD-structure-preserving model order reduction; and
calculating the noise power spectrum in frequency domain by analyzing a BBD formed macro-model of substrate.

7. A method as recited in claim 1, further comprising performing a structured analysis of reduced macro-model, comprising:
stamping and transforming the original model into a block-triangular-structure (TBS) by triangularization;
exploring the latency and removing the redundancy by a dominant-pole based clustering;
finding a projection matrix from the TBS matrix;
constructing a structured projection matrix and performing a structure-preserving projection; and
analyzing the reduced macro-model with a multi-rated two-level relaxation in time domain.

8. A method as recited in claim 7, wherein said triangularization comprises:
stacking a replica block diagonally; and
moving the original lower-triangular portions of the matrix to new upper-block triangular portions of the matrix.

9. A method as recited in claim 7, wherein poles of an upper-block-triangular system are determined solely by the compact blocks along the diagonal of the state matrix.

10. A method as recited in claim 7, wherein said structured projection comprises:
splitting a flat projection matrix into a structured projection matrix; and
reducing the state matrices block-by-block preserving upper-triangular-block structure.

11. A method as recited in claim 7, wherein said dominant-pole-based clustering comprises:
a block-level pole calculation using model order reduction; and
a block-level similarity comparison using pole-distance.

12. A method as recited in claim 7, wherein localized moment matching is performed which matches more poles than results from Passive-Reduced-order Interconnect Macro-modeling Algorithm (PRIMA).

13. A method as recited in claim 7, wherein said multi-rated two-level relaxation comprises a block-level multi-rated transient simulation with different time-step; and a block-level solving with block substitution.

14. A method as recited in claim 7, wherein said method is applied to power grid analysis, comprising:
discretizing on-chip power grids into a distributed RC model;
partitioning the distributed RC model into basic blocks;
clustering basic blocks into compact blocks with use of the dominant-pole analysis;
stamping the compact blocks into an upper-block-triangular form;
constructing a structured projection matrix from the upper-block-triangular matrix;
performing a structure-preserving model order reduction; and
calculating supply voltage bounce in time domain by analyzing the triangular formed macro-model in time domain with different rate for each reduced block.

15. A method as recited in claim 1, further comprising performing a sensitivity analysis of the reduced order system, comprising:
performing a parameterization procedure of modified nodal analysis;
structuring the parameterized state matrix into a block-triangular form;
constructing the structured projection matrix and performing a structure-preserving projection;
analyzing the reduced macro-model by calculating both sensitivities and nominal responses in both frequency and time domain by block substitution; and
optimizing the design with use of sensitivity in a sequential fashion.

16. A method as recited in claim 15, wherein said parameterization procedure comprises:
parameterizing the size and topology of the device under tuning by a parameterized matrix; and
sequential expanding said state matrix with respect to the parameters to obtain the nominal value and sensitivity.

17. A method as recited in claim 15, wherein said structure-preserving projection comprises:
splitting a flat projection matrix into a structured projection matrix; and
reducing the state matrices block-by-block separating the nominal values and sensitives.

18. A method as recited in claim 15, wherein said method is applied to thermal via allocation for 3D integrated circuits, comprising:
discretizing active devices and inter-dielectric layers into tiles within a 3D dynamic thermal model;
wherein each of said tiles is connected by a thermal resistance and capacitance;
wherein active device heat sources are modeled as time-variant current sources;
constructing a structured and parameterized thermal macro-model;
determining transient temperature of tiles and its sensitives with respect to the via densities; and
optimizing a via density vector based on sensitivity to minimize a transient thermal violation integral under the given congestion constraints.

19. A method as recited in claim 18, wherein a thermal violation integral is utilized which considers minimization of transient temperature.

20. A method as recited in claim 18, wherein optimizing a via density vector performs an iterative sequential optimization using sensitivity from the transient thermal analysis of the macro-model.

21. A method as recited in claim 15, wherein said method is applied to via stapling in 3D integrated circuits, comprising:
simultaneously modeling the dynamic thermal and power integrity characteristics of the 3D integrated circuit in parameterized state equations;
constructing structured and parameterized thermal and power integrity macro-models;
stapling vias until thermal and power integrity constraints are both satisfied, in response to the following steps,
reducing the state equation with structured and parameterized reduction process,
computing nominal voltage/temperature sensitivity by backward substitution,
determining voltage and temperature maximums of critical nodes,
increasing via density according to weighted sensitivity, and
updating macro-model in response to block preserving state-matrix reduction.

22. A method as recited in claim 21, wherein said parameterized state equations are based on a hierarchical decomposition of solution space of vias into a set of levelized stapling patterns.

23. A method as recited in claim 21, wherein said iteratively sequential optimization comprises simultaneously calculating both nominal and sensitivity of thermal and voltage integrities and verifying if both integrity constraints are met.

24. A method as recited in claim 21, wherein said vias are used to optimize thermal and power integrity are optimized simultaneously.
